(19) United States
(12) Patent Application Publication
(10) Pub. No.: US 2023/0135643 A1
(43) Pub. Date: May 4, 2023

(54) Systems and Methods for Agricultural Optimization

(71) Applicant: VITIDORE, INC., Spokane, WA (US)

(72) Inventors: Alyssa J. DeVincentis, Sonoma, CA (US); Hervé Guillon, Davis, CA (US); Sloane Rice, Sonoma, CA (US); Roy Perkins, Spokane, WA (US); John Knutson, Auburn, CA (US); Mike Morgenfeld, St. Helena, CA (US); Gary Lichtenstein, Seattle, WA (US); Thomas Reverso, Aix-les-Bains (FR); Helaine Berris, Seattle, WA (US)

(73) Assignee: VITIDORE, INC., Spokane, WA (US)

(21) Appl. No.: 17/979,726

(22) Filed: Nov. 2, 2022

Related U.S. Application Data
(60) Provisional application No. 63/274,625, filed on Nov. 2, 2021.
(60) Provisional application No. 63/274,668, filed on Nov. 2, 2021.

(51) Int. Cl. G06Q 50/02; A01G 17/00; A01G 17/02; G06Q 10/06

(52) U.S. Cl. CPC G06Q 50/02; A01G 17/005; A01G 17/02; G06Q 10/06315; G06Q 10/067

(57) ABSTRACT

Systems, methods, and/or processes for agricultural parameter determination are provided. One or more can include or use processing circuitry configured to: manage one or more land parcels for agricultural parameter optimization (such as soil organic carbon optimization); and determine one or more agricultural parameters of at least a portion of one land parcel (such as an alleyway between commodity crops) during a first time period without sampling the portion of the one land parcel. Systems, methods, and/or processes for increasing soil organic carbon are also provided.

### CROSS REFERENCE TO RELATED APPLICATIONS

This application claims priority to and the benefit of U.S. Provisional Patent Application Ser. No. 63/274,668 filed Nov. 2, 2021, entitled “Bulbosa 7PB55 Cultivar Cover Crop Systems and Methods for Northern and Central California Wine Grape Crops” and U.S. Provisional Patent Application Ser. No. 63/274,625 filed Nov. 2, 2021, entitled “System and/or Methods for Cover Crop Application, Determining Cover Crop Performance and/or Carbon Credits Generation from Cover Crop Application”, the entirety of each of which is incorporated by reference herein.

### TECHNICAL FIELD

The present disclosure relates to systems and/or methods for agricultural optimization. Particular embodiments of systems and methods of the present disclosure provide environmental optimization and methods, particularly the area of soil carbon enhancement or increase and/or biomass accumulation in previously unused biomass accumulation regions within farm parcels.

### BACKGROUND

Agriculture is intrinsic to global health and prosperity while simultaneously putting an enormous strain on the planet's water, soil, and human resources, and contributing a significant fraction of global greenhouse gas emissions. However, agricultural lands also have the capacity to reverse or mitigate adverse environmental impacts when subjected to interventions that purposefully reduce an associated pressure on compromised environmental resources. These interventions can shift the environmental impacts of an agricultural system from extractive to regenerative.

Cover crops have been used to enhance the productivity of commodity crops. Cover cropping is an intervention in which complementary, unharvested vegetation is planted in an agricultural system for the purpose of enhancing its agro-economy through any combination of lowering required inputs, mitigating agronomic pressures, or regenerating environmental attributes such as soil health. In specialty crop systems where the commodity crop is planted in rows, cover crops can be planted in the alleyways between rows and sometimes underneath the trees or vines of the cash crop. Cover crops can be annual or perennial and multiple species can be planted as a mix in the same space. As farmers weigh costs with benefits and consider the barriers to trying unfamiliar practices, adoption rates for cover cropping remain low in specialty crop systems. Perceived competition for water and soil resources are significant drawbacks, as is the cost of clearing and re-seeding annual varieties each year.

Despite low adoption rates, the upside of cover cropping is very favorable to certain types of farming operations, such as those practicing no-till. In no-till systems, soil is left undisturbed by tillage, providing a variety of agronomic benefits including erosion control. A cover crop can raise soil carbon content by absorbing the greenhouse gas carbon-dioxide through photosynthesis and depositing the resulting organic carbon byproducts into the soil through its root systems and by interaction with other biological processes. This soil carbon can be temporarily removed from the atmosphere when combined with the practice of no-till. A need exists for a trustworthy cover cropping system that does not impede agricultural productivity and complements existing biological and agronomic farm schedules while providing an incentive for implementation by farmers.

### SUMMARY

Systems, methods, and/or processes for agricultural parameter determination are provided. One or more can include or use processing circuitry configured to: manage one or more land parcels for agricultural parameter optimization (such as soil organic carbon optimization); and determine one or more agricultural parameters of at least a portion of one land parcel (such as an alleyway between commodity crops) during a first time period without sampling the portion of the one land parcel.

The determining can include: collecting target agricultural data from collection sites of at least one portion of one land parcel, the collecting comprising compiling target agricultural data and candidate predictor parcel data associated with the collection sites; associating a subset of the candidate predictor parcel data with points throughout the portions of the land parcels; and processing both the compiled target agricultural data and the subset of predictive parcel data to generate target agricultural data for unsampled parcel portions of the one land parcel or of another, unsampled, land parcel.

The processing can include: building a target agricultural data model from collected target agricultural data and the subsets of predictive data; and applying the target agricultural data model to determine one or more agricultural parameters of a portion of the at least one land parcel.

Systems, methods, and/or processes for increasing soil organic carbon are also provided. They can include: managing a parcel having commodity crops planted in rows, the commodity crops having a dormant season; defining alleyways between the rows of commodity crops; planting a cover crop within the alleyways, the cover crops having a growing season within the dormant season of the commodity crop, and a dormant season within the growing season of the commodity crop; and increasing the soil organic carbon content of the parcel during the dormant season of the commodity crop with the cover crop.

Systems, methods, and/or processes for increasing soil organic carbon within land parcels having commodity crops separated by alleyways are also provided. They can include processing circuitry configured to: manage one or more land parcels for agricultural parameter optimization, the land parcels having commodity crops in rows with alleyways therebetween; and determine carbon per acre of at least one land parcel during a first time period without sampling the one land parcel.

The determining can include: collecting soil organic carbon data from collection sites of alleyways of another land parcel, the collecting can include: determining collection sites and compiling soil organic carbon data from the collection sites; associating a subset of the candidate predictor parcel data with points throughout the alleyways of the land parcels; and processing both the compiled soil organic data and the subset of predictive parcel data to generate soil organic data for unsampled alleyways. The processing can include: building a soil organic carbon data model from collected soil organic data and the subsets of predictive data; and applying the soil organic data model to determine soil organic carbon of the alleyway of the at least one land parcel.

### DRAWINGS

Embodiments of the disclosure are described below with reference to the following accompanying drawings.

FIG. 1 is a depiction of system process parameters according to an embodiment of the disclosure.

FIG. 2 is another depiction of system process parameters according to an embodiment of the disclosure.

FIG. 3 is another depiction of system process parameters according to an embodiment of the disclosure.

FIG. 4 is another depiction of system process parameters according to an embodiment of the disclosure.

FIGS. 5A, 5B and 5C depict system and/or methods steps for determining sampling sites.

FIG. 6 is a depiction of example parcels and process parameters according to an embodiment of the disclosure.

FIG. 7 is another depiction of parcel portion digitization and processing according to an embodiment of the disclosure.

FIG. 8 is a depiction of digitized parcel portions according to an embodiment of the disclosure.

FIG. 9 is another depiction of system process parameters according to an embodiment of the disclosure.

FIG. 10 is another depiction of system process parameters according to an embodiment of the disclosure.

FIGS. 11 and 12 are examples of collection sites of target data collection in 12, and a map of predicted points for the entire area of alleyways in 13 according to an embodiment of the disclosure.

FIG. 13 is an example of sampled parcels with predicted sites and an un sampled parcel with predicted sites.

FIG. 14 is a depiction of Hybridized bulbosa cover crop grown in alleyways between commodity crops.

FIG. 15 is another depiction of Hybridized bulbosa cover crop grown in alleyways between commodity crops.

FIG. 16 is a depiction of the Hybridized bulbosa growth cycle within the alleyways in comparison to the growth cycle of a commodity crop (wine grapes).

FIG. 17 is a processing circuitry system according to an embodiment of the present disclosure.

### DESCRIPTION

This disclosure is submitted in furtherance of the constitutional purposes of the U.S. Patent Laws “to promote the progress of science and useful arts” (Article 1, Section 8).

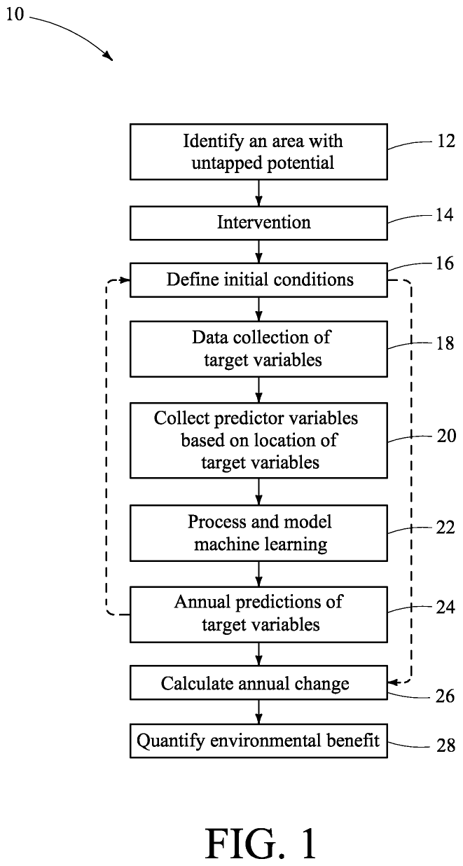

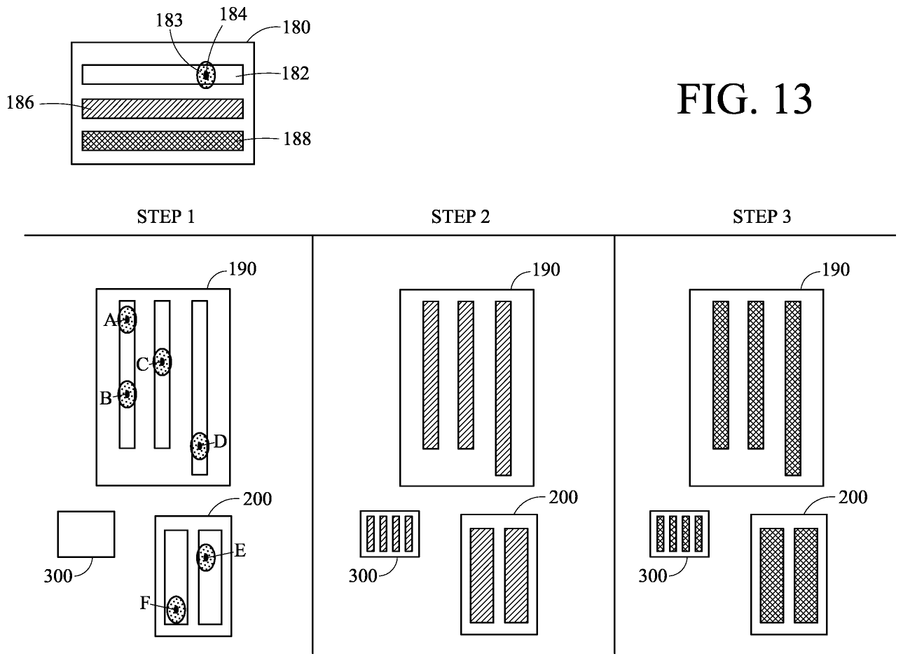

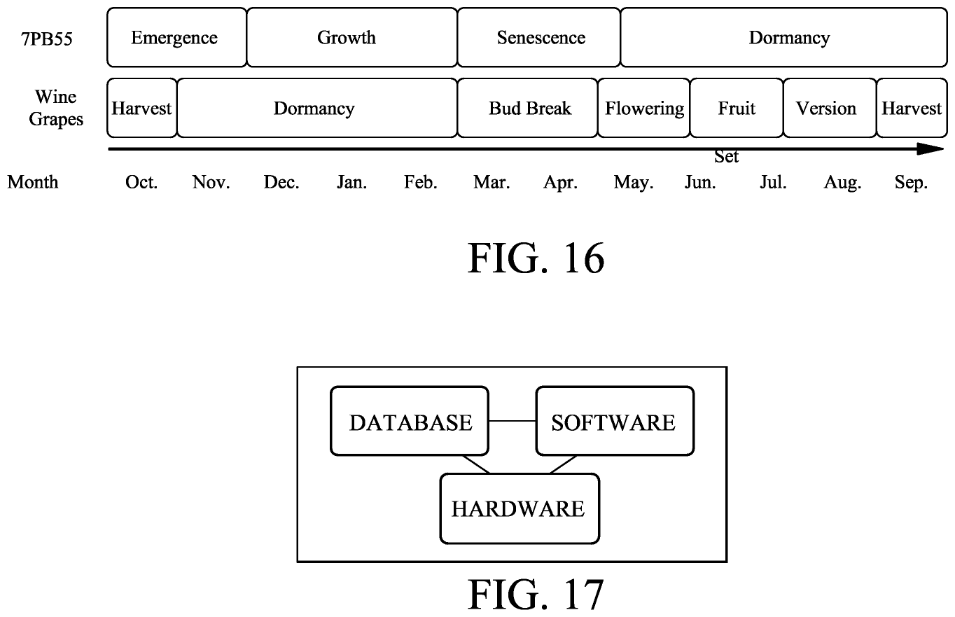

The present disclosure will be described with reference to FIGS. 1-17. Referring first to FIG. 1, an example method 10 to be performed by processing circuitry is provided. Method 10 begins with identifying an area 12. This identification can be a parcel, a portion of a parcel, a farm, and/or a plot, etc. Any form of an area for agricultural parameter determination can be identified. Multiple land parcels and/or multiple portions of multiple land parcels can be identified.

The method includes an intervention 14 into the area. This intervention can be the preparation of any kind of agricultural treatment, but in particular embodiments, environmentally positive agricultural treatments, such as but not limited to, the use of cover crops as will be detailed later by example.

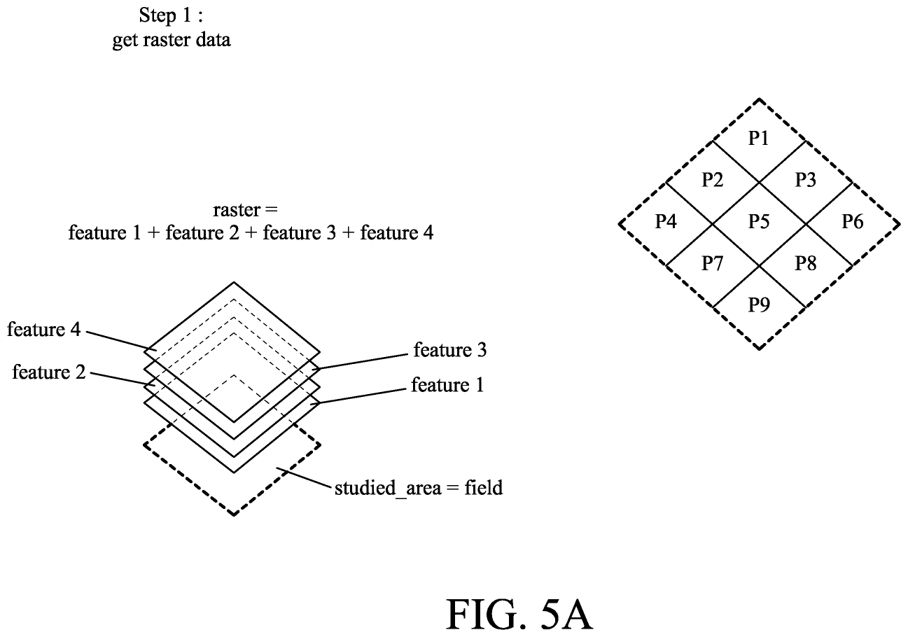

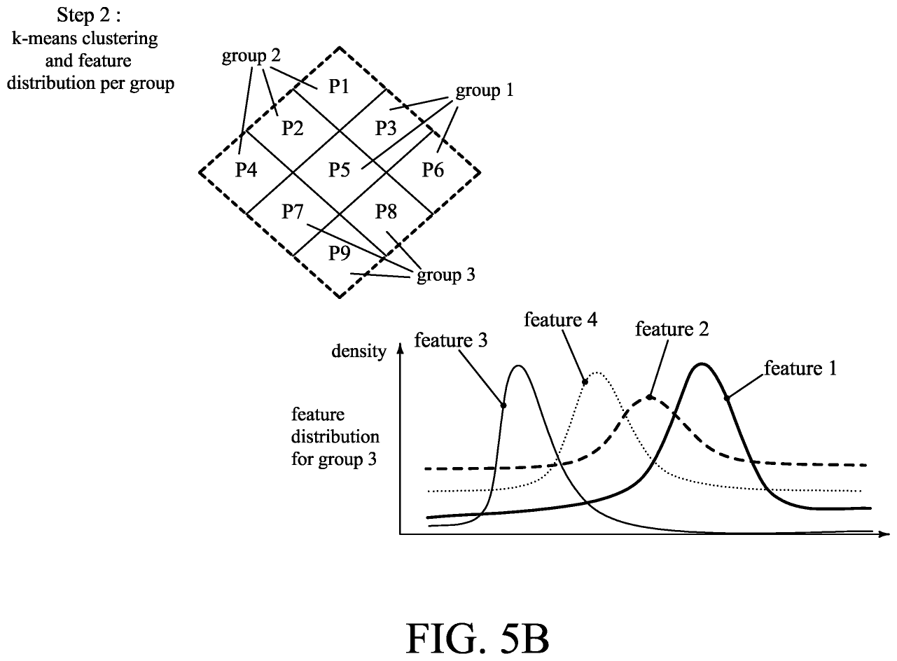

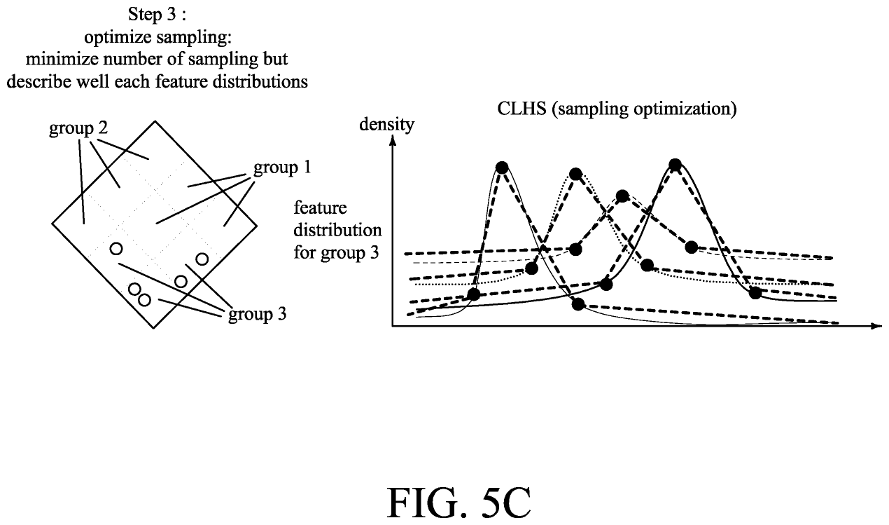

The method can continue by defining initial condition 16. This can include collecting target agricultural data for at least one other land parcel, the collecting comprising determining sampling sites and compiling target agricultural data associated with the sampled sites. As an example, using soil data from publicly available, soil databases (e.g., gNATSGO), vegetation indices from drone imagery, and elevation data from public datasets can be processed by aggregating data and deriving the number of statistically different units or zones present within the parcel or parcel portion and then deriving where to sample within these units in order to best approximate the unit's statistical distribution. At least one example of this is depicted and described with reference to FIGS. 5A-5C.

The method continues with data collection of target variables 18. This can include the collection of target agricultural data for at least one portion of another land parcel or portion. This can be a collection of Soil Organic Carbon from an alleyway, for example. The collecting can include determining the collection sites and compiling target agricultural data associated with the samples acquired from the collection sites. This target agricultural data can include Total Carbon, Total Organic Carbon, Soil Organic Carbon, Calcium, Magnesium, and/or Nitrogen.

The method continues with collecting predictor variables based on locations of target variables 20. For example, candidate predictor parcel data can be compiled and associated with the collected target agricultural data samples acquired from the collection sites.

Predictor variables can include but are not limited to predictors derived from drone imagery and summarized over space across statistical metrics including but not limited to minimum, mean, maximum, standard deviation of various spectral indices including but not limited to CI, MCARI, NDWI, VARI, kNDVI, NDVI, SAVI, GNDVI, ENDVI, LCI, EVI, NIRv, GLI, CVI, CI RedEdge, and NDRE; predictors derived from various satellite imagery (e.g., ESA Copernicus Sentinel-1, ESA Copernicus Sentinel-2, PlanetScope, MODIS, etc) and summarized over space and time across statistical metrics including but not limited to minimum, mean, maximum, standard deviation of various spectral indices including but not limited to SCI, CI, NDWI, VARI, kNDVI, SAVI, ENDVI, LCI: B5, B6, B7; NIRv; GLI, CVI, CI RedEdge: B5, B6, B7; NDRE: B5, B6, B7; 3BSI, mND, MCARI, IRECI, NDVI, S2REP, SR, GNDVI, MDVI, MSI, EVI; predictors derived from sunlight hours at the location between the start of the growing season identified from the first time of rain and the drone flight date: average sunlight hours, total sunlight hours; predictors derived from daily meteorological variables and summarized over time across statistical metrics including but not limited to minimum, mean, maximum, standard deviation) of five variables (precipitation, shortwave radiation, maximum temperature, minimum temperature, vapor pressure); predictors derived from location information: system (e.g., “vineyard”, “orchard”), age, fertilizer rate, pure live seed goal, year, predictors derived from gNATSGO: taxorder, taxsuborder, taxgrtgroup, taxsubgrp, taxpartsize, ksat_r, awc_r, dbovendry_r, wthirdbar_r, wfifteenbar_r, kwfact, kffact, claytotal_r, om_r, musym; predictors derived from 12 SoilGrids250m: wrb, ocs, bdod, cec, cfvo, clay, nitrogen, phh2o, sand, silt, soc, ocd across four quantiles, Q0.05, Q0.5, mean and Q0.95, and 6 various depths: 0-5, 5-15, 15-30, 30-60, 60-100, and 100-200 cm (ocs is only distributed at depth 0-30 cm); and/or predictors derived from 13 Polaris (30-m resolution) variables: ph, om, clay, sand, silt, bd, hb, n, alpha, ksat, lambda, theta_r, theta_s across 5 quantiles (mean, mode, p50, p5, p95) at 3 depths (0-5, 5-15, 15-30 cm). Statistical metrics for summarizing drone imagery, satellite imagery and daily weather data can be automatically determined by the processing circuitry.

The method continues with processing and modeling these variables including machine learning 22. Accordingly, both the compiled target agricultural data and the predictive parcel data are processed to generate target agricultural data for unsampled parcel portions. The processing can include selecting a predictive parcel data subset from the predictive parcel data. The selection of the subset favors a parsimonious model that accomplishes the desired level of explanation or prediction with as few predictor variables as possible. The goodness of fit of a statistical model describes how well it fits a set of observations. The processing can include building a target agricultural data model using the sample data acquired at the collection sites and the subset of predictive data, and applying the target agricultural data model to determine one or more agricultural parameters of the unsampled land parcel.

The processing can include determining additional sample sites for the one land parcel and additional sample sites for the other land parcel. This can include selecting unsampled sites for target variable prediction.

The predictive parcel data subset can be associated with portions of the sampled and/or unsampled parcels. For example sampled alleyways and/or unsampled alleyways. Accordingly, the subset of predictive parcel data can be associated with a myriad of points throughout the parcel or parcel portion. The model can be derived using the subset of predictive data and the sampled data or the entirety of the predictive data and the sampled data.

The model can then be applied to the target agricultural data associated with the collection sites and/or unsampled land parcels or portions to determine the one or more agricultural parameters of the at least one land parcel.

As shown the method can continue with additional predictions including but not limited to annual predictions of target variables 24, and then a calculation of annual change 26, and finally quantifying the environmental benefits 28.

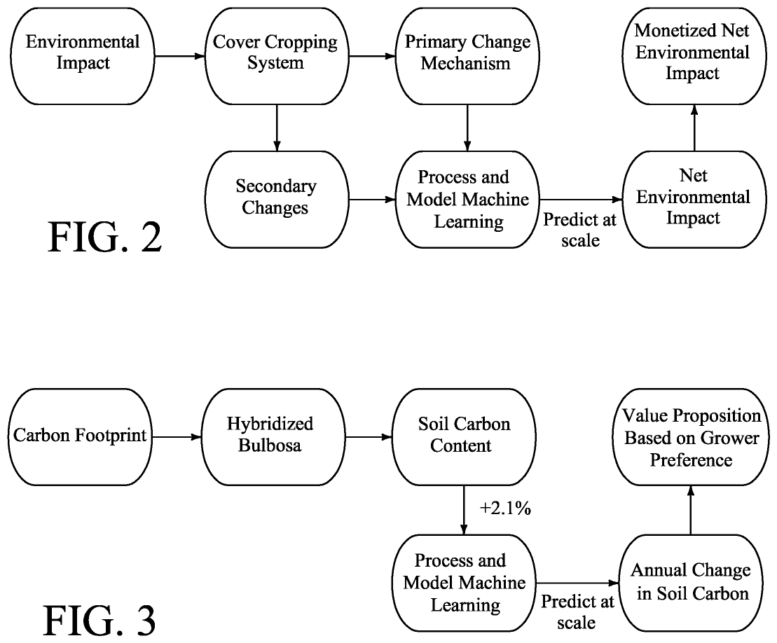

FIGS. 2 and 3 are examples of alternative embodiments of method 10 described in FIG. 1. This can include assessing environmental impact, providing a cover cropping system that indicates secondary changes and also primary change mechanisms, and then using the machine learning and/or process and model software to determine a net environmental impact and then monetizing the net environmental impact. FIG. 3 can include determining changes to a carbon footprint utilizing a specific plant variety such as hybridized bulbosa to increase soil carbon content by utilizing the machine learning and/or process and modeling software to determine annual change in soil carbon as a value proposition based on grower preference.

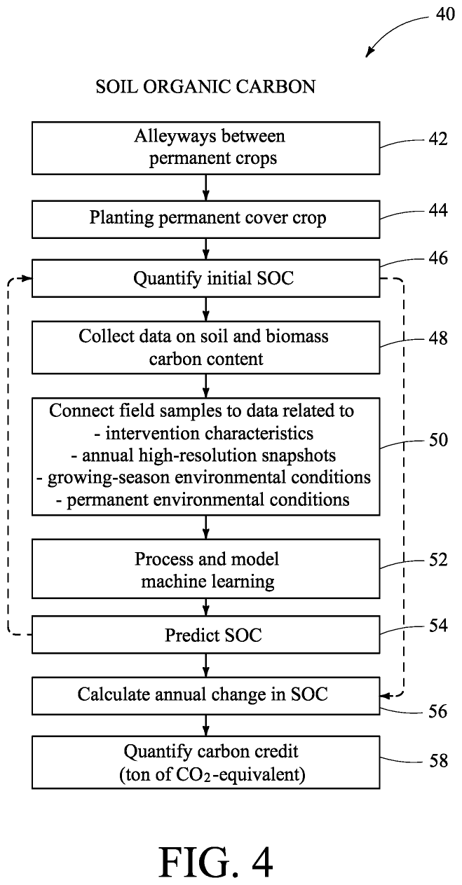

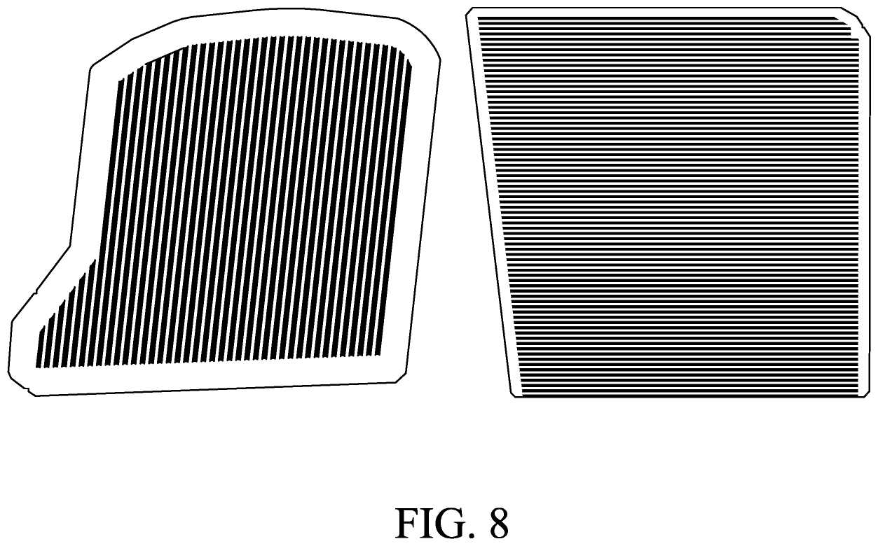

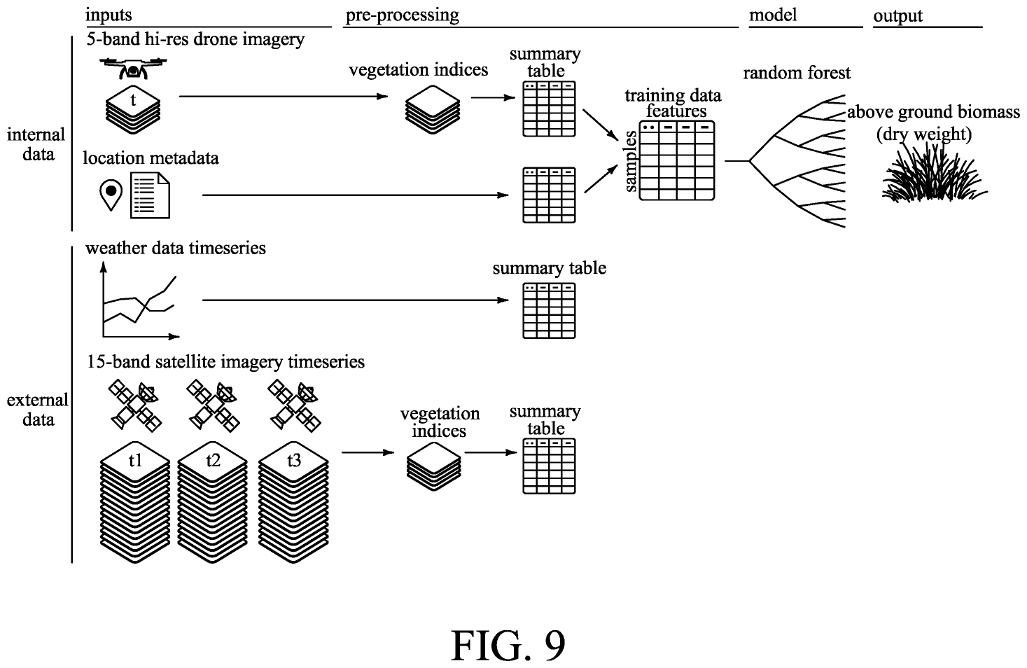

Referring next to FIG. 4, in a specific embodiment, method 40 can include identifying alleyways between permanent crops 42. This can include drone image segmentation as described with reference to FIGS. 8-9. In accordance with example implementations, portions of parcels, or alleyways between commodity crops are identified. Cover crops are planted within the alleyways 44. Initial soil organic carbon content can be determined from samples collected from sampling sites and analyzed at 46 and 48. These sampling sites can be determined in accordance with FIGS. 5A-5C. At 50, field samples collected and analyzed can be associated and/or connected to data (such as predictive data) related to intervention characteristics, annual high-resolution snapshots, growing season environmental conditions and permanent environmental conditions, for example. At 52 process and modeling that can include machine learning to predict the soil organic carbon content at 54. At 56, the annual change in soil organic carbon content can be calculated. At 58 carbon credits from additional soil organic carbon added to the parcel or portion thereof can be determined.

Referring next to FIGS. 5A-5C as well as Table 1 below, sampling site determination is described. To determine sampling sites in accordance with steps 1-3, soil information, elevation, and imagery are acquired from the parcels of interest. A statistical clustering identifies the number of statistically different groups of patterns and groups areas of the field into units and/or sampling zones. Processes for determining sample sites can also include those disclosed in Hartigan, J. A., & Wong, M. A. (1979). Algorithm AS 136: A k-means clustering algorithm. Journal of the royal statistical society. series c (applied statistics), 28(1), 100-108, and/or Pelleg, D., & Moore, A. W. (2000, June). X-means: Extending k-means with efficient estimation of the number of clusters. In IcmI (Vol. 1, pp. 727-734), the entirety of both of which are incorporated by reference herein.

TABLE 1

| Points | Feature 1 | Feature 2 | Feature 3 | Feature 4 |
|---|---|---|---|---|
| P1 | 100 | 45 | 0.1 | 1000 |
| P2 | 99 | 50 | 0.1 | 900 |
| P3 | 14 | 2 | 9 | 25 |
| P4 | 75 | 55 | 0.1 | 800 |
| P5 | 15 | 2 | 10 | 30 |
| P6 | 13 | 1 | 11 | 34 |
| P7 | 25 | 8 | 0.1 | 0 |
| P8 | 29 | 10 | 0.01 | 2 |
| P9 | 31 | 10.5 | 0.1 | 1 |

In accordance with the below reference, a second statistical algorithm is run for each zone that identifies where within the sampling zone to best represent the statistical distribution of the sampling zones. Processes for determining sample sites can also include those disclosed in Minasny, B., & McBratney, A. B. (2006). A conditioned Latin hypercube method for sampling in the presence of ancillary information. Computers & geosciences, 32(9), 1378-1388 the entirety of which is incorporated by reference herein.

In italics of Table 1 are group three data corresponding to group 3(P7-P9) of FIG. 5B. These features are shown in the 5B graph. This determination can be made for sampling target data.

The processing circuitry of the system of the present disclosure is not limited to that depicted in FIG. 17. For example, the processing circuitry can include a personal computing system that includes a computer processing unit that can include one or more microprocessors, one or more support circuits, circuits that include power supplies, clocks, input/output interfaces, circuitry, and the like. Generally, all computer processing units described herein can be of the same general type. Application Programming Interface (API) can allow for communication between different software applications in the system. The memory can include random access memory, read-only memory, removable disc memory, flash memory, and various combinations of these types of memory. The memory can be referred to as a main memory and be part of a cache memory or buffer memory. The memory can store various software packages and components such as an operating system.

The computing system may also include a web server that can be of any type of computing device adapted to distribute data and process data requests. The web server can be configured to execute system application software such as the reminder schedule software, databases, electronic mail, and the like. The memory of the web server can include system application interfaces for interacting with users and one or more third party applications. Computer systems of the present disclosure can be standalone or work in combination with other servers and other computer systems that can be utilized, for example, with larger corporate systems such as financial institutions, insurance providers, and/or software support providers. The system is not limited to a specific operating system but may be adapted to run on multiple operating systems such as, for example, Linux and/or Microsoft Windows. The computing system can be coupled to a server and this server can be located on the same site as the computer system or at a remote location, for example.

In accordance with example implementations, these processes may be utilized in connection with the processing circuitry described. The processes may use software and/or hardware of the following combinations or types. For example, with respect to server-side languages, the circuitry may use Java, Python, PHP, .NET, Ruby, JavaScript, Golang, R, or Dart, for example. Some other types of servers that the systems may use include Apache/PHP, .NET, Ruby, NodeJS, Java, R, Golang, and/or Python. Databases that may be utilized are Oracle, MySQL, SQL, NoSQL, or SQLite (for Mobile) as well as any type of relational, key-value, in memory, document, wide column, graph, time series, or ledger databases. Client-side languages that may be used, this would be the user side languages, for example, are ASM, C, C++, C#, Java, Objective-C, Swift, ActionScript/Adobe AIR, or JavaScript/HTML5. Communications between the server and client may be utilized using TCP/UDP Socket based connections, for example, as Third-Party data network services that may be used include GSM, LTE, HSPA, UMTS, CDMA, WiMAX, WIFI, Cable, and DSL. The hardware platforms that may be utilized within processing circuitry include embedded systems such as (Raspberry PI/Arduino), (Android, iOS, Windows Mobile), phones and/or tablets, or any embedded system using these operating systems, i.e., cars, watches, glasses, headphones, augmented reality wear, etc., or desktops/laptops/hybrids (Mac, Windows, Linux). The architectures that may be utilized for software and hardware interfaces include x86 (including x86-64), or ARM.

The systems and/or processing circuitry of the present disclosure can include a server or cluster of servers, one or more devices, additional computing devices, several network connections linking devices to server(s) including the network connections, one or more databases, and a network connection between the server and the additional computing devices, such as those devices that may be linked to an adjuster.

Devices and/or processing circuitry and/or plurality of devices and the additional computing device can be any type of communication devices that support network communication, including a telephone, a mobile phone, a smart phone, a personal computer, a laptop computer, a smart watch, a personal digital assistant (PDA), a wearable or embedded digital device(s), a network-connected vehicle, etc. In some embodiments, the devices and the computing device can support multiple types of networks. For example, the devices and the computing device may have wired or wireless network connectivity using IP (Internet Protocol) or may have mobile network connectivity allowing over cellular and data networks.

The various networks may take the form of multiple network topologies. For example, networks can include wireless and/or wired networks. Networks can link the server and the devices. Networks can include infrastructure that support the links necessary for data communication between at least one device and a server. Networks may include a cell tower, base station, and switching network as well as cloud-based networks.

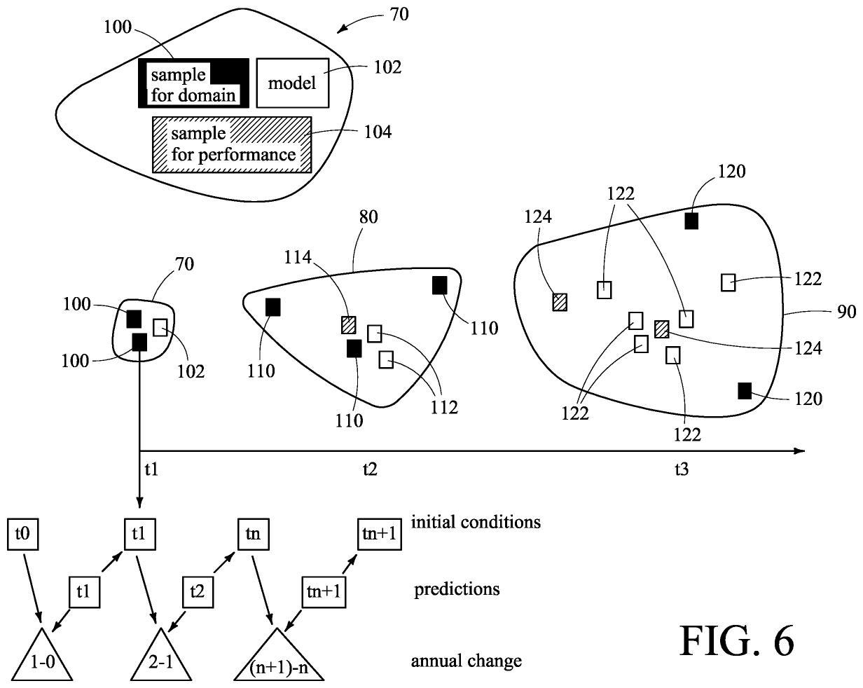

Referring next to FIG. 6, the modeling domain 70 (which can include a parcel or portion of a parcel) is shown, which encompasses rectangles that denote data. At 100, target agricultural data is collected for the purpose of expanding the modeling domain. This target agricultural data is acquired from samples taken from collection sites. At 102, using the target agricultural data and predictive parcel data, modeled target agricultural data is determined. At 104, target agricultural data is collected to improve model performance. This target agricultural data is sampled at collection sites that were either previously sampled or previously modeled. Accordingly, at t1, two samples 100 were taken and modeled data is determined at 102. This process can be iterative as shown by example, with initial conditions (tn+1). Accordingly, domain 80 is shown that may encompass domain 70 at t2, while domain 90 is shown that may encompass both domains 80 and 70 at t3. As shown, the sampling and modeling is different at each time step t1-t3. At t2, domain 80 has target agricultural data 110 (110 rather 100 because this data is collected at t2) collected. This data is processed with predictive parcel data to determine modeled data 112. Additionally, previously sampled 100 at t1 is sampled for performance at 114.

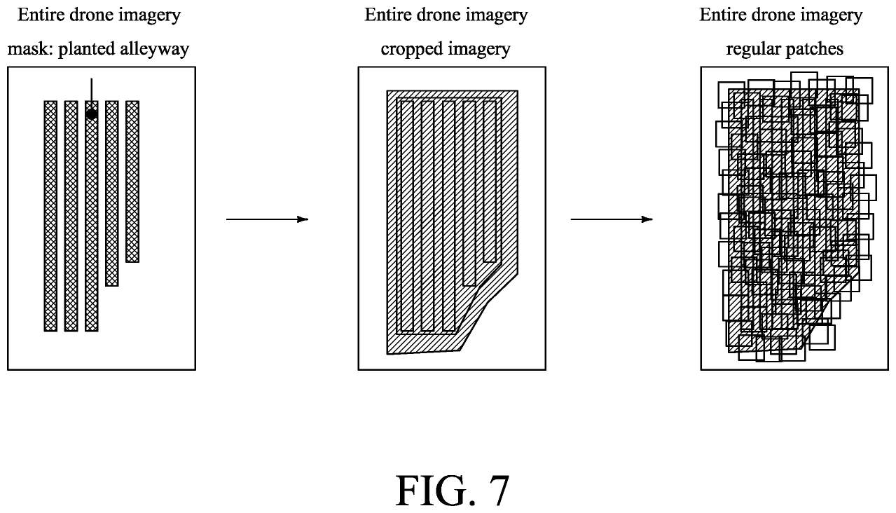

At t3, domain 90 has target agricultural data 120 collected to expand modeling domain. This data a is processed with predictive parcel data to determine modeled data 122. Additionally, at t3, sample for performance is taken at 124. At each iteration the target agricultural model is updated. Referring next to FIG. 7, an example classification of images for determining the alleyways between commodity crops is shown. The alleyways and the borders are defined throughout the imagery to dictate where overlap occurs between alleyways and commodity crops using processing circuitry. For example, a myriad patches can be defined and these patches can be training data for a model. Accordingly, parcels can be provided as shown in FIG. 8, wherein black indicates the alleyways and white indicates the commodity crops. In accordance with example implementations, the masked images can be used to determine sampling sites. For example, sampling sites for actual sampling and/or prediction can be confined to sites within the alleyways.

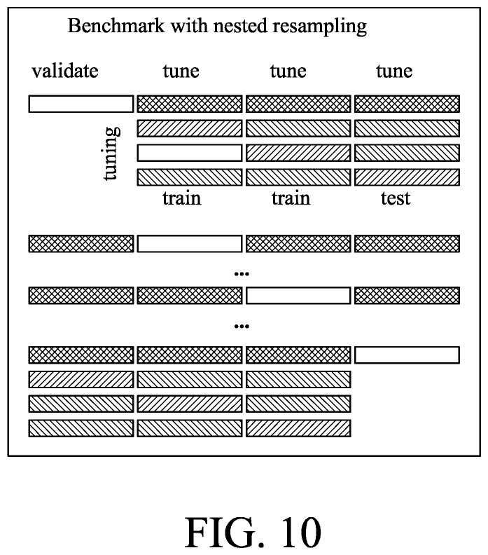

Referring to FIG. 9, an overall system and/or method is shown. In accordance with example implementations, the system inputs or predictive data can include both internal data and/or external data. The internal data is data acquired by the user, for example drone imagery and/or location metadata (for example, agricultural system, type of crop, age of intervention, etc.). The external data is typically publicly available data. For example, weather data time series and/or multiple satellite imagery timeseries. As shown, this data can be preprocessed which includes summarizing vegetation indices tables which can then be used as training data. The training data can be used to train a machine learning model, and the model can be used to generate modeled data as an output. In accordance with example implementations and with reference to FIG. 10, the system provides for a benchmarking operation and a validation operation as well as a tuning operation and a training operation and then a testing operation of the system as shown to validate the system.

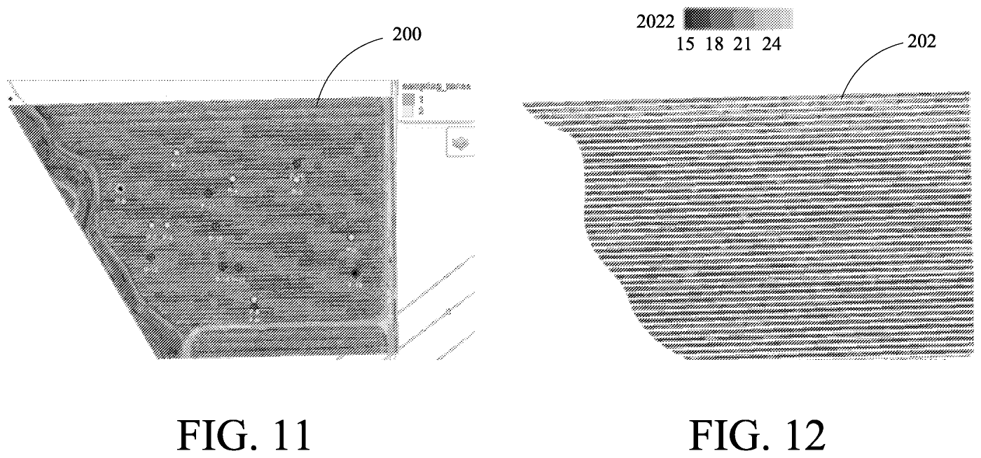

Referring next to FIGS. 11 and 12, a parcel 200 has been identified in FIG. 11, and in FIG. 12 a digitized parcel 202 is shown that demonstrates modeled data. Sample sites have been determined within parcel 200 and these sample sites are within alleyways between commodity crops. Referring first to Tables 2 and 3, point measurements may be acquired at points 1, 2 and 3 as shown in FIG. 12.

TABLE 2
Point Measurements of Parcel 200

| | | |
|---|---|---|
| Point 1: | 6 | tons C/acre |
| Point 2: | 15 | tons C/acre |
| Point 3: | 13 | tons C/acre |
| Average: | 11 | tons C/acre |
| Standard Deviation: | 3 | tons C/acre |
| Annual Change 2021-2022: | 0.2 | tons C/acre |

| | |
|---|---|
| Model Performance: | 20% MAPE |

TABLE 3
Modeled Data of Parcel 202

| | | |
|---|---|---|
| Average | 11 | tons C/acre |
| Standard Deviation | 3 | tons C/acre |
| Annual Change 2021-2022 | +0.2 | tons C/acre |

| | |
|---|---|
| Model Performance: | 20% MAPE |

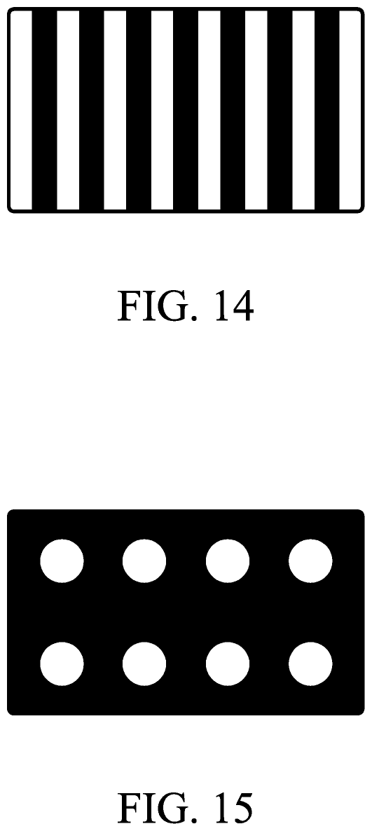

As shown in FIG. 14, at target data of parcel 190 there are sampling points A, B, C and D within alleyways that have been provided through masking as described. In parcel 200 sampling points F and E are shown, and in parcel 300, no actual sampling has been performed. Accordingly, FIG. 14 is an example use of at least two parcels (190 and 200) and portions of each to determine carbon per acre of parcel or portions of parcel 300. Data associated with parcel 190 is represented in the tables as X2, data associated with parcel 200 is represented in the tables at V4, and data associated with parcel 300 is represented in the tables as V3. As a legend, 180 can represent a parcel having a boundary, 186 can represent the subset of predictive data associated with modeled parcels or portions of Step 2, and 188 can represent validated, or modeled values compared to observed values at Step 3.

In accordance with example implementations, to tables 4-9, the processing circuitry utilizing publicly available machine learning programs such as any ensemble or combination of a time series analysis, a spectral analysis, a network analysis, a correlation analysis, a generalized linear model, a generalized additive model, a nearest-neighbor model, a decision tree model, a support vector machine model, a Bayesian model, a Gaussian processes model, an artificial neural network, a recurrent neural network, a convolutional neural network, a generative adversarial neural network, a transformer model, and with operations such as a clustering operation, a regression operation, a classification operation, a feature selection operation, a feature engineering operation, a spatio-temporal resampling operation, a benchmarking operation, a training operation, a testing operation, a validation operation, a tuning operation, a genetic algorithm operation, a Monte-Carlo operation, a bagging operation, an ensembling operation, a gradient boosting operation, a regularization operation, a supervised learning operation, an unsupervised learning operation, a self-supervised learning operation, a semi-supervised learning operation, a reinforcement learning operation, and a sequence-to-sequence learning operation

As an example and with reference to Table 4 multiple samples were taken at collection sites of parcels 190 and 200.

TABLE 4
Target Agricultural Data Sampled

| | | | | | depth | fresh weight | dry weight | toc |
|---|---|---|---|---|---|---|---|---|
| Parcel | date collected | description | type | zone | (cm) | (g) | (g) | % |
| V4 | Apr. 6, 2021 | V4-P-4 | soil | | 30 | 54.21 | | |
| V4 | Apr. 6, 2021 | V4-P-5 | soil | | 30 | 113.56 | | |
| V4 | Apr. 6, 2021 | V4-P-10 | soil | | 30 | 92.388 | | |
| V4 | Apr. 6, 2021 | V4-P-1SX | soil sub- | | 30 | 86.019 | | |
| | | | composite | | | | | |
| V4 | Apr. 6, 2021 | V4-P-2SX | soil sub- | | 30 | 86.053 | | |
| | | | composite | | | | | |
| V4 | Apr. 6, 2021 | V4-P-3SX | soil sub- | | 30 | 85.297 | | |
| | | | composite | | | | | |
| V4 | Mar. 4, 2022 | V4-P-2 | soil | | 30 | 41.502 | | |
| V4 | Mar. 4, 2022 | V4-P-10 | soil | | 30 | 34.406 | | |
| V4 | Mar. 4, 2022 | V4-P-5 | soil | | 30 | 36.991 | | |
| V4 | Mar. 4, 2022 | V4-P-7 | soil | | 30 | 47.111 | | |
| V4 | Mar. 4, 2022 | V4-P-4 | soil | | 30 | 50.01 | | |
| V4 | Mar. 4, 2022 | V4-P-1SX | soil sub- | | 30 | 52.513 | 48.962 | |
| | | | composite | | | | | |
| V4 | Mar. 4, 2022 | V4-P-2SX | soil sub- | | 30 | 52.503 | 46.818 | |
| | | | composite | | | | | |
| V4 | Mar. 4, 2022 | V4-P-3SX | soil sub- | | 30 | 52.511 | 49.896 | |
| | | | composite | | | | | |
| V4 | Mar. 4, 2022 | V4-P-4SX | soil sub- | | 30 | 51.747 | 47.36 | 0.62 |
| | | | composite | | | | | |
| X2 | Mar. 20, 2021 | X2-P-1 | soil | | 30 | 103.013 | | |
| X2 | Mar. 20, 2021 | X2-P-2 | soil | | 30 | 93.779 | | |
| X2 | Mar. 20, 2021 | X2-P-3 | soil | | 30 | 122.414 | | |
| X2 | Mar. 20, 2021 | X2-P-4 | soil | | 30 | 104.443 | | |
| X2 | Mar. 20, 2021 | X2-P-5 | soil | | 30 | 88.387 | | |
| X2 | Mar. 20, 2021 | X2-P-6 | soil | | 30 | 91.791 | | |
| X2 | Mar. 20, 2021 | X2-P-7 | soil | | 30 | 87.666 | | |
| X2 | Mar. 20, 2021 | X2-P-8 | soil | | 30 | 87.053 | | |
| X2 | Mar. 20, 2021 | X2-P-10 | soil | | 30 | 79.573 | | |
| X2 | Mar. 20, 2021 | X2-P-11 | soil | | 30 | 97.584 | | |
| X2 | Mar. 20, 2021 | X2-P-1SX | Soil Sub- | | 30 | 316.737 | | |
| | | | composite | | | | | |
| X2 | Mar. 20, 2021 | X2-P-2SX | Soil Sub- | | 30 | 315.583 | | |
| | | | composite | | | | | |
| X2 | Mar. 20, 2021 | X2-P-3SX | Soil Sub- | | 30 | 309.573 | | |
| | | | composite | | | | | |
| X2 | Feb. 12, 2022 | X2-P-4 | soil | | 30 | 44.22 | | |
| X2 | Feb. 12, 2022 | X2-P-9 | soil | | 30 | 41.32 | | |
| X2 | Feb. 12, 2022 | X2-P-10 | soil | | 30 | 52.366 | | |
| X2 | Feb. 12, 2022 | X2-P-7 | soil | | 30 | 43.364 | | |
| X2 | Feb. 12, 2022 | X2-P-5 | soil | | 30 | 50.356 | | |
| X2 | Feb. 12, 2022 | X2-P-1SX | soil sub- | | 30 | 57.926 | 46.77 | |
| | | | composite | | | | | |
| X2 | Feb. 12, 2022 | X2-P-2SX | soil sub- | | 30 | 57.943 | 46.891 | |
| | | | composite | | | | | |
| X2 | Feb. 12, 2022 | X2-P-3SX | soil sub- | | 30 | 57.945 | 47.508 | |
| | | | composite | | | | | |
| X2 | Feb. 12, 2022 | X2-P-4SX | soil sub- | | 30 | 56.736 | 44.67 | 1.7 |
| | | | composite | | | | | |
| X2 | Feb. 12, 2022 | X2-P-4SX | soil sub- | | | | | 1.68 |
| | | | composite | | | | | |
| V4 | Jul. 19, 2021 | V4-P-0BD | bulk density | 0 | | | | |
| V4 | Jul. 19, 2021 | V4-P-4BD | bulk density | 4 | | | | |
| V4 | Jul. 19, 2021 | V4-P-1BD | bulk density | 1 | | | | |
| V4 | Jul. 19, 2021 | V4-P-2BD | bulk density | 2 | | | | |

| | bd | | Amount | (mg) | | (mg) | | |
|---|---|---|---|---|---|---|---|---|
| Parcel | (g/cm3) | bd_p50_15_30 | (mg) | N | % N | C | % C | C:N Ratio |
| V4 | | | | | | | | |
| V4 | | | | | | | | |
| V4 | | | | | | | | |
| V4 | | | 19.5 | 0.017 | 0.09 | 0.184 | 0.94 | 10.8235294 |
| V4 | | | 15.6 | 0.012 | 0.08 | 0.123 | 0.79 | 10.25 |
| V4 | | | 16.6 | 0.013 | 0.08 | 0.135 | 0.81 | 10.3846154 |
| V4 | | 1.53 | | | | | | |
| V4 | | 1.27 | | | | | | |
| V4 | | 1.63 | | | | | | |
| V4 | | 1.63 | | | | | | |
| V4 | | 1.29 | | | | | | |
| V4 | | | 16.6 | 0.017 | 0.1 | 0.156 | 0.96 | 9.18 |
| V4 | | | 18.4 | 0.017 | 0.1 | 0.171 | 1.01 | 10.06 |
| V4 | | | 17.1 | 0.017 | 0.1 | 0.154 | 0.93 | 9.06 |
| V4 | | | | | | | | |
| X2 | | | | | | | | |
| X2 | | | | | | | | |
| X2 | | | | | | | | |
| X2 | | | | | | | | |
| X2 | | | | | | | | |
| X2 | | | | | | | | |
| X2 | | | | | | | | |
| X2 | | | | | | | | |
| X2 | | | | | | | | |
| X2 | | | | | | | | |
| X2 | | | 19.9 | 0.031 | 0.16 | 0.312 | 1.57 | 10.0645161 |
| X2 | | | 17.5 | 0.024 | 0.13 | 0.292 | 1.67 | 12.1666667 |
| X2 | | | 17.9 | 0.02 | 0.11 | 0.26 | 1.45 | 13 |
| X2 | | 1.39 | | | | | | |
| X2 | | 1.39 | | | | | | |
| X2 | | 1.39 | | | | | | |
| X2 | | 1.49 | | | | | | |
| X2 | | 1.49 | | | | | | |
| X2 | | | 17.8 | 0.02 | 0.11 | 0.392 | 2.2 | 19.6 |
| X2 | | | 16 | 0.015 | 0.1 | 0.328 | 2.05 | 21.87 |
| X2 | | | 19.2 | 0.019 | 0.1 | 0.41 | 2.14 | 21.58 |
| X2 | | | | | | | | |
| X2 | | | | | | | | |
| V4 | 1.44 | | | | | | | |
| V4 | 0.57 | | | | | | | |
| V4 | 1.30 | | | | | | | |
| V4 | 1.43 | | | | | | | |

In accordance with example implementations, the target data of Table 4 samples were associated with a myriad of candidate predictor data associated with the collection site at 183, for example. The sample data is shown associated with candidate predictor data in Table 5.

These 68 predictor values as shown in Table 5 are summarized over space across four summary metrics. There are also 128 predictors derived from Sentinel-2 imagery summarized over time and then two predictors derived from sunlight hours, 20 predictors derived from daily meteorological summarized over time, five predictors derived from location information and 15 predictors derived from gNATSGO as well as 245 predictors derived from soil grids 250 variables. Predictors can also include legacy predictors, two of which are derived from clay content as well.

TABLE 5
Candidate Predictor Values

| | Parcel X2 | | | | |
|---|---|---|---|---|---|
| Predictive | Sample Location | | | | |
| Parcel Data | X2-P-4 | X2-P-9 | X2-P-10 | X2-P-7 | X2-P-5 |
| CI_min | 0.179167718 | 0.210017985 | 0.230493887 | 0.307210737 | 0.120695699 |
| CI_mean | 0.490652738 | 0.52563623 | 0.455869832 | 0.519407918 | 0.485004001 |
| CI_max | 0.617626555 | 0.634187752 | 0.586850959 | 0.639792967 | 0.633414048 |
| CI_sd | 0.084537601 | 0.088728514 | 0.056066238 | 0.058753236 | 0.10596902 |
| MCARI_min | 7.14E−06 | −9.45E−07 | −4.27E−06 | −4.18E−06 | −3.14E−06 |
| MCARI_mean | 0.00580061 | 0.003927367 | 0.005706154 | 0.005717895 | 0.004352375 |
| MCARI_max | 0.020021112 | 0.023502497 | 0.013211475 | 0.022790876 | 0.020354753 |
| MCARI_sd | 0.004298485 | 0.004404259 | 0.005158668 | 0.004683299 | 0.004301355 |
| NDWI_min | −0.822735055 | −0.821158896 | −0.863967714 | −0.817751488 | −0.856799933 |
| NDWI_mean | −0.699771811 | −0.677040129 | −0.680822088 | −0.702496749 | −0.660539745 |
| NDWI_max | −0.424344443 | −0.40932772 | −0.396501297 | −0.398227378 | −0.414774299 |
| NDWI_sd | 0.099306333 | 0.08435168 | 0.139520185 | 0.1106884 | 0.122194629 |
| VARI_min | −0.292241596 | −0.350405477 | −0.351743352 | −0.322972416 | −0.317569917 |
| VARI_mean | −0.017370633 | −0.154496898 | −0.047931958 | −0.036073158 | −0.079548942 |
| VARI_max | 0.525553297 | 0.442091979 | 0.421903386 | 0.410072665 | 0.584522547 |
| VARI_sd | 0.2070003 | 0.166573936 | 0.210401291 | 0.177343437 | 0.224827227 |
| kNDVI_min | 0.000224572 | 0.075771581 | 0.05669348 | 0.069713954 | 0.073722392 |
| kNDVI_mean | 0.433830582 | 0.34923593 | 0.402701833 | 0.433372216 | 0.364011409 |
| kNDVI_max | 0.681886457 | 0.666383155 | 0.670071754 | 0.647479951 | 0.708404553 |
| kNDVI_sd | 0.165648632 | 0.141959028 | 0.22143015 | 0.181466614 | 0.191967817 |
| NDVI_min | 0.283544261 | 0.275530566 | 0.258442701 | 0.26424841 | 0.27176532 |
| NDVI_mean | 0.673483126 | 0.596077507 | 0.63526929 | 0.67074815 | 0.602519511 |
| NDVI_max | 0.912486427 | 0.8967769 | 0.900485068 | 0.878036047 | 0.940198878 |
| NDVI_sd | 0.167226453 | 0.141099257 | 0.225146433 | 0.181953419 | 0.196078124 |
| SAVI_min | 0.083607638 | 0.065354536 | 0.04620825 | 0.068617517 | 0.049476246 |
| SAVI_mean | 0.441743859 | 0.381067537 | 0.403961314 | 0.435083387 | 0.384575409 |
| SAVI_max | 0.718017193 | 0.730439052 | 0.703324349 | 0.68561899 | 0.836735249 |
| SAVI_sd | 0.150623331 | 0.134185255 | 0.214069315 | 0.169131679 | 0.188756418 |
| GNDVI_min | 0.424344443 | 0.40932772 | 0.398501297 | 0.398227378 | 0.414774299 |
| GNDVI_mean | 0.699771811 | 0.677040129 | 0.680822088 | 0.702496749 | 0.660539746 |
| GNDVI_max | 0.822735056 | 0.821158896 | 0.869957714 | 0.817751488 | 0.855799933 |
| GNDVI_sd | 0.099306333 | 0.08435166 | 0.139520186 | 0.1106884 | 0.122194629 |
| ENDVI_min | 0.356668754 | 0.301090749 | 0.25722593 | 0.316422 | 0.2769425 |
| ENDVI_mean | 0.721730561 | 0.674272586 | 0.670575466 | 0.725823789 | 0.661852343 |
| ENDVI_max | 0.88668654 | 0.861690575 | 0.904745045 | 0.87786623 | 0.906204897 |
| ENDVI_sd | 0.136804679 | 0.115459944 | 0.194289039 | 0.154531102 | 0.175403556 |
| LCI_min | 0.205417711 | 0.209129882 | 0.1880328 | 0.202739503 | 0.191494792 |
| LCI_mean | 0.480490339 | 0.433581495 | 0.464080978 | 0.48421181 | 0.445456498 |

| | Parcel V4 | | | |
|---|---|---|---|---|
| Predictive | Sample Location | | | |
| Parcel Data | V4-P-2 | V4-P-10 | V4-P-5 | V4-P-7 |
| CI_min | 0.078302272 | 0.111900615 | 0.038698810 | 0.205234402 |
| CI_mean | 0.350495441 | 0.394993664 | 0.363795543 | 0.484769094 |
| CI_max | 0.591839445 | 0.62611427 | 0.519228247 | 0.516806085 |
| CI_sd | 0.094555841 | 0.108786541 | 0.084123505 | 0.079807487 |
| MCARI_min | 5.21E−05 | 3.14E−05 | 8.74E−05 | 1.58E−05 |
| MCARI_mean | 0.003980679 | 0.002557302 | 0.004058522 | 0.00135785 |
| MCARI_max | 0.01624406 | 0.011076091 | 0.012608365 | 0.008720223 |
| MCARI_sd | 0.003688326 | 0.003045479 | 0.002618125 | 0.001818403 |
| NDWI_min | −0.796137507 | −0.738301297 | −0.771056917 | −0.701062675 |
| NDWI_mean | −0.577147701 | −0.492222958 | −0.605422885 | −0.45388792 |
| NDWI_max | −0.306498978 | −0.308084077 | −0.327505917 | −0.313362699 |
| NDWI_sd | 0.155216881 | 0.149706584 | 0.11825602 | 0.113707597 |
| VARI_min | −0.247734513 | −0.301510019 | −0.223557744 | −0.277955424 |
| VARI_mean | 0.101994413 | −0.017488034 | 0.096428283 | −0.139754142 |
| VARI_max | 0.666542987 | 0.428531559 | 0.581959793 | 0.345127085 |
| VARI_sd | 0.236862536 | 0.225182255 | 0.19220215 | 0.13950943 |
| kNDVI_min | 0.018748829 | 0.014045902 | 0.044286027 | 0.015440634 |
| kNDVI_mean | 0.366601457 | 0.247858525 | 0.391063587 | 0.156062253 |
| kNDVI_max | 0.664266383 | 0.61954207 | 0.662423225 | 0.566085925 |
| kNDVI_sd | 0.236752513 | 0.221050807 | 0.181620856 | 0.155124515 |
| NDVI_min | 0.136934389 | 0.118519304 | 0.210511315 | 0.124265284 |
| NDVI_mean | 0.587343945 | 0.451562822 | 0.626017184 | 0.356517309 |
| NDVI_max | 0.894555821 | 0.851035578 | 0.892815385 | 0.801089325 |
| NDVI_sd | 0.258147142 | 0.257355507 | 0.193492148 | 0.190835874 |
| SAVI_min | 0.064394546 | 0.075575543 | 0.061178497 | 0.076653534 |
| SAVI_mean | 0.313066551 | 0.238582358 | 0.33311175 | 0.178107177 |
| SAVI_max | 0.636013607 | 0.544438092 | 0.572615732 | 0.472104045 |
| SAVI_sd | 0.177276393 | 0.15364951 | 0.124576985 | 0.096225335 |
| GNDVI_min | 0.306498978 | 0.308084077 | 0.327505917 | 0.313362699 |
| GNDVI_mean | 0.577147701 | 0.492222958 | 0.605422885 | 0.45388792 |
| GNDVI_max | 0.796137507 | 0.738301297 | 0.771056917 | 0.701052676 |
| GNDVI_sd | 0.165216881 | 0.149708584 | 0.11825602 | 0.113707597 |
| ENDVI_min | 0.286414958 | 0.304890713 | 0.312452726 | 0.369076621 |
| ENDVI_mean | 0.810624213 | 0.522339819 | 0.637716277 | 0.491455071 |
| ENDVI_max | 0.8553800 | 0.807328739 | 0.833448071 | 0.753179397 |
| ENDVI_sd | 0.191950326 | 0.164952039 | 0.143876173 | 0.10340289 |
| LCI_min | 0.085025621 | 0.067848885 | 0.137335326 | 0.079849931 |
| LCI_mean | 0.375462161 | 0.280871784 | 0.391787803 | 0.210587874 |

| | Parcel X2 | | | | |
|---|---|---|---|---|---|
| | Sample Location | | | | |
| | X2-P-4 | X2-P-9 | X2-P-10 | X2-P-7 | X2-P-5 |
| LCI_max | 0.651713205 | 0.638710557 | 0.689423053 | 0.640112548 | 0.734597912 |
| LCI_sd | 0.104306524 | 0.085491496 | 0.141010307 | 0.115384016 | 0.129366623 |
| EVI_min | 0.075538843 | 0.058924869 | 0.041296473 | 0.061397705 | 0.044130583 |
| EVI_mean | 0.452193526 | 0.378851921 | 0.420486428 | 0.443830854 | 0.391327515 |
| EVI_max | 0.817297988 | 0.856816513 | 0.791846761 | 0.77336168 | 1.008477412 |
| EVI_sd | 0.172539403 | 0.156166382 | 0.239556519 | 0.187879957 | 0.214475538 |
| NIRv_min | 0.069064699 | 0.049934309 | 0.0382699 | 0.059407242 | 0.036641385 |
| NIRv_mean | 0.322603278 | 0.294646427 | 0.293813893 | 0.31384686 | 0.291477404 |
| NIRv_max | 0.554616809 | 0.595755544 | 0.559029996 | 0.531940043 | 0.715683937 |
| NIRv_sd | 0.09838997 | 0.092854499 | 0.143492036 | 0.110174591 | 0.130478001 |
| GLI_min | −0.07161784 | −0.092493087 | −0.108026451 | −0.082469222 | −0.082780604 |
| GLI_mean | 0.128761802 | 0.036765157 | 0.099584751 | 0.125333076 | 0.084268651 |
| GLI_max | 0.462951189 | 0.374599567 | 0.395188971 | 0.405554156 | 0.472740686 |
| GLI_sd | 0.132800946 | 0.102399262 | 0.144793209 | 0.12395267 | 0.145848808 |
| CVI_min | 3.080762759 | 2.884845234 | 2.943879241 | 3.141879651 | 3.151760106 |
| CVI_mean | 6.173023851 | 6.88232553 | 6.293305121 | 6.541599011 | 5.974441352 |
| CVI_max | 8.774352492 | 9.608594713 | 9.745779222 | 9.896908826 | 10.38196655 |
| CVI_sd | 1.325121771 | 1.258829949 | 1.593696337 | 1.578851171 | 1.524421008 |
| CI_Rededge_min | 0.454588724 | 0.456386859 | 0.411252782 | 0.460715416 | 0.401948491 |
| CI_Rededge_mean | 1.371252164 | 1.202502495 | 1.357342987 | 1.4115550801 | 1.30121101 |
| CI_Rededge_max | 2.190341837 | 2.078544158 | 2.59814453 | 2.21955144 | 3.120602488 |
| CI_Rededge_sd | 0.36438188 | 0.287537438 | 0.513335956 | 0.419919374 | 0.519323804 |
| NDRE_min | 0.185199549 | 0.185796003 | 0.170555849 | 0.18722824 | 0.167342677 |
| NDRE_mean | 0.399204615 | 0.370440608 | 0.389673286 | 0.403988808 | 0.379994611 |
| NDRE_max | 0.52271197 | 0.509640968 | 0.574300027 | 0.526015969 | 0.609420961 |
| NDRE_sd | 0.070512147 | 0.056797602 | 0.096401189 | 0.079663874 | 0.09159187 |
| system | Vineyard | Vineyard | Vineyard | Vineyard | Vineyard |
| crop | Wine grapes | Wine grapes | Wine grapes | Wine grapes | Wine grapes |
| age | 3 | 3 | 3 | 3 | 3 |
| prcp_mean | 3.583506927 | 3.583506927 | 3.583506927 | 3.583506927 | 3.583506927 |
| prcp_max | 138.7399979 | 138.7399979 | 138.7399979 | 138.7399979 | 138.7399979 |
| prcp_sd | 13.78393873 | 13.78393873 | 13.78393873 | 13.78393873 | 13.78393873 |
| srad_min | 57.93000031 | 57.93000031 | 57.93000031 | 57.93000031 | 57.93000031 |
| srad_mean | 243.1942705 | 243.1942705 | 243.1942705 | 243.1942705 | 243.1942705 |
| srad_max | 449.1699982 | 449.1699982 | 449.1699982 | 449.1699982 | 449.1699982 |
| srad_sd | 93.71569219 | 93.71569219 | 93.71569219 | 93.71569219 | 93.71569219 |
| tmax_min | 7.869999886 | 7.869999886 | 7.869999886 | 7.869999886 | 7.869999886 |
| tmax_mean | 18.82722225 | 18.82722225 | 18.82722225 | 18.82722225 | 18.82722225 |
| tmax_max | 34.875 | 34.875 | 34.875 | 34.875 | 34.875 |
| tmax_sd | 5.819062389 | 5.819062389 | 5.819062389 | 5.819062389 | 5.819062389 |
| tmin_min | −0.925000012 | −0.925000012 | −0.925000012 | −0.925000012 | −0.925000012 |
| tmin_mean | 7.037604171 | 7.037604171 | 7.037604171 | 7.037604171 | 7.037604171 |
| tmin_max | 13.99499989 | 13.99499989 | 13.99499989 | 13.99499989 | 13.99499989 |
| tmin_sd | 3.540111509 | 3.540111509 | 3.540111509 | 3.540111509 | 3.540111509 |
| vp_min | 331.4100037 | 331.4100037 | 331.4100037 | 331.4100037 | 331.4100037 |
| vp_mean | 853.4975334 | 853.4975334 | 853.4975334 | 853.4975334 | 853.4975334 |
| vp_max | 1496.5 | 1496.5 | 1496.5 | 1496.5 | 1496.5 |
| vp_sd | 297.7363722 | 297.7363722 | 297.7363722 | 297.7363722 | 297.7363722 |
| sunlight_hr_mean | 10.35992146 | 10.35992146 | 10.35992146 | 10.35992146 | 10.35992146 |
| sunlight_hr_sum | 1502.188611 | 1502.188611 | 1502.188611 | 1502.188611 | 1502.188611 |
| sampling_date.y | 2022-02-10 | 2022-02-10 | 2022-02-10 | 2022-02-10 | 2022-02-10 |
| SCI_S2_min | −0.103550296 | −0.118054006 | −0.114543115 | −0.198720877 | −0.109693262 |
| SCI_S2_mean | −0.037066052 | −0.051367774 | −0.050919963 | −0.08693389 | −0.035724108 |
| SCI_S2_max | 0.04866426 | 0.055604075 | 0.053117783 | 0.016896209 | 0.041836581 |
| SCI_S2_sd | 0.034973128 | 0.043936348 | 0.046472457 | 0.066142846 | 0.034757288 |
| CI_S2_min | 0.095360825 | 0.079552926 | 0.079790713 | 0.074440053 | 0.054824561 |
| CI_S2_mean | 0.386956291 | 0.375101432 | 0.364571367 | 0.378394894 | 0.362377158 |
| CI_S2_max | 0.615321252 | 0.618559636 | 0.63317757 | 0.604669887 | 0.614107884 |
| CI_S2_sd | 0.163385594 | 0.168067587 | 0.169135545 | 0.163274104 | 0.172328609 |
| NDWI_S2_min | −0.682749045 | −0.682229965 | −0.682038052 | −0.693553223 | −0.664552949 |
| NDWI_S2_mean | −0.552189435 | −0.557473272 | −0.555963723 | −0.559739718 | −0.558000471 |
| NDWI_S2_max | −0.343935382 | −0.334446764 | −0.336949718 | −0.351855527 | −0.333616299 |
| NDWI_S2_sd | 0.095852876 | 0.104511979 | 0.103932312 | 0.09843271 | 0.100702988 |
| VARI_S2_min | −0.277821626 | −0.292328042 | −0.30589949 | −0.286769231 | −0.280395137 |
| VARI_S2_mean | −0.053989481 | −0.044981309 | −0.035130452 | −0.010403542 | −0.030977465 |
| VARI_S2_max | 0.191458027 | 0.218002813 | 0.226804124 | 0.282608696 | 0.207578254 |
| VARI_S2_sd | 0.157428578 | 0.178443792 | 0.183894386 | 0.203488832 | 0.173741588 |
| kNDVI_S2_min | 0.094301978 | 0.084381181 | 0.091387994 | 0.108715388 | 0.092647119 |
| kNDVI_S2_mean | 0.271012386 | 0.290128152 | 0.29220169 | 0.295706431 | 0.287142436 |
| kNDVI_S2_max | 0.45339859 | 0.480126608 | 0.485929732 | 0.513705976 | 0.472089578 |
| kNDVI_S2_sd | 0.120436596 | 0.142907301 | 0.146216716 | 0.160381689 | 0.135023714 |
| SAVI_S2_min | 0.46127067 | 0.436202656 | 0.454046101 | 0.495514658 | 0.457178449 |
| SAVI_S2_mean | 0.775309563 | 0.8003171 | 0.803534309 | 0.806316368 | 0.797913841 |
| SAVI_S2_max | 1.048712108 | 1.084764456 | 1.092583845 | 1.130063635 | 1.073928043 |
| SAVI_S2_sd | 0.189460296 | 0.222056506 | 0.224048965 | 0.244060059 | 0.209285775 |
| ENDVI_S2_min | 0.262233375 | 0.258271352 | 0.259898477 | 0.278177155 | 0.252835896 |
| ENDVI_S2_mean | 0.54852551 | 0.557059062 | 0.555231182 | 0.567183752 | 0.549572976 |
| ENDVI_S2_max | 0.674635889 | 0.705352411 | 0.715039678 | 0.752291305 | 0.739558025 |
| ENDVI_S2_sd | 0.131876851 | 0.144470880 | 0.140396643 | 0.142680403 | 0.140826838 |
| LCI_S2_B5_min | 0.219729207 | 0.207595435 | 0.209720237 | 0.221722003 | 0.215559767 |
| LCI_S2_B5_mean | 0.383871068 | 0.40136283 | 0.40100707 | 0.397586891 | 0.399005757 |
| LCI_S2_B5_max | 0.551599965 | 0.557831705 | 0.565984252 | 0.574299462 | 0.549786395 |
| LCI_S2_B5_sd | 0.094630161 | 0.105950743 | 0.111130124 | 0.122758054 | 0.102911713 |
| LCI_S2_B6_min | 0.085188028 | 0.077628793 | 0.087135506 | 0.04585759 | 0.098006645 |
| LCI_S2_B6_mean | 0.148595756 | 0.147990556 | 0.147638259 | 0.154914201 | 0.176618545 |
| LCI_S2_B6_max | 0.199522673 | 0.199661591 | 0.190462754 | 0.205725735 | 0.243587835 |
| LCI_S2_B6_sd | 0.034869238 | 0.036775408 | 0.032067043 | 0.035428107 | 0.039175709 |
| LCI_S2_B7_min | 0.029728725 | 0.014467184 | 0.000343053 | −0.016010385 | 0.057931834 |
| LCI_S2_B7_mean | 0.075469749 | 0.068649046 | 0.068035154 | 0.077692584 | 0.10489218 |
| LCI_S2_B7_max | 0.112649165 | 0.107875411 | 0.122282609 | 0.124823097 | 0.182478959 |
| LCI_S2_B7_sd | 0.025861716 | 0.02363296 | 0.02610168 | 0.032379523 | 0.027709092 |
| NIRv_S2_min | 1726 | 1636 | 1648 | 1710 | 1504 |
| NIRv_S2_mean | 2663.4375 | 2689.6875 | 2680.875 | 2954.40525 | 2572.71875 |
| NIRv_S2_max | 3618 | 3699 | 3625 | 3980 | 3553 |
| NIRv_S2_sd | 499.9369597 | 452.2335913 | 463.202151 | 477.0825221 | 484.8273543 |
| GLI_S2_min | −0.037518038 | −0.059606657 | −0.065786332 | −0.050445104 | −0.53066412 |
| GLI_S2_mean | 0.067190315 | 0.069821128 | 0.073115803 | 0.095181918 | 0.076108053 |
| GLI_S2_max | 0.218262806 | 0.217391304 | 0.212477928 | 0.284512618 | 0.227790433 |
| GLI_S2_sd | 0.08387675 | 0.097097855 | 0.097482372 | 0.117666037 | 0.094517492 |
| CVI_S2_min | 2.182998571 | 2.153445559 | 2.148333354 | 2.145762029 | 2.133842347 |
| CVI_S2_mean | 4.044151796 | 4.189820699 | 4.108489159 | 3.851524008 | 3.974820041 |
| CVI_S2_max | 6.243507873 | 6.389281555 | 6.257888099 | 5.599971517 | 6.054186851 |
| CVI_S2_sd | 1.272033295 | 1.27375194 | 1.23572309 | 1.087907079 | 1.202721204 |
| CI_Rededge_S2_B5_min | 0.606238859 | 0.474157303 | 0.471750115 | 0.499788584 | 0.496903287 |
| CI_Rededge_S2_B5_mean | 1.057148316 | 1.33551377 | 1.136602378 | 1.125210264 | 1.122394666 |
| CI_Rededge_S2_B5_max | 1.851754706 | 1.836099585 | 1.897571278 | 1.923222749 | 1.78358209 |
| CI_Rededge_S2_B5_sd | 0.362102638 | 0.401274899 | 0.429984716 | 0.480669856 | 0.38829966 |
| CI_Rededge_S2_B6_min | 0.116842105 | 0.101289134 | 0.114054782 | 0.066084788 | 0.176779026 |
| CI_Rededge_S2_B6_mean | 0.250822098 | 0.248697784 | 0.245304715 | 0.256246738 | 0.303875165 |
| CI_Rededge_S2_B6_max | 0.387395737 | 0.383947939 | 0.383249882 | 0.364587876 | 0.441636582 |
| CI_Rededge_S2_B6_sd | 0.079051363 | 0.086776994 | 0.073289942 | 0.064640762 | 0.079858772 |
| CI_Rededge_S2_B7_min | 0.036463081 | 0.017439387 | 0.000403226 | −0.021179164 | 0.095703125 |
| CI_Rededge_S2_B7_mean | 0.114357166 | 0.102194378 | 0.10142903 | 0.114959213 | 0.159440585 |
| CI_Rededge_S2_B7_max | 0.187153053 | 0.178019223 | 0.207026349 | 0.199769939 | 0.273823192 |
| CI_Rededge_S2_B7_sd | 0.045649636 | 0.041427663 | 0.043656177 | 0.048495055 | 0.043006152 |
| NDRE_S2_B5_min | 0.201991465 | 0.19164396 | 0.190656718 | 0.199932341 | 0.199007823 |
| NDRE_S2_B5_mean | 0.337189035 | 0.352043532 | 0.350897292 | 0.345851125 | 0.349876205 |
| NDRE_S2_B5_max | 0.480757483 | 0.478637101 | 0.48885993 | 0.490215028 | 0.471400394 |
| NDRE_S2_B5_sd | 0.075516724 | 0.082129244 | 0.086963584 | 0.095702133 | 0.00010748 |
| NDRE_S2_B6_min | 0.05519642 | 0.04820333 | 0.053950722 | 0.031985516 | 0.081211287 |
| NDRE_S2_B6_mean | 0.110380035 | 0.109321914 | 0.108334233 | 0.112848009 | 0.130879963 |
| NDRE_S2_B6_max | 0.162267081 | 0.161055505 | 0.153707775 | 0.154186647 | 0.180877279 |
| NDRE_S2_B6_sd | 0.031041316 | 0.034106721 | 0.029044875 | 0.025111375 | 0.030311953 |
| NDRE_S2_B7_min | 0.017905103 | 0.008644318 | 0.000201572 | −0.010702922 | 0.045666355 |
| NDRE_S2_B7_mean | 0.053657485 | 0.048253335 | 0.047867182 | 0.053862518 | 0.07348117 |
| NDRE_S2_B7_max | 0.085569253 | 0.081734459 | 0.093803297 | 0.090814014 | 0.120424135 |
| NDRE_S2_B7_sd | 0.020492575 | 0.018853895 | 0.019859305 | 0.022192691 | 0.018304497 |
| Three_BSI_Tian_S2_min | −0.777507303 | −0.7771261 | −0.774469124 | −0.748275862 | −0.768972142 |
| Three_BSI_Tian_S2_mean | −0.696807874 | −0.704142247 | −0.70221834 | −0.67206021 | −0.692546212 |
| Three_BSI_Tian_S2_max | −0.573115851 | −0.575081226 | −0.577008929 | −0.049921255 | −0.670040023 |
| Three_BSI_Tian_S2_sd | 0.055082574 | 0.057626315 | 0.057501905 | 0.049921255 | 0.056447329 |
| mND_Verrelat_S2_max | 258.7142857 | 121.4285714 | 552.3333333 | 1403 | 90 |
| MCARI_S2_min | 77325.2 | 36556 | 60672 | 68686.8 | 60669 |
| MCARI_S2_mean | 161161.3375 | 159155.7125 | 160680.35 | 217056.2063 | 147968.0563 |
| MCARI_S2_max | 237718 | 305393.6 | 295678 | 394941.6 | 274344 |
| MCARI_S2_sd | 46860.50939 | 84485.28133 | 69775.73444 | 103384.5848 | 66197.89647 |
| IRECI_S2_min | 1413.9125 | 1386.267757 | 1437.691318 | 1606.20122 | 1166.662347 |
| IRECI_S2_mean | 2600.366788 | 2806.600814 | 2819.022178 | 2998.916927 | 2323.473045 |
| IRECI_S2_max | 4010.256303 | 4795.910345 | 4811.117296 | 4957.816114 | 3944.224299 |
| IRECI_S2_sd | 861.9203899 | 1210.396217 | 1244.968369 | 1292.498893 | 864.8538764 |
| NDMI_S2_min | −0.04866426 | −0.055804076 | −0.053117783 | −0.016896209 | −0.041836581 |
| NDMI_S2_mean | 0.037066052 | 0.051367774 | 0.050919963 | 0.08693389 | 0.035724106 |
| NDMI_S2_max | 0.103550296 | 0.118054006 | 0.114543115 | 0.198720877 | 0.109693252 |
| NDMI_S2_sd | 0.034973128 | 0.043936348 | 0.046472457 | 0.066142845 | 0.034757286 |
| S2REP_min | 712.0216049 | 713.891129 | 712.8521127 | 712.1296296 | 712.2585227 |
| S2REP_mean | 718.1787359 | 719.4609392 | 718.8287051 | 718.2368845 | 718.0607826 |
| S2REP_max | 722.5 | 725.5523256 | 723.2191781 | 721.7427885 | 722.862069 |
| S2REP_sd | 2.844674495 | 3.729494589 | 2.821142958 | 2.158744752 | 2.751397379 |
| SR_S2_min | 1.888268156 | 1.820199778 | 1.868317389 | 1.986740331 | 1.876941458 |
| SR_S2_mean | 3.452196028 | 3.774463247 | 3.822390994 | 3.992547223 | 3.702367762 |
| SR_S2_max | 5.65034965 | 6.227790433 | 6.366589327 | 7.113350126 | 6.043981481 |
| SR_S2_sd | 0.250354968 | 1.603764068 | 1.674547008 | 1.977904553 | 1.50825947 |
| GNDVI_S2_min | 0.343936382 | 0.334446764 | 0.336949718 | 0.351855527 | 0.333618299 |
| GNDVI_S2_mean | 0.552189436 | 0.567473272 | 0.686063723 | 0.559739718 | 0.558000471 |
| GNDVI_S2_max | 0.682749045 | 0.582229965 | 0.682038052 | 0.693553223 | 0.664552949 |
| GNDVI_S2_sd | 0.095852876 | 0.104511979 | 0.103932312 | 0.09843271 | 0.100702988 |
| NDVI_S2_min | 0.30754362 | 0.290830382 | 0.302727094 | 0.330373659 | 0.304817276 |
| NDVI_S2_mean | 0.516953664 | 0.533627389 | 0.535773089 | 0.537619621 | 0.532028678 |
| NDVI_S2_max | 0.699263933 | 0.723290252 | 0.728503937 | 0.753492704 | 0.716069668 |
| NDVI_S2_sd | 0.12634063 | 0.148072389 | 0.149401419 | 0.162739163 | 0.139558203 |
| MSI_S2_min | 0.81233244 | 0.788822355 | 0.794457275 | 0.668445122 | 0.802299867 |
| MSI_S2_mean | 0.930704234 | 0.90565302 | 0.906844201 | 0.8466494 | 0.933170817 |
| MSI_S2_max | 1.102307225 | 1.117755857 | 1.112196122 | 1.034373195 | 1.087325508 |
| MSI_S2_sd | 0.067017214 | 0.083339278 | 0.087646684 | 0.112269615 | 0.06634357 |
| EVI_S2_min | 0.689280278 | 0.656257524 | 0.679345729 | 0.607776519 | 0.711952972 |
| EVI_S2_mean | 1.29552207 | 1.376145802 | 1.389086554 | 1.358962858 | 1.406879394 |
| EVI_S2_max | 2.151187005 | 2.33378257 | 2.33155437 | 2.411753106 | 2.624040921 |
| EVI_S2_sd | 0.478965836 | 0.55427408 | 0.557920669 | 0.59002402 | 0.572866727 |
| sampling_date | 2021-03- | 2021-03- | 2022-02- | 2022-02- | 2022-02- |
| | 20T00:00:00Z | 20T00:00:00Z | 12T00:00:00Z | 12T00:00:00Z | 12T00:00:00Z |
| taxorder | Alfisols | Alfisols | Alfisols | Alfisols | Alfisols |
| taxsuborder | Xeralfs | Xeralfs | Xeralfs | Xeralfs | Xeralfs |
| taxgrtgroup | Palexeralfs | Palexeralfs | Palexeralfs | Palexeralfs | Palexeralfs |
| taxsubgrp | Mollic | Mollic | Mollic | Mollic | Mollic |
| | Palexeralfs | Palexeralfs | Palexeralfs | Palexeralfs | Palexeralfs |
| taxpartsize | fine | fine | fine | fine | fine |
| lcsnt_r | 3 | 3 | 3 | 3 | 3 |
| awc_r | 0.186046518 | 0.186046518 | 0.186046518 | 0.186046518 | 0.186046518 |
| wthirdbar_r | 32.77907083 | 32.77907083 | 32.77907083 | 32.77907083 | 32.77907083 |
| wfifteenbar_r | 19.71860415 | 19.71860415 | 19.71860415 | 19.71860415 | 19.71860415 |
| kwfact | 0.335116279 | 0.335116279 | 0.335116279 | 0.335116279 | 0.335116279 |
| kffact | 0.335116279 | 0.335116279 | 0.335116279 | 0.335116279 | 0.335116279 |
| claytotal_r | 30 | 30 | 30 | 30 | 30 |
| musym | ZaA | ZaA | ZaA | RnA | RnA |
| ph_mean_0_5 | 6.825320244 | 5.702754498 | 6.55454731 | 6.085464478 | 6.041648855 |
| clay_mean_0_5 | 30.61816406 | 28.04101563 | 17.84341431 | 20.12170029 | 18.84765525 |
| sand_mean_0_5 | 33.76099777 | 21.79101563 | 40.79089355 | 33.76836395 | 38.62121201 |
| silt_mean_0_5 | 34.049366 | 49.98537827 | 35.93652344 | 46.10312663 | 44.41789246 |
| hb_mean_0_5 | 5.246660527 | 3.075604422 | 2.075308256 | 3.444456937 | 3.075338293 |
| n_mean_0_5 | 1.258532047 | 1.283736467 | 1.355552021 | 1.321102142 | 1.334684134 |
| alpha_mean_0_5 | 0.189423507 | 0.327131576 | 0.473978649 | 0.301981591 | 0.319007 |
| ksat_mean_0_5 | 0.915640773 | 0.577488848 | 2.625437769 | 1.358792871 | 1.628046063 |
| theta_r_mean_0_5 | 0.125004873 | 0.079575762 | 0.05575073 | 0.06526953 | 0.062726915 |
| theta_s_mean_0_5 | 0.444021523 | 0.44546026 | 0.45504554 | 0.44041127 | 0.440598339 |
| ph_mean_5_15 | 6.824072351 | 6.769343145 | 6.626858711 | 6.1234622 | 6.06571579 |
| clay_mean_5_15 | 30.3465271 | 29.19463348 | 17.79268255 | 20.68449593 | 19.34082031 |
| sand_mean_5_15 | 33.70332335 | 21.69373703 | 40.84082031 | 33.727005 | 38.33105469 |
| silt_mean_5_15 | 34.05425252 | 48.85293961 | 36.04740906 | 45.42954636 | 44.07894897 |
| hb_mean_5_15 | 5.304206965 | 3.196967429 | 2.050592208 | 3.501662862 | 3.084433696 |
| n_mean_5_15 | 1.25922215 | 1.282382965 | 1.353484392 | 1.314134121 | 1.332590477 |
| alpha_mean_5_15 | 0.189912993 | 0.31727985 | 0.468627346 | 0.292249271 | 0.318764365 |
| ksat_mean_5_15 | 0.927740699 | 0.562644042 | 2.624737044 | 1.286311276 | 1.614845423 |
| theta_r_mean_5_15 | 0.12429297 | 0.078746825 | 0.05562963 | 0.065474711 | 0.064448975 |
| theta_s_mean_5_15 | 0.442747653 | 0.444574744 | 0.453072965 | 0.437219977 | 0.437517719 |
| ph_mean_15_30 | 7.021382332 | 6.878724098 | 6.794202805 | 6.176373005 | 6.102796555 |
| clay_mean_15_30 | 37.42074203 | 31.85288429 | 17.51750946 | 22.58815002 | 21.71616364 |
| sand_mean_15_30 | 29.25268936 | 21.33251762 | 39.55278778 | 32.99027252 | 36.48627472 |
| silt_mean_15_30 | 32.12854385 | 46.40820313 | 36.82226563 | 44.39247131 | 43.40244293 |
| hb_mean_15_30 | 4.822539119 | 3.187482559 | 2.167941059 | 3.587482913 | 3.379542765 |
| n_mean_15_30 | 1.242382765 | 1.272646308 | 1.361961365 | 1.316674709 | 1.326002836 |
| alpha_mean_15_30 | 0.20894845 | 0.321051975 | 0.469476626 | 0.278972241 | 0.299199573 |
| ksat_mean_15_30 | 0.537130041 | 0.480175669 | 2.543004733 | 0.99391625 | 1.141484023 |
| theta_r_mean_15_30 | 0.134078592 | 0.085191405 | 0.052718445 | 0.055902442 | 0.065158717 |
| theta_s_mean_15_30 | 0.464716391 | 0.44233945 | 0.448894173 | 0.428133726 | 0.430063009 |
| ph_mode_0_5 | 7.18200015 | 5.364000092 | 6.998000145 | 5.710000038 | 5.710000038 |
| clay_mode_0_5 | 31.5 | 31.5 | 22.5 | 11.5 | 11.5 |
| sand_mode_0_5 | 34.5 | 7.5 | 12.5 | 42.5 | 42.5 |
| silt_mode_0_5 | 32.5 | 48.5 | 53.5 | 45.5 | 45.5 |
| hb_mode_0_5 | 6.575032681 | 5.199477081 | 1.485925851 | 5.199477081 | 3.251496509 |
| n_mode_0_5 | 1.262500048 | 1.262500048 | 1.287499905 | 1.262500048 | 1.262500048 |
| alpha_mode_0_5 | 0.165958702 | 0.218775179 | 0.660693437 | 0.19952821 | 0.288403176 |
| ksat_mode_0_5 | 0.94055556 | 0.266397019 | 0.686152666 | 2.836336254 | 2.838336254 |
| theta_r_mode_0_5 | 0.093999997 | 0.054000001 | 0.041999999 | 0.050000001 | 0.050000001 |
| theta_s_mode_0_5 | 0.437735856 | 0.445283026 | 0.498113215 | 0.437735856 | 0.437735856 |
| ph_mode_5_15 | 7.18200016 | 5.262000084 | 7.18200016 | 5.710000038 | 5.710000038 |
| clay_mode_5_15 | 31.5 | 31.5 | 22.5 | 11.5 | 11.5 |
| sand_mode_5_15 | 34.5 | 7.5 | 24.5 | 42.5 | 42.5 |
| silt_mode_5_15 | 32.5 | 46.5 | 61.5 | 46.5 | 46.5 |
| hb_mode_5_15 | 6.575032681 | 5.199477081 | 1.486925851 | 4.808175508 | 4.808175508 |
| n_mode_5_15 | 1.262500048 | 1.237499952 | 1.287499905 | 1.287499905 | 1.287499905 |
| alpha_mode_5_15 | 0.151356127 | 0.19952621 | 0.660693437 | 0.19952621 | 0.19952621 |
| ksat_mode_5_15 | 0.94055556 | 0.227534596 | 0.586055563 | 2.836336254 | 2.836336254 |
| theta_r_mode_5_15 | 0.093999997 | 0.07 | 0.041999999 | 0.050000001 | 0.050000001 |
| theta_s_mode_5_15 | 0.437735856 | 0.437735856 | 0.490566045 | 0.437735856 | 0.422641546 |
| ph_mode_15_30 | 7.366000175 | 6.630000114 | 7.642000198 | 5.618000031 | 5.618000031 |
| clay_mode_15_30 | 39.5 | 32.5 | 21.5 | 12.5 | 12.5 |
| sand_mode_15_30 | 29.5 | 6.5 | 25.5 | 43.5 | 43.5 |
| silt_mode_15_30 | 30.5 | 42.5 | 60.5 | 45.5 | 45.5 |
| hb_mode_15_30 | 5.080208889 | 5.199477081 | 1.607935775 | 4.808175508 | 4.808175508 |
| n_mode_15_30 | 1.237499952 | 1.237499952 | 1.287499905 | 1.287499905 | 1.287499905 |
| alpha_mode_15_30 | 0.165958702 | 0.181970082 | 0.602559588 | 0.19952621 | 0.19952621 |
| ksat_mode_15_30 | 0.586055563 | 0.165990684 | 0.500560874 | 0.165990684 | 2.42256715 |
| theta_r_mode_15_30 | 0.106000006 | 0.07 | 0.041999999 | 0.050000001 | 0.050000001 |
| theta_s_mode_15_30 | 0.480377366 | 0.445283026 | 0.475471735 | 0.445283026 | 0.445283026 |
| ph_p50_0_5 | 6.81400013 | 6.446000099 | 6.538000107 | 5.986000061 | 5.802000046 |
| clay_p50_0_5 | 30.5 | 30.5 | 18.5 | 16.5 | 15.5 |
| sand_p50_0_5 | 34.5 | 20.5 | 30.5 | 40.5 | 41.5 |
| silt_p50_0_5 | 32.5 | 45.5 | 36.5 | 45.5 | 44.5 |
| hb_p50_0_5 | 5.199477081 | 3.251496509 | 1.880301532 | 3.516112061 | 3.006795599 |
| n_p50_0_5 | 1.237499952 | 1.262500048 | 1.3125 | 1.287499905 | 1.3125 |
| alpha_p50_0_5 | 0.181970082 | 0.288403176 | 0.50118722 | 0.263026773 | 0.288403176 |
| ksat_p50_0_5 | 0.803345892 | 0.585055563 | 2.06915932 | 2.06915932 | 2.06915932 |
| theta_r_p50_0_5 | 0.118000001 | 0.077999994 | 0.050000001 | 0.061999999 | 0.067999998 |
| theta_s_p50_0_5 | 0.437735856 | 0.437735856 | 0.460377365 | 0.437735856 | 0.437735856 |
| ph_p50_5_15 | 6.181400013 | 6.446000099 | 6.538000107 | 5.986000061 | 5.802000046 |
| clay_p50_5_15 | 30.5 | 30.5 | 18.5 | 16.5 | 15.5 |
| sand_p50_5_15 | 34.5 | 19.5 | 27.5 | 39.5 | 40.5 |
| silt_p50_5_15 | 32.5 | 45.5 | 37.5 | 45.5 | 44.5 |
| hb_p50_5_15 | 5.199477081 | 3.251496500 | 1.880301532 | 3.802262741 | 3.251496509 |
| n_p50_5_15 | 1.237499952 | 1.262500048 | 1.3125 | 1.287499905 | 1.3125 |
| alpha_p50_5_15 | 0.181970082 | 0.288403176 | 0.50118722 | 0.263026773 | 0.288403175 |
| ksat_p50_5_15 | 0.803345892 | 0.586055563 | 1.767307169 | 2.06916932 | 2.06915932 |
| theta_r_p50_5_15 | 0.118000001 | 0.077999994 | 0.050000001 | 0.061999999 | 0.057999998 |
| theta_s_p50_5_15 | 0.437735856 | 0.437735856 | 0.467924555 | 0.430188715 | 0.430188715 |
| ph_p50_15_30 | 8.998000145 | 8.630000114 | 8.630000114 | 6.170000076 | 5.710000038 |
| clay_p50_15_30 | 38.5 | 31.5 | 18.5 | 19.5 | 19.5 |
| sand_p50_15_30 | 18.5 | 19.5 | 25.5 | 37.5 | 39.5 |
| silt_p50_15_30 | 30.5 | 42.5 | 41.5 | 42.5 | 44.5 |
| hb_p50_15_30 | 4.808175508 | 3.251495509 | 1.880301532 | 3.802262741 | 3.516112061 |
| n_p50_15_30 | 1.212500095 | 1.262500048 | 1.3125 | 1.287499905 | 1.287499905 |
| alpha_p50_15_30 | 0.19952521 | 0.288403176 | 0.50118722 | 0.239883289 | 0.263026773 |
| ksat_p50_15_30 | 0.500560874 | 0.585055563 | 2.06915932 | 1.289282995 | 1.289282995 |
| theta_r_p50_15_30 | 0.129999995 | 0.082000002 | 0.046472457 | 0.066 | 0.061999999 |
| theta_s_p50_15_30 | 0.460377365 | 0.437735856 | 0.457924565 | 0.430188715 | 0.430188715 |
| ph_p5_0_5 | 5.894000053 | 1.845999956 | 5.710000038 | 5.342000008 | 5.342000008 |
| clay_p5_0_5 | 21.5 | 14.5 | 2.5 | 8.5 | 9.5 |
| sand_p5_0_5 | 14.5 | 5.50E+00 | 5.50E+00 | 6.5 | 7.5 |
| silt_p5_0_5 | 0.5 | 34.5 | 6.5 | 0.5 | 15.5 |
| hb_p5_0_5 | 2.671254732 | 0.795159229 | 0.735317163 | 1.087355863 | 1.005523679 |
| n_p5_0_5 | 1.162499905 | 1.162499905 | 1.212500095 | 1.1875 | 1.212500095 |
| alpha_p5_0_5 | 0.066069335 | 0.096499263 | 0.138038422 | 0.095499263 | 0.10471285 |
| ksat_p5_0_5 | 0.586055563 | 3.90E−05 | 3.90E−05 | 0.194341485 | 0.194341485 |
| theta_r_p5_0_5 | 0.01 | 0.002 | 0.002 | 0.002 | 0.002 |
| theta_s_p5_0_5 | 0.060377389 | 0.430188715 | 0.384905696 | 0.422641546 | 0.415094376 |
| ph_p5_5_15 | 5.986000061 | 6.170000075 | 5.802000046 | 5.434000015 | 5.434000015 |
| clay_p5_5_15 | 21.5 | 15.5 | 2.5 | 10.5 | 10.5 |
| sand_p5_5_15 | 14.5 | 6.50E+00 | 5.50E+00 | 7.5 | 7.5 |
| silt_p5_5_15 | 0.5 | 34.5 | 8.5 | 0.5 | 16.5 |
| hb_p5_5_15 | 2.571254732 | 0.869871401 | 0.795159229 | 1.087355863 | 0.929850015 |
| n_p5_5_15 | 1.162499905 | 1.1875 | 1.212500095 | 1.1875 | 1.212500095 |
| alpha_p5_5_15 | 0.066069335 | 0.095499263 | 0.138038422 | 0.095499263 | 0.10471285 |
| ksat_p5_5_15 | 0.586055553 | 3.90E−05 | 3.90E−05 | 0.194341485 | 0.194341485 |
| theta_r_p5_5_15 | 0.01 | 0.002 | 0.002 | 0.002 | 0.002 |
| theta_s_p5_5_15 | 0.060377389 | 0.430188715 | 0.384905698 | 0.415094376 | 0.415094376 |
| ph_p5_15_30 | 6.354000092 | 6.262000084 | 5.802000046 | 5.342000008 | 5.342000008 |
| clay_p5_15_30 | 21.5 | 19.5 | 1.5 | 10.5 | 10.5 |
| sand_p5_15_30 | 15.5 | 5.00E−01 | 5.50E+00 | 6.50E+00 | 6.50E+00 |
| silt_p5_15_30 | 0.5 | 33.5 | 5.5 | 0.5 | 18.5 |
| hb_p5_15_30 | 2.571254732 | 0.859871401 | 0.795159229 | 1.087355863 | 1.087355863 |
| n_p5_15_30 | 1.137500048 | 1.62499905 | 1.212500095 | 1.1875 | 1.1875 |
| alpha_p5_15_30 | 0.10471285 | 0.095499263 | 0.138038422 | 0.095499263 | 0.095499263 |
| ksat_p5_15_30 | 0.311897019 | 3.90E−05 | 3.90E−05 | 3.90E−05 | 3.90E−05 |
| theta_r_p5_15_30 | 0.002 | 0.006 | 0.002 | 0.006 | 0.006 |
| theta_s_p5_15_30 | 0.445283026 | 0.060377389 | 0.377358526 | 0.384905696 | 0.384905696 |
| ph_p95_0_5 | 7.274000168 | 7.642000198 | 6.998000145 | 6.998000145 | 6.998000145 |
| clay_p95_0_5 | 33.5 | 31.5 | 29.5 | 31.5 | 31.5 |
| sand_p95_0_5 | 37.5 | 39.5 | 76.5 | 43.5 | 67.5 |
| silt_p95_0_5 | 37.5 | 64.5 | 61.5 | 61.5 | 48.5 |
| hb_p95_0_5 | 14.37778402 | 9.722878889 | 6.080208889 | 9.722878889 | 8.314499354 |
| n_p95_0_5 | 1.337500095 | 1.412499905 | 1.537499905 | 1.452500095 | 1.487499952 |
| alpha_p95_0_5 | 0.346736868 | 1.148153618 | 1.258925395 | 0.954992587 | 0.954992587 |
| ksat_p95_0_5 | 1.767307169 | 2.636335254 | 25.79314315 | 3.320776433 | 3.320776433 |
| theta_r_p95_0_5 | 0.205 | 0.129999995 | 0.114 | 0.118000001 | 0.114 |
| theta_s_p95_0_5 | 0.475471735 | 0.460377365 | 0.498113215 | 0.460377365 | 0.460377365 |
| ph_p95_5_15 | 7.16200015 | 7.734000205 | 7.18200016 | 6.998000145 | 6.998000145 |
| clay_p95_5_15 | 32.5 | 34.5 | 29.5 | 34.5 | 32.5 |
| sand_p95_5_15 | 34.5 | 38.5 | 77.5 | 43.5 | 65.5 |
| silt_p95_5_15 | 37.5 | 61.5 | 51.5 | 46.5 | 46.5 |
| hb_p95_5_15 | 14.37778402 | 9.722878889 | 6.080208889 | 8.991155729 | 8.314499354 |
| n_p95_5_15 | 1.337500095 | 1.412499905 | 1.537499905 | 1.4375 | 1.487499952 |
| alpha_p95_5_15 | 0.346736868 | 1.148153618 | 1.148153518 | 0.954992587 | 0.95499587 |
| ksat_p95_5_15 | 1.767307169 | 2.836336254 | 25.79314316 | 2.835336254 | 3.320776433 |
| theta_r_p95_5_15 | 0.206 | 0.129999995 | 0.109999999 | 0.118000001 | 0.118000001 |
| theta_s_p95_5_15 | 0.475471735 | 0.460377355 | 0.490566045 | 0.460377366 | 0.467924565 |
| ph_p95_15_30 | 7.366000175 | 7.918000221 | 7.642000198 | 6.998000145 | 6.998000145 |
| clay_p95_15_30 | 40.5 | 39.5 | 28.5 | 39.5 | 38.5 |
| sand_p95_15_30 | 29.5 | 36.5 | 86.5 | 44.5 | 56.5 |
| silt_p95_15_30 | 38.5 | 61.5 | 60.5 | 52.5 | 52.5 |
| hb_p95_15_30 | 8.314499354 | 9.722878889 | 6.080208889 | 9.722878889 | 9.722878889 |
| n_p95_15_30 | 1.362499952 | 1.387500048 | 1.5625 | 1.462500095 | 1.487499952 |
| alpha_p95_15_30 | 0.380189382 | 1.148153618 | 1.148153618 | 0.870963593 | 0.954992587 |
| ksat_p95_15_30 | 1.101200404 | 2.42256715 | 25.79314316 | 2.836336254 | 2.836336254 |
| theta_r_p95_15_30 | 0.233999997 | 0.134000003 | 0.101999998 | 0.114 | 0.114 |
| theta_s_p95_15_30 | 0.475471735 | 0.450377365 | 0.483018875 | 0.460377365 | 0.460377365 |
| wrb | Lixisols | Lixisols | Lixisols | Lixisols | Lixisols |
| cec_0_5 cm_Q0.05 | 96 | 96 | 96 | 96 | 96 |
| cec_5_15 cm_Q0.05 | 100 | 100 | 100 | 100 | 100 |
| cec_15_30 cm_Q0.05 | 93 | 93 | 93 | 93 | 93 |
| cec_30_60 cm_Q0.05 | 93 | 93 | 93 | 93 | 93 |
| cec_60_100 cm_Q0.05 | 101 | 101 | 101 | 101 | 101 |
| cec_100_200 cm_Q0.05 | 115 | 115 | 115 | 115 | 115 |
| clay_0_5 cm_Q0.05 | 26 | 26 | 26 | 26 | 26 |
| clay_5_15 cm_Q0.05 | 32 | 32 | 32 | 32 | 32 |
| clay_15_30 cm_Q0.05 | 51 | 51 | 51 | 51 | 51 |
| clay_30_60 cm_Q0.05 | 39 | 39 | 39 | 39 | 39 |
| clay_60_100 cm_Q0.05 | 35 | 35 | 35 | 35 | 35 |
| clay_100_200 cm_Q0.05 | 29 | 29 | 29 | 29 | 29 |
| phh2o_0_5 cm_Q0.05 | 51 | 51 | 51 | 51 | 51 |
| phh2o_5_15 cm_Q0.05 | 51 | 51 | 51 | 51 | 51 |
| phh2o_15_30 cm_Q0.05 | 51 | 51 | 51 | 51 | 51 |
| phh2o_30_60 cm_Q0.05 | 51 | 51 | 51 | 51 | 51 |
| phh2o_60_100 cm_Q0.05 | 50 | 50 | 50 | 50 | 50 |
| phh2o_100_200 cm_Q0.05 | 50 | 50 | 50 | 50 | 50 |
| sand_0_5 cm_Q0.05 | 20 | 20 | 20 | 20 | 20 |
| sand_5_15 cm_Q0.05 | 20 | 20 | 20 | 20 | 20 |
| sand_15_30 cm_Q0.05 | 20 | 20 | 20 | 20 | 20 |
| sand_30_60 cm_Q0.05 | 16 | 16 | 16 | 16 | 16 |
| sand_60_100 cm_Q0.05 | 15 | 15 | 15 | 15 | 15 |
| sand_100_200 cm_Q0.05 | 16 | 16 | 16 | 16 | 16 |
| silt_0_5 cm_Q0.05 | 41 | 41 | 41 | 41 | 41 |
| silt_5_15 cm_Q0.05 | 42 | 42 | 42 | 42 | 42 |
| silt_15_30 cm_Q0.05 | 33 | 33 | 33 | 33 | 33 |
| silt_30_60 cm_Q0.05 | 39 | 39 | 39 | 39 | 39 |
| silt_60_100 cm_Q0.05 | 27 | 27 | 27 | 27 | 27 |
| silt_100_200 cm_Q0.05 | 19 | 19 | 19 | 19 | 19 |
| cec_0_5 cm_Q0.5 | 195 | 195 | 195 | 195 | 195 |
| cec_5_15 cm_Q0.5 | 190 | 190 | 190 | 190 | 190 |
| cec_15_30 cm_Q0.5 | 183 | 183 | 183 | 183 | 183 |
| cec_30_60 cm_Q0.5 | 195 | 195 | 195 | 195 | 195 |
| cec_60_100 cm_Q0.5 | 234 | 234 | 234 | 234 | 234 |
| cec_100_200 cm_Q0.5 | 230 | 230 | 230 | 230 | 230 |
| cfvo_0_5 cm_Q0.5 | 10 | 10 | 10 | 10 | 10 |
| cfvo_5_15 cm_Q0.5 | 30 | 30 | 30 | 30 | 30 |
| cfvo_15_30 cm_Q0.5 | 10 | 10 | 10 | 10 | 10 |
| cfvo_30_60 cm_Q0.5 | 10 | 10 | 10 | 10 | 10 |
| cfvo_60_100 cm_Q0.5 | 10 | 10 | 10 | 10 | 10 |
| cfvo_100_200 cm_Q0.5 | 10 | 10 | 10 | 10 | 10 |
| clay_0_5 cm_Q0.5 | 222 | 222 | 222 | 222 | 222 |
| clay_5_15 cm_Q0.5 | 228 | 228 | 228 | 228 | 228 |
| clay_15_30 cm_Q0.5 | 295 | 295 | 295 | 295 | 295 |
| clay_30_60 cm_Q0.5 | 302 | 302 | 302 | 302 | 302 |
| clay_60_100 cm_Q0.5 | 310 | 310 | 310 | 310 | 310 |
| clay_100_200 cm_Q0.5 | 306 | 306 | 306 | 306 | 306 |
| phh2o_0_5 cm_Q0.5 | 60 | 60 | 60 | 60 | 60 |
| phh2o_5_15 cm_Q0.5 | 60 | 60 | 60 | 60 | 60 |
| phh2o_15_30 cm_Q0.5 | 60 | 60 | 60 | 60 | 60 |
| phh2o_30_60 cm_Q0.5 | 60 | 60 | 60 | 60 | 60 |
| phh2o_60_100 cm_Q0.5 | 60 | 60 | 60 | 60 | 60 |
| phh2o_100_200 cm_Q0.5 | 63 | 63 | 63 | 63 | 63 |
| sand_0_5 cm_Q0.5 | 242 | 242 | 242 | 242 | 242 |
| sand_5_15 cm_Q0.5 | 242 | 242 | 242 | 242 | 242 |
| sand_15_30 cm_Q0.5 | 223 | 223 | 223 | 223 | 223 |
| sand_30_60 cm_Q0.5 | 217 | 217 | 217 | 217 | 217 |
| sand_60_100 cm_Q0.5 | 220 | 220 | 220 | 220 | 220 |
| sand_100_200 cm_Q0.5 | 217 | 217 | 217 | 217 | 217 |
| silt_0_5 cm_Q0.5 | 399 | 399 | 399 | 399 | 399 |
| silt_5_15 cm_Q0.5 | 402 | 402 | 402 | 402 | 402 |
| silt_15_30 cm_Q0.5 | 372 | 372 | 372 | 372 | 372 |
| silt_30_60 cm_Q0.5 | 370 | 370 | 370 | 370 | 370 |
| silt_60_100 cm_Q0.5 | 325 | 325 | 325 | 325 | 325 |
| silt_100_200 cm_Q0.5 | 317 | 317 | 317 | 317 | 317 |
| cec_0_5 cm_mean | 219 | 219 | 219 | 219 | 219 |
| cec_5_15 cm_mean | 192 | 192 | 192 | 192 | 192 |
| cec_15_30 cm_mean | 187 | 187 | 187 | 187 | 187 |
| cec_30_60 cm_mean | 201 | 201 | 201 | 201 | 201 |
| cec_60_100 cm_mean | 239 | 239 | 239 | 239 | 239 |
| cec_100_200 cm_mean | 234 | 234 | 234 | 234 | 234 |
| cfvo_0_5 cm_mean | 61 | 61 | 61 | 61 | 61 |
| cfvo_5_15 cm_mean | 75 | 75 | 75 | 75 | 75 |
| cfvo_15_30 cm_mean | 58 | 58 | 58 | 58 | 58 |
| cfvo_30_60 cm_mean | 60 | 60 | 60 | 60 | 60 |
| cfvo_60_100 cm_mean | 55 | 55 | 55 | 55 | 55 |
| cfvo_100_200 cm_mean | 60 | 60 | 60 | 60 | 60 |
| clay_0_5 cm_mean | 333 | 333 | 333 | 333 | 333 |
| clay_5_15 cm_mean | 330 | 330 | 330 | 330 | 330 |
| clay_15_30 cm_mean | 386 | 386 | 386 | 386 | 386 |
| clay_30_60 cm_mean | 388 | 388 | 388 | 388 | 388 |
| clay_60_100 cm_mean | 394 | 394 | 394 | 394 | 394 |
| clay_100_200 cm_mean | 383 | 383 | 383 | 383 | 383 |
| phh2o_0_5 cm_mean | 62 | 62 | 62 | 62 | 62 |
| phh2o_5_15 cm_mean | 61 | 61 | 61 | 61 | 61 |
| phh2o_15_30 cm_mean | 61 | 61 | 61 | 61 | 61 |
| phh2o_30_60 cm_mean | 61 | 61 | 61 | 61 | 61 |
| phh2o_60_100 cm_mean | 62 | 62 | 62 | 62 | 62 |
| phh2o_100_200 cm_mean | 63 | 63 | 63 | 63 | 63 |
| sand_0_5 cm_mean | 246 | 246 | 246 | 246 | 246 |
| sand_5_15 cm_mean | 247 | 247 | 247 | 247 | 247 |
| sand_15_30 cm_mean | 233 | 233 | 233 | 233 | 233 |
| sand_30_60 cm_mean | 234 | 234 | 234 | 234 | 234 |
| sand_60_100 cm_mean | 243 | 243 | 243 | 243 | 243 |
| sand_100_200 cm_mean | 257 | 257 | 257 | 257 | 257 |
| silt_0_5 cm_mean | 421 | 421 | 421 | 421 | 421 |
| silt_5_15 cm_mean | 423 | 423 | 423 | 423 | 423 |
| silt_15_30 cm_mean | 381 | 381 | 381 | 381 | 381 |
| silt_30_60 cm_mean | 378 | 378 | 378 | 378 | 378 |
| silt_60_100 cm_mean | 364 | 364 | 364 | 364 | 364 |
| silt_100_200 cm_mean | 360 | 360 | 360 | 360 | 360 |
| cec_0_5 cm_Q0.95 | 378 | 378 | 378 | 378 | 378 |
| cec_5_15 cm_Q0.95 | 323 | 323 | 323 | 323 | 323 |
| cec_15_30 cm_Q0.95 | 330 | 330 | 330 | 330 | 330 |
| cec_30_60 cm_Q0.95 | 333 | 333 | 333 | 333 | 333 |
| cec_60_100 cm_Q0.95 | 377 | 377 | 377 | 377 | 377 |
| cec_100_200 cm_Q0.95 | 377 | 377 | 377 | 377 | 377 |
| cfvo_0_5 cm_Q0.95 | 240 | 240 | 240 | 240 | 240 |
| cfvo_5_15 cm_Q0.95 | 291 | 291 | 291 | 291 | 291 |
| cfvo_15_30 cm_Q0.95 | 272 | 272 | 272 | 272 | 272 |
| cfvo_30_60 cm_Q0.95 | 312 | 312 | 312 | 312 | 312 |
| cfvo_60_100 cm_Q0.95 | 234 | 234 | 234 | 234 | 234 |
| cfvo_100_200 cm_Q0.95 | 358 | 358 | 358 | 358 | 358 |
| clay_0_5 cm_Q0.95 | 935 | 935 | 935 | 935 | 935 |
| clay_5_15 cm_Q0.95 | 917 | 917 | 917 | 917 | 917 |
| clay_15_30 cm_Q0.95 | 939 | 939 | 939 | 939 | 939 |
| clay_30_60 cm_Q0.95 | 939 | 939 | 939 | 939 | 939 |
| clay_60_100 cm_Q0.95 | 940 | 940 | 940 | 940 | 940 |
| clay_100_200 cm_Q0.95 | 959 | 959 | 959 | 959 | 959 |
| phh2o_0_5 cm_Q0.95 | 75 | 75 | 75 | 75 | 75 |
| phh2o_5_15 cm_Q0.95 | 75 | 75 | 75 | 75 | 75 |
| phh2o_15_30 cm_Q0.95 | 75 | 75 | 75 | 75 | 75 |
| phh2o_30_60 cm_Q0.95 | 77 | 77 | 77 | 77 | 77 |
| phh2o_60_100 cm_Q0.95 | 79 | 79 | 79 | 79 | 79 |
| phh2o_100_200 cm_Q0.95 | 80 | 80 | 80 | 80 | 80 |
| sand_0_5 cm_Q0.95 | 545 | 545 | 545 | 545 | 545 |
| sand_5_15 cm_Q0.95 | 551 | 551 | 551 | 551 | 551 |
| sand_15_30 cm_Q0.95 | 549 | 549 | 549 | 549 | 549 |
| sand_30_60 cm_Q0.95 | 550 | 550 | 550 | 550 | 550 |
| sand_60_100 cm_Q0.95 | 572 | 572 | 572 | 572 | 572 |
| sand_100_200 cm_Q0.95 | 608 | 608 | 608 | 608 | 608 |
| silt_0_5 cm_Q0.95 | 898 | 898 | 898 | 898 | 898 |
| silt_5_15 cm_Q0.95 | 892 | 892 | 892 | 892 | 892 |
| silt_15_30 cm_Q0.95 | 871 | 871 | 871 | 871 | 871 |
| silt_30_60 cm_Q0.95 | 886 | 886 | 886 | 886 | 886 |
| silt_60_100 cm_Q0.95 | 871 | 871 | 871 | 871 | 871 |
| silt_100_200 cm_Q0.95 | 884 | 884 | 884 | 884 | 884 |
| | Parcel V4 | | | | |
| | Sample Location | | | | |
| | V4-P-2 | V4-P-10 | V4-P-5 | V4-P-7 | V4-P-4 |
| LCI_max | 0.634557788 | 0.551017374 | 0.525584118 | 0.491651093 | 0.563030012 |
| LCI_sd | 0.173045306 | 0.158036973 | 0.128085251 | 0.109302059 | 0.112738076 |
| EVI_min | 0.075545421 | 0.055322408 | 0.074289835 | 0.067785363 | 0.050029924 |
| EVI_mean | 0.319518089 | 0.238987423 | 0.335786666 | 0.168519919 | 0.246823639 |
| EVI_max | 0.714437521 | 0.584214733 | 0.641753749 | 0.501755983 | 0.514998371 |
| EVI_sd | 0.193583024 | 0.155443401 | 0.134625897 | 0.10098445 | 0.114019032 |
| NIRv_min | 0.08444199 | 0.095278546 | 0.065097526 | 0.078875817 | 0.050712764 |
| NIRv_mean | 0.211793533 | 0.194651665 | 0.221897934 | 0.175615454 | 0.175114542 |
| NIRv_max | 0.449568123 | 0.361375928 | 0.378113359 | 0.514488173 | 0.312473327 |
| NIRv_sd | 0.091183441 | 0.062014803 | 0.060828597 | 0.038533625 | 0.05306091 |
| GLI_min | −0.019670436 | −0.050347676 | −0.023624289 | −0.047226636 | −0.033135772 |
| GLI_mean | 0.171185624 | 0.097525666 | 0.169545200 | 0.036023775 | 0.099468536 |
| GLI_max | 0.438069746 | 0.357771255 | 0.432628262 | 0.30358203 | 0.324431248 |
| GLI_sd | 0.145660167 | 0.130338934 | 0.115081174 | 0.077061655 | 0.094597551 |
| CVI_min | 2.407390977 | 2.523473974 | 2.511619416 | 2.565787369 | 2.403864699 |
| CVI_mean | 3.480831976 | 3.166495639 | 3.697953172 | 3.384802811 | 3.626291457 |
| CVI_max | 5.229198166 | 4.431450855 | 5.485914347 | 6.179979512 | 5.071275116 |
| CVI_sd | 0.710215355 | 0.426959432 | 0.576088531 | 0.545306223 | 0.498729401 |
| CI_Rededge_min | 0.177617428 | 0.138069593 | 0.293501513 | 0.163561557 | 0.268518894 |
| CI_Rededge_mean | 0.956050176 | 0.659489338 | 0.961467189 | 0.459020524 | 0.795520343 |
| CI_Rededge_max | 2.058848336 | 1.563100218 | 1.961764331 | 1.222684537 | 1.609234431 |
| CI_Rededge_sd | 0.523377434 | 0.412885108 | 0.38304724 | 0.260820334 | 0.31244898 |
| NDRE_min | 0.081565028 | 0.054576754 | 0.127970925 | 0.075598296 | 0.118406355 |
| NDRE_mean | 0.301301225 | 0.230412901 | 0.312845355 | 0.178407393 | 0.275608012 |
| NDRE_max | 0.507249388 | 0.438691062 | 0.495174414 | 0.379399406 | 0.445865865 |
| NDRE_sd | 0.125075398 | 0.113738666 | 0.092213788 | 0.078224175 | 0.080670399 |
| system | Vineyard | Vineyard | Vineyard | Vineyard | Vineyard |
| crop | Wine grapes | Wine grapes | Wine grapes | Wine grapes | Wine grapes |
| age | 2 | 2 | 2 | 2 | 2 |
| prcp_mean | 7.929999985 | 7.929999985 | 7.929999985 | 7.929999985 | 7.929999985 |
| prcp_max | 105.8899994 | 105.8899994 | 105.8899994 | 105.8899994 | 105.8899994 |
| prcp_sd | 9.085575635 | 9.085575635 | 9.085575635 | 9.085575635 | 9.085575635 |
| srad_min | 77.40000153 | 77.40000153 | 77.40000153 | 77.40000153 | 77.40000153 |
| srad_mean | 267.9093065 | 267.9093065 | 267.9093065 | 267.9093065 | 267.9093065 |
| srad_max | 442.019989 | 442.019989 | 442.019989 | 442.019989 | 442.019989 |
| srad_sd | 85.9787663 | 85.9787663 | 85.9787663 | 85.9787663 | 85.9787663 |
| tmax_min | 8.300000191 | 8.300000191 | 8.300000191 | 8.300000191 | 8.300000191 |
| tmax_mean | 19.88942193 | 19.88942193 | 19.88942193 | 19.88942193 | 19.88942193 |
| tmax_max | 38.5 | 38.5 | 38.5 | 38.5 | 38.5 |
| tmax_sd | 6.68582569 | 6.68582569 | 6.68582569 | 6.68582569 | 6.68582569 |
| tmin_min | −2.109999895 | −2.109999895 | −2.109999895 | −2.109999895 | −2.109999895 |
| tmin_mean | 7.15433525 | 7.15433525 | 7.15433525 | 7.15433525 | 7.15433525 |
| tmin_max | 20.09000015 | 20.09000015 | 20.09000015 | 20.09000015 | 20.09000015 |
| tmin_sd | 4.423895763 | 4.423895763 | 4.423895763 | 4.423895763 | 4.423895763 |
| vp_min | 306.2200012 | 306.2200012 | 306.2200012 | 306.2200012 | 306.2200012 |
| vp_mean | 820.4393046 | 820.4393046 | 820.4393046 | 820.4393046 | 820.4393046 |
| vp_max | 1445.920044 | 1445.920044 | 1445.920044 | 1445.920044 | 1445.920044 |
| vp_sd | 238.8830191 | 238.8830191 | 238.8830191 | 238.8830191 | 238.8830191 |
| sunlight_hr_mean | 10.55606162 | 10.55606162 | 10.55606162 | 10.55606162 | 10.55606162 |
| sunlight_hr_sum | 1835.754722 | 1835.754722 | 1835.754722 | 1835.754722 | 1835.754722 |
| sampling_date.y | 2022-03-02 | 2022-03-02 | 2022-03-02 | 2022-03-02 | 2022-03-02 |
| SCI_S2_min | −0.286644951 | −0.265433513 | −0.295116323 | −0.270616663 | −0.19535547 |
| SCI_S2_mean | −0.008214213 | −0.005852271 | −0.030949549 | −0.039393524 | −0.027515988 |
| SCI_S2_max | 0.235901509 | 0.24187356 | 0.220246238 | 0.207137315 | 0.180485339 |
| SCI_S2_sd | 0.19016092 | 0.1784377 | 0.177823329 | 0.157882553 | 0.121341241 |
| CI_S2_min | 0.214555256 | 0.220871327 | 0.223454834 | 0.190998902 | 0.216981132 |
| CI_S2_mean | 0.430608349 | 0.440188669 | 0.440885848 | 0.435452852 | 0.432282685 |
| CI_S2_max | 0.632478632 | 0.696935795 | 0.667889908 | 0.622425529 | 0.515566038 |
| CI_S2_sd | 0.139941394 | 0.136932434 | 0.146031512 | 0.135704006 | 0.14346231 |
| NDWI_S2_min | −0.758415842 | −0.74789915 | −0.730451367 | −0.755753877 | −0.745323741 |
| NDWI_S2_mean | −0.53749341 | −0.636065508 | −0.542129613 | −0.546076639 | −0.545017417 |
| NDWI_S2_max | −0.292191436 | −0.294068505 | −0.30551844 | −0.297841123 | −0.300083822 |
| NDWI_S2_sd | 0.162148331 | 0.169774155 | 0.150353808 | 0.159248407 | 0.154302257 |
| VARI_S2_min | −0.290640541 | −0.290512175 | −0.325280414 | −0.264454976 | −0.168918919 |
| VARI_S2_mean | −0.121260219 | −0.108398296 | −0.102440029 | −0.104866986 | −0.085419764 |
| VARI_S2_max | −0.014258555 | −0.014925373 | −0.029325513 | −0.008415147 | 0 |
| VARI_S2_sd | 0.060520614 | 0.067010357 | 0.062346234 | 0.058710512 | 0.041594432 |
| kNDVI_S2_min | 0.056975134 | 0.060436992 | 0.063678693 | 0.054681631 | 0.066418375 |
| kNDVI_S2_mean | 0.243103347 | 0.245809432 | 0.252853902 | 0.258079158 | 0.265088141 |
| kNDVI_S2_max | 0.481219216 | 0.47965895 | 0.457972244 | 0.503675858 | 0.471678313 |
| kNDVI_S2_sd | 0.152579935 | 0.155053695 | 0.142036195 | 0.153474283 | 0.143929021 |
| SAVI_S2_min | 0.35819994 | 0.368948725 | 0.378738525 | 0.350901664 | 0.366622098 |
| SAVI_S2_mean | 0.713235179 | 0.717333173 | 0.73397608 | 0.739099276 | 0.753706457 |
| SAVI_S2_max | 1.085232001 | 1.079150897 | 1.054903801 | 1.116506436 | 1.073360438 |
| SAVI_S2_sd | 0.250529163 | 0.263115106 | 0.241957666 | 0.259196835 | 0.244154805 |
| ENDVI_S2_min | 0.235270962 | 0.237859267 | 0.246057187 | 0.249116376 | 0.25413929 |
| ENDVI_S2_mean | 0.52851363 | 0.536826187 | 0.545454636 | 0.54418281 | 0.551691952 |
| ENDVI_S2_max | 0.778249015 | 0.777843778 | 0.787496331 | 0.797421731 | 0.781574539 |
| ENDVI_S2_sd | 0.192443602 | 0.19251828 | 0.186675981 | 0.191929235 | 0.187949853 |
| LCI_S2_B5_min | 0.171497585 | 0.178399035 | 0.18124383 | 0.181546433 | 0.177971375 |
| LCI_S2_B5_mean | 0.357640653 | 0.366672623 | 0.363213132 | 0.36093291 | 0.360797402 |
| LCI_S2_B5_max | 0.543848776 | 0.533899138 | 0.523162446 | 0.548891786 | 0.530763791 |
| LCI_S2_B5_sd | 0.13760679 | 0.133087855 | 0.122845646 | 0.130646894 | 0.124757047 |
| LCI_S2_B6_min | 0.070249597 | 0.077722278 | 0.07798618 | 0.05981717 | 0.050689376 |
| LCI_S2_B6_mean | 0.151940901 | 0.147343924 | 0.151002842 | 0.133643196 | 0.126244803 |
| LCI_S2_B6_max | 0.22038835 | 0.215931534 | 0.211201502 | 0.235332464 | 0.230551627 |
| LCI_S2_B6_sd | 0.046920371 | 0.04427192 | 0.040269077 | 0.057244301 | 0.066951105 |
| LCI_S2_B7_min | 0.020128824 | 0.037659445 | 0.034550839 | −0.020296643 | −0.062597201 |
| LCI_S2_B7_mean | 0.055362643 | 0.062189997 | 0.068324593 | 0.046509774 | 0.037156758 |
| LCI_S2_B7_max | 0.109634551 | 0.104344964 | 0.103328051 | 0.128699701 | 0.128666689 |
| LCI_S2_B7_sd | 0.025117829 | 0.020519165 | 0.019376803 | 0.036344945 | 0.050469625 |
| NIRv_S2_min | 1324 | 1436 | 1386 | 1408 | 1405 |
| NIRv_S2_mean | 2430.9 | 2463.8 | 2511.55 | 2487.05 | 2436.8 |
| NIRv_S2_max | 3176 | 3262 | 3309 | 3330 | 3504 |
| NIRv_S2_sd | 725.5072101 | 664.3532351 | 718.9040984 | 683.1260641 | 639.2972787 |
| GLI_S2_min | −0.038961039 | −0.046815042 | −0.069354839 | −0.025076991 | 0.001691007 |
| GLI_S2_mean | 0.037302392 | 0.049077714 | 0.053274432 | 0.050269028 | 0.062957514 |
| GLI_S2_max | 0.110047847 | 0.137534247 | 0.116049383 | 0.128425578 | 0.143174251 |
| GLI_S2_sd | 0.042719626 | 0.051251812 | 0.04972515 | 0.046496192 | 0.039946562 |
| CVI_S2_min | 2.046516635 | 2.032720143 | 2.099585077 | 2.116794459 | 2.035447668 |
| CVI_S2_mean | 4.629295426 | 4.471459626 | 4.447454042 | 4.613407898 | 4.426290478 |
| CVI_S2_max | 8.471916152 | 8.531851352 | 7.517241379 | 8.752913143 | 7.782342239 |
| CVI_S2_sd | 2.08662161 | 1.962831215 | 1.781147828 | 2.058582532 | 1.917639276 |
| CI_Rededge_S2_B5_min | 0.382749326 | 0.401175938 | 0.407275954 | 0.416933638 | 0.393217232 |
| CI_Rededge_S2_B5_mean | 1.007844967 | 0.981740551 | 0.999388554 | 0.988453315 | 0.97158566 |
| CI_Rededge_S2_B5_max | 1.796315251 | 1.68902439 | 1.631490787 | 1.697580845 | 1.622702703 |
| CI_Rededge_S2_B5_sd | 0.517096669 | 0.470351855 | 0.438289626 | 0.465711921 | 0.436626283 |
| CI_Rededge_S2_B6_min | 0.127885572 | 0.141505002 | 0.142239827 | 0.105799649 | 0.076464208 |
| CI_Rededge_S2_B6_mean | 0.256295213 | 0.246293671 | 0.251913208 | 0.216026607 | 0.202520921 |
| CI_Rededge_S2_B6_max | 0.347711731 | 0.335378323 | 0.329750855 | 0.369498465 | 0.372334609 |
| CI_Rededge_S2_B6_sd | 0.067296395 | 0.063431252 | 0.055850405 | 0.086346662 | 0.107427024 |
| CI_Rededge_S2_B7_min | 0.033579584 | 0.05967575 | 0.058391725 | −0.026666667 | −0.075023299 |
| CI_Rededge_S2_B7_mean | 0.098614666 | 0.09180069 | 0.1007852 | 0.065890388 | 0.052648371 |
| CI_Rededge_S2_B7_max | 0.15502451 | 0.142671855 | 0.142732049 | 0.177278974 | 0.179723502 |
| CI_Rededge_S2_B7_sd | 0.035633826 | 0.028402681 | 0.025488142 | 0.048238761 | 0.067456104 |
| NDRE_S2_B5_min | 0.160633484 | 0.167074779 | 0.169185404 | 0.172505207 | 0.164304854 |
| NDRE_S2_B5_mean | 0.316647973 | 0.313233744 | 0.319469966 | 0.315338951 | 0.312999097 |
| NDRE_S2_B5_max | 0.473173362 | 0.45785124 | 0.449261993 | 0.45910578 | 0.447925992 |
| NDRE_S2_B5_sd | 0.113644116 | 0.107593116 | 0.099532877 | 0.104783348 | 0.100598211 |
| NDRE_S2_B6_min | 0.050099879 | 0.066077799 | 0.066397714 | 0.05024203 | 0.036824236 |
| NDRE_S2_B6_mean | 0.112833802 | 0.108957118 | 0.111339294 | 0.096195917 | 0.089935635 |
| NDRE_S2_B6_max | 0.148106655 | 0.143607706 | 0.141539107 | 0.155939525 | 0.156948606 |
| NDRE_S2_B6_sd | 0.026738914 | 0.025627096 | 0.022372403 | 0.034803187 | 0.043480332 |
| NDRE_S2_B7_min | 0.01651255 | 0.028973371 | 0.028368545 | −0.013513514 | −0.038973614 |
| NDRE_S2_B7_mean | 0.046729264 | 0.04371964 | 0.047841939 | 0.031397642 | 0.024655171 |
| NDRE_S2_B7_max | 0.071936309 | 0.066585956 | 0.066612178 | 0.08142226 | 0.082452431 |
| NDRE_S2_B7_sd | 0.016189005 | 0.012894675 | 0.011546308 | 0.02240774 | 0.031854362 |
| Three_BSI_Tian_S2_min | −0.813223566 | −0.809378408 | −0.805751492 | −0.803200692 | −0.801833261 |
| Three_BSI_Tian_S2_mean | −0.707795049 | −0.707147112 | −0.693023119 | −0.705585737 | −0.713095954 |
| Three_BSI_Tian_S2_max | −0.568392371 | −0.584051135 | −0.552060231 | −0.585709042 | −0.580305927 |
| Three_BSI_Tian_S2_sd | 0.081944198 | 0.078220992 | 0.080203987 | 0.077792424 | 0.079407031 |
| mND_Verrelat_S2_max | 9.339181287 | 6.883333333 | 9.169491525 | 5.649819495 | 6.382606696 |
| MCARI_S2_min | 30451.2 | 30655.2 | 30764.8 | 42343 | 53125.8 |
| MCARI_S2_mean | 116630.15 | 132315.12 | 138853.82 | 143475.97 | 149519.35 |
| MCARI_S2_max | 278066.8 | 337524 | 330865.2 | 305584.8 | 282973.6 |
| MCARI_S2_sd | 90486.61313 | 104640.5866 | 99550.98054 | 98964.64486 | 69309.32823 |
| IRECI_S2_min | 794.109589 | 910.1322816 | 998.8095839 | 1065.668858 | 1164.540748 |
| IRECI_S2_mean | 2250.377705 | 2270.222002 | 2301.725514 | 2427.684823 | 2410.33725 |
| IRECI_S2_max | 5045.468777 | 4805.746073 | 4671.961093 | 4610.928277 | 4146.920175 |
| IRECI_S2_sd | 1503.006562 | 1400.03622 | 1323.297038 | 1254.720644 | 947.1223035 |
| NDMI_S2_min | −0.235901509 | −0.24187356 | −0.220246238 | −0.207137316 | −0.180485339 |
| NDMI_S2_mean | 0.008214213 | 0.005852271 | 0.030949549 | 0.039393524 | 0.027516988 |
| NDMI_S2_max | 0.286644951 | 0.255433513 | 0.286116323 | 0.270615563 | 0.19535547 |
| NDMI_S2_sd | 0.19016092 | 0.1784377 | 0.177823329 | 0.157882553 | 0.121341241 |
| S2REP_min | 712.2474747 | 709.9875 | 714.3201754 | 711.6268382 | 712.0845921 |
| S2REP_mean | 719.2690839 | 718.8489845 | 718.6293745 | 718.8039754 | 718.3447813 |
| S2REP_max | 722.9038462 | 721.9038929 | 721.2389912 | 721.3354317 | 720.895967 |
| S2REP_sd | 2.431737045 | 2.683367325 | 1.746762111 | 2.227869518 | 2.072721337 |
| SR_S2_min | 1.627513228 | 1.65248227 | 1.675647121 | 1.61082205 | 1.695081967 |
| SR_S2_mean | 3.292044316 | 3.330829745 | 3.32606391 | 3.453801284 | 3.459220865 |
| SR_S2_max | 6.253521127 | 6.131455399 | 5.742616034 | 6.826530512 | 6.034825871 |
| SR_S2_sd | 1.573402864 | 1.606039889 | 1.404833231 | 1.644154371 | 1.450994315 |
| GNDVI_S2_min | 0.292191436 | 0.294068505 | 0.30561844 | 0.297841123 | 0.300083822 |
| GNDVI_S2_mean | 0.53749341 | 0.535065608 | 0.642129613 | 0.546075539 | 0.545017417 |
| GNDVI_S2_max | 0.758415842 | 0.74789916 | 0.730451367 | 0.765753877 | 0.745323741 |
| GNDVI_S2_sd | 0.162148331 | 0.159774165 | 0.150363808 | 0.159248407 | 0.154302257 |
| NDVI_S2_min | 0.238824003 | 0.245989305 | 0.252517275 | 0.233957752 | 0.257907543 |
| NDVI_S2_mean | 0.475571699 | 0.478302222 | 0.489399638 | 0.492815886 | 0.50255778 |
| NDVI_S2_max | 0.724271845 | 0.719552337 | 0.703379224 | 0.744458931 | 0.715700141 |
| NDVI_S2_sd | 0.173713656 | 0.175439916 | 0.161333143 | 0.172827836 | 0.162801775 |
| MSI_S2_min | 0.55443038 | 0.593075205 | 0.555089292 | 0.574040219 | 0.673142468 |
| MSI_S2_mean | 1.049031921 | 1.046875167 | 0.993609908 | 0.965935534 | 0.972771761 |
| MSI_S2_max | 1.617463617 | 1.638082377 | 1.564912281 | 1.522504892 | 1.440468846 |
| MSI_S2_sd | 0.357237271 | 0.350167931 | 0.330006767 | 0.291425256 | 0.23637186 |
| EVI_S2_min | 0.52668391 | 0.548924787 | 0.533872599 | 0.696377307 | 0.71318361 |
| EVI_S2_mean | 1.053500418 | 1.043615368 | 1.070005015 | 1.086405508 | 1.119725298 |
| EVI_S2_max | 1.51277545 | 1.501252784 | 1.504510755 | 1.590972415 | 1.555952742 |
| EVI_S2_sd | 0.299978463 | 0.299562502 | 0.264417963 | 0.29105597 | 0.250241911 |
| sampling_date | 2022-03- | 2022-03- | 2022-03- | 2022-03- | 2022-03- |
| | 02T00:00:00Z | 02T00:00:00Z | 02T00:00:00Z | 02T00:00:00Z | 02T00:00:00Z |
| taxorder | Alfisols | Alfisols | Alfisols | Alfisols | Alfisols |
| taxsuborder | Xeralfs | Xeralfs | Xeralfs | Xeralfs | Xeralfs |
| taxgrtgroup | Dunxeralfs | Dunxeralfs | Dunxeralfs | Dunxeralfs | Dunxeralfs |
| taxsubgrp | Abruptic | Abruptic | Abruptic | Abruptic | Abruptic |
| | Dunxeralfs | Dunxeralfs | Dunxeralfs | Dunxeralfs | Dunxeralfs |
| taxpartsize | fine | fine | fine | fine | fine |
| lcsnt_r | 9 | 9 | 9 | 9 | 9 |
| awc_r | 0.119999997 | 0.119999997 | 0.119999997 | 0.119999997 | 0.119999997 |
| wthirdbar_r | 19.558139 | 19.558139 | 19.558139 | 19.558139 | 19.558139 |
| wfifteenbar_r | 8.646511865 | 8.646511865 | 8.646511865 | 8.646511865 | 8.646511865 |
| kwfact | 0.227906977 | 0.227906977 | 0.227906977 | 0.227906977 | 0.227906977 |
| kffact | 0.471860465 | 0.471860465 | 0.471860465 | 0.471860465 | 0.471860465 |
| claytotal_r | 16.09302326 | 16.09302326 | 16.09302326 | 16.09302326 | 16.09302326 |
| musym | 221 | 221 | 221 | 221 | 221 |
| ph_mean_0_5 | 6.83998251 | 5.579891205 | 5.659377575 | 5.429769039 | 5.76255846 |
| clay_mean_0_5 | 12.26953125 | 11.15527344 | 12.87243366 | 13.33446884 | 11.39355469 |
| sand_mean_0_5 | 44.21722031 | 55.81769562 | 42.36190033 | 40.43164063 | 55.8542099 |
| silt_mean_0_5 | 39.84570313 | 59.13147736 | 39.826828 | 40.98194885 | 57.6541481 |
| hb_mean_0_5 | 1.435451871 | 1.487495829 | 1.407700782 | 1.358189533 | 1.527814411 |
| n_mean_0_5 | 1.444977999 | 1.392428729 | 1.434880018 | 1.433837891 | 1.390307665 |
| alpha_mean_0_5 | 0.70622863 | 0.669529922 | 0.711239036 | 0.746932326 | 0.651631315 |
| ksat_mean_0_5 | 1.572783163 | 5.262482819 | 1.466581585 | 1.316189737 | 3.373450362 |
| theta_r_mean_0_5 | 0.041882701 | 0.043558594 | 0.044835295 | 0.046074368 | 0.043986343 |
| theta_s_mean_0_5 | 0.435584813 | 0.525374234 | 0.45305109 | 0.462408155 | 0.521392822 |
| ph_mean_5_15 | 5.897957325 | 5.705063343 | 5.72110796 | 5.540057182 | 5.32605505 |
| clay_mean_5_15 | 12.35575006 | 11.04003906 | 12.8891103 | 13.10878086 | 11.28849888 |
| sand_mean_5_15 | 43.7819519 | 55.29587936 | 42.17580795 | 40.23170471 | 55.37155577 |
| silt_mean_5_15 | 40.01026917 | 58.69024277 | 40.0450058 | 41.28396606 | 56.34408569 |
| hb_mean_5_15 | 1.465882402 | 1.393925777 | 1.523085129 | 1.501167291 | 1.465208588 |
| n_mean_5_15 | 1.446419954 | 1.397939086 | 1.436815143 | 1.432529449 | 1.395085335 |
| alpha_mean_5_15 | 0.680436362 | 0.715877477 | 0.655739753 | 0.654214036 | 0.688052913 |
| ksat_mean_5_15 | 1.389473918 | 6.324563701 | 1.238686192 | 1.063372226 | 3.28174714 |
| theta_r_mean_5_15 | 0.039874509 | 0.043348379 | 0.045458294 | 0.045737259 | 0.043760933 |
| theta_s_mean_5_15 | 0.421829998 | 0.523228765 | 0.426632315 | 0.435714424 | 0.517851949 |
| ph_mean_15_30 | 6.058990479 | 6.405271053 | 5.92124939 | 5.776344299 | 6.481218815 |
| clay_mean_15_30 | 15.32859993 | 11.23607083 | 14.16144753 | 16.73874664 | 11.51759529 |
| sand_mean_15_30 | 42.00584412 | 57.02889252 | 40.59970856 | 37.74511719 | 58.98532104 |
| silt_mean_15_30 | 40.7834816 | 58.28005981 | 40.88492889 | 41.80234909 | 58.48728943 |
| hb_mean_15_30 | 1.458040501 | 1.409487417 | 1.612130641 | 1.766970415 | 1.492742662 |
| n_mean_15_30 | 1.435465693 | 1.402470589 | 1.428140283 | 1.405852914 | 1.399059175 |
| alpha_mean_15_30 | 0.690866197 | 0.725672643 | 0.61243009 | 0.663729089 | 0.679459775 |
| ksat_mean_15_30 | 1.082853403 | 5.032488174 | 0.948985442 | 0.736757088 | 3.05766889 |
| theta_r_mean_15_30 | 0.051843446 | 0.041976541 | 0.050163585 | 0.053387914 | 0.043542966 |
| theta_s_mean_15_30 | 0.401783228 | 0.509007335 | 0.391315609 | 0.399044573 | 0.5041098 |
| ph_mode_0_5 | 6.262000084 | 5.434000015 | 6.262000084 | 6.262000084 | 6.434000015 |
| clay_mode_0_5 | 13.5 | 8.5 | 13.5 | 13.5 | 8.5 |
| sand_mode_0_5 | 63.5 | 67.5 | 39.5 | 39.5 | 57.5 |
| silt_mode_0_5 | 38.5 | 59.5 | 41.5 | 41.5 | 59.5 |
| hb_mode_0_5 | 1.738793864 | 1.375022789 | 1.738793854 | 1.375022789 | 2.198802904 |
| n_mode_0_5 | 1.387500048 | 1.337500095 | 1.412499905 | 1.362499952 | 1.337500095 |
| alpha_mode_0_5 | 0.549540886 | 0.457088185 | 0.549540886 | 0.724435959 | 0.457088186 |
| ksat_mode_0_5 | 2.06915932 | 8.553245405 | 2.06915932 | 2.06915932 | 8.553245406 |
| theta_r_mode_0_5 | 0.057999998 | 0.002 | 0.002 | 0.002 | 0.002 |
| theta_s_mode_0_5 | 0.437735856 | 0.520754695 | 0.581132054 | 0.581132054 | 0.520754695 |
| ph_mode_5_15 | 6.262000084 | 5.710000038 | 6.262000084 | 6.262000084 | 5.710000038 |
| clay_mode_5_15 | 14.5 | 7.5 | 14.5 | 14.5 | 7.5 |
| sand_mode_5_15 | 38.5 | 65.5 | 38.5 | 38.5 | 65.6 |
| silt_mode_5_15 | 38.5 | 59.5 | 41.5 | 41.5 | 59.5 |
| hb_mode_5_15 | 2.198802904 | 1.175847774 | 2.198802904 | 1.880301532 | 1.175847774 |
| n_mode_5_15 | 1.362499952 | 1.337500095 | 1.362499952 | 1.362499952 | 1.337500095 |
| alpha_mode_5_15 | 0.457088186 | 0.724435959 | 0.457088186 | 0.50118722 | 0.724435960 |
| ksat_mode_5_15 | 2.836336254 | 8.553245406 | 0.803345892 | 0.803345892 | 8.553245406 |
| theta_r_mode_5_15 | 0.057999998 | 0.002 | 0.057999998 | 0.046 | 0.002 |
| theta_s_mode_5_15 | 0.437735856 | 0.558490634 | 0.483018875 | 0.483018875 | 0.558490634 |
| ph_mode_15_30 | 6.252000084 | 6.722000122 | 5.618000031 | 5.618000031 | 6.722000122 |
| clay_mode_15_30 | 12.5 | 7.5 | 12.5 | 12.5 | 7.5 |
| sand_mode_15_30 | 38.5 | 66.5 | 38.5 | 38.5 | 68.6 |
| silt_mode_15_30 | 40.5 | 59.5 | 49.5 | 49.5 | 59.5 |
| hb_mode_15_30 | 1.375022789 | 1.271541393 | 2.198802904 | 2.198802904 | 1.486925851 |
| n_mode_15_30 | 1.362499952 | 1.362499952 | 1.362499952 | 1.362499952 | 1.362499952 |
| alpha_mode_15_30 | 0.724435959 | 0.794328246 | 0.457088186 | 0.457088186 | 0.794328246 |
| ksat_mode_15_30 | 0.266397019 | 8.553245406 | 0.266397019 | 0.266397019 | 8.553245406 |
| theta_r_mode_15_30 | 0.025000001 | 0.002 | 0.026000001 | 0.026000001 | 0.002 |
| theta_s_mode_15_30 | 0.430188715 | 0.520754695 | 0.316981187 | 0.316981187 | 0.620754595 |
| ph_p50_0_5 | 5.802000046 | 5.434000015 | 5.526000023 | 5.434000015 | 5.434000015 |
| clay_p50_0_5 | 12.5 | 8.5 | 12.5 | 12.5 | 9.5 |
| sand_p50_0_5 | 41.5 | 62.5 | 39.5 | 39.5 | 62.5 |
| silt_p50_0_5 | 40.5 | 59.5 | 40.5 | 41.5 | 69.5 |
| hb_p50_0_5 | 1.486925851 | 1.486925851 | 1.486925851 | 1.375022789 | 1.486925851 |
| n_p50_0_5 | 1.412499905 | 1.362499962 | 1.412499905 | 1.412499905 | 1.362499962 |
| alpha_p50_0_5 | 0.660693437 | 0.660693437 | 0.660693437 | 0.660693437 | 0.602559588 |
| ksat_p50_0_5 | 2.06915932 | 7.305485284 | 2.06915932 | 2.06915932 | 7.305485284 |
| theta_r_p50_0_5 | 0.037999999 | 0.041999999 | 0.037999999 | 0.041999999 | 0.041999999 |
| theta_s_p50_0_5 | 0.437735856 | 0.528301954 | 0.445283026 | 0.452830195 | 0.520754695 |
| ph_p50_5_15 | 5.894000053 | 5.618000031 | 5.618000031 | 5.434000015 | 5.618000031 |
| clay_p50_5_15 | 12.5 | 8.5 | 12.5 | 13.5 | 9.5 |
| sand_p50_5_15 | 39.5 | 62.5 | 38.5 | 38.5 | 61.5 |
| silt_p50_5_15 | 40.5 | 59.5 | 40.5 | 41.5 | 59.5 |
| hb_p50_5_15 | 1.486925851 | 1.375022789 | 1.607935775 | 1.607935775 | 1.375022789 |
| n_p50_5_15 | 1.412499905 | 1.362499952 | 1.412499905 | 1.412499905 | 1.362499952 |
| alpha_p50_5_15 | 0.602559588 | 0.660593437 | 0.549540886 | 0.549540886 | 0.660593437 |
| ksat_p50_5_15 | 2.06915932 | 7.305485284 | 1.757307169 | 1.757307169 | 7.305485284 |
| theta_r_p50_5_15 | 0.034000002 | 0.041999999 | 0.037999999 | 0.037999999 | 0.041999999 |
| theta_s_p50_5_15 | 0.437735856 | 0.528301954 | 0.445283026 | 0.452830195 | 0.620754595 |
| ph_p50_15_30 | 5.986000061 | 6.262000084 | 5.618000031 | 5.618000031 | 6.262000084 |
| clay_p50_15_30 | 12.5 | 8.5 | 12.5 | 13.5 | 9.5 |
| sand_p50_15_30 | 38.5 | 63.5 | 38.5 | 37.5 | 63.5 |
| silt_p50_15_30 | 40.5 | 58.5 | 39.5 | 40.5 | 58.5 |
| hb_p50_15_30 | 1.375022789 | 1.375022789 | 1.607935775 | 1.738793864 | 1.486925851 |
| n_p50_15_30 | 1.412499905 | 1.387500048 | 1.387500048 | 1.387500048 | 1.362499952 |
| alpha_p50_15_30 | 0.660693437 | 0.660693437 | 0.549540886 | 0.50118722 | 0.660693437 |
| ksat_p50_15_30 | 1.509489675 | 7.305485284 | 1.509489685 | 0.94055555 | 7.305485284 |
| theta_r_p50_15_30 | 0.046 | 0.037999999 | 0.041999999 | 0.045737259 | 0.041999999 |
| theta_s_p50_15_30 | 0.377358526 | 0.513207555 | 0.377358526 | 0.377358526 | 0.506660415 |
| ph_p5_0_5 | 4.421999931 | 5.065999985 | 1.845999966 | 1.845999966 | 5.065999985 |
| clay_p5_0_5 | 6.5 | 5.5 | 7.5 | 0.5 | 5.5 |
| sand_p5_0_5 | 30.5 | 21.5 | 3.05E+01 | 3.05E+00 | 21.5 |
| silt_p5_0_5 | 15.5 | 47.5 | 16.5 | 25.5 | 0.5 |
| hb_p5_0_5 | 0.497253327 | 0.581482301 | 0.459831069 | 0.459831069 | 0.628804898 |
| n_p5_0_5 | 1.262500048 | 1.237499952 | 1.262500048 | 1.262500048 | 1.237499952 |
| alpha_p5_0_5 | 0.288403176 | 0.288403176 | 0.288403176 | 0.288403176 | 0.263026773 |
| ksat_p5_0_5 | 0.103427957 | 0.227534596 | 3.90E−05 | 3.90E−05 | 0.194341485 |
| theta_r_p5_0_5 | 0.002 | 0.002 | 0.002 | 0.002 | 0.002 |
| theta_s_p5_0_5 | 0.294339657 | 0.437735856 | 0.060377389 | 0.060377389 | 0.430188715 |
| ph_p5_5_15 | 4.697999954 | 5.25 | 1.845999955 | 1.845999955 | 5.342000008 |
| clay_p5_5_15 | 6.5 | 5.5 | 8.5 | 8.5 | 5.5 |
| sand_p5_5_15 | 30.5 | 21.5 | 3.05E+01 | 3.05E+01 | 21.5 |
| silt_p5_5_15 | 15.5 | 44.5 | 15.5 | 26.5 | 0.5 |
| hb_p5_5_15 | 0.497253327 | 0.581482301 | 0.497253327 | 0.497253327 | 0.581482301 |
| n_p5_5_15 | 1.287499905 | 1.262500048 | 1.287499905 | 1.287499905 | 1.262500048 |
| alpha_p5_5_15 | 0.288403176 | 0.288403176 | 0.263026773 | 0.263026773 | 0.288403176 |
| ksat_p5_5_15 | 0.103427957 | 0.194341485 | 3.90E−05 | 3.90E−05 | 0.194341485 |
| theta_r_p5_5_15 | 0.002 | 0.002 | 0.002 | 0.002 | 0.002 |
| theta_s_p5_5_15 | 0.294339657 | 0.437735856 | 0.060377389 | 0.060377389 | 0.422641546 |
| ph_p5_15_30 | 5.342000008 | 5.710000038 | 5.25 | 5.157999992 | 5.710000038 |
| clay_p5_15_30 | 8.5 | 5.5 | 8.5 | 8.537721187 | 5.5 |
| sand_p5_15_30 | 21.5 | 27.5 | 3.05E+01 | 1.85E+01 | 30.5 |
| silt_p5_15_30 | 14.5 | 44.5 | 14.5 | 31.5 | 0.5 |
| hb_p5_15_30 | 0.497253327 | 0.581482301 | 0.497253327 | 0.537721107 | 0.628804898 |
| n_p5_15_30 | 1.262500048 | 1.252500048 | 1.262500048 | 1.1875 | 1.262500048 |
| alpha_p5_15_30 | 0.263025773 | 0.288403176 | 0.218776179 | 0.181970082 | 0.263026773 |
| ksat_p5_15_30 | 0.141775697 | 0.155990684 | 3.90E−05 | 3.90E−05 | 0.141775697 |
| theta_r_p5_15_30 | 0.006 | 0.002 | 0.006 | 0.006 | 0.002 |
| theta_s_p5_15_30 | 0.060377389 | 0.445283056 | 0.060377389 | 0.060377389 | 0.430188715 |
| ph_p95_0_5 | 6.446000099 | 6.81400013 | 6.446000099 | 6.262000084 | 6.906000137 |
| clay_p95_0_5 | 15.5 | 20.5 | 17.5 | 18.5 | 20.5 |
| sand_p95_0_5 | 63.5 | 69.5 | 53.5 | 53.5 | 69.5 |
| silt_p95_0_5 | 54.5 | 60.5 | 54.5 | 47.5 | 60.5 |
| hb_p95_0_5 | 3.251496509 | 3.251496509 | 3.251496509 | 3.251496509 | 3.251496509 |
| n_p95_0_5 | 1.637500048 | 1.537499905 | 1.812499952 | 1.812499952 | 1.537499905 |
| alpha_p95_0_5 | 1.819700019 | 1.513561273 | 1.99526237 | 1.99526237 | 1.513561273 |
| ksat_p95_0_5 | 10.01411872 | 25.79314316 | 8.553245406 | 3.320776433 | 25.79314316 |
| theta_r_p95_0_5 | 0.101999998 | 0.093999997 | 0.101999998 | 0.101999998 | 0.093999997 |
| theta_s_p95_0_5 | 0.581132054 | 0.596226454 | 0.581132054 | 0.581132054 | 0.596226454 |
| ph_p95_5_15 | 6.262000084 | 6.446000099 | 6.262000084 | 6.262000084 | 6.538000107 |
| clay_p95_5_15 | 15.5 | 20.5 | 15.5 | 15.5 | 20.5 |
| sand_p95_5_15 | 63.5 | 69.5 | 63.5 | 52.5 | 59.5 |
| silt_p95_5_15 | 54.5 | 60.5 | 54.5 | 47.5 | 50.5 |
| hb_p95_5_15 | 3.251496509 | 3.251496509 | 3.516112051 | 3.251496509 | 3.251496509 |
| n_p95_5_15 | 1.637500048 | 1.537499905 | 1.637500048 | 1.612499952 | 1.637499905 |
| alpha_p95_5_15 | 1.819700819 | 1.659586903 | 1.819700813 | 1.819700819 | 1.659586903 |
| ksat_p95_5_15 | 8.553245406 | 26.79314316 | 8.553245405 | 3.320776433 | 22.03039817 |
| theta_r_p95_5_15 | 0.085999995 | 0.093999997 | 0.101999998 | 0.101999998 | 0.093999997 |
| theta_s_p95_5_15 | 0.613207555 | 0.603773594 | 0.520754695 | 0.528301954 | 0.596226464 |
| ph_p95_15_30 | 6.906000137 | 6.998000145 | 6.906000137 | 6.262000084 | 7.090000153 |
| clay_p95_15_30 | 26.5 | 21.5 | 22.5 | 27.5 | 21.5 |
| sand_p95_15_30 | 69.5 | 59.5 | 50.5 | 49.5 | 70.5 |
| silt_p95_15_30 | 54.5 | 59.5 | 54.5 | 49.5 | 59.5 |
| hb_p95_15_30 | 3.802262741 | 3.251495509 | 3.802252741 | 4.446321848 | 3.510112001 |
| n_p95_15_30 | 1.662499905 | 1.5525 | 1.512499952 | 1.587500095 | 1.537499905 |
| alpha_p95_15_30 | 1.819700819 | 1.659585903 | 1.819700819 | 1.819700819 | 1.513561273 |
| ksat_p95_15_30 | 5.329485508 | 10.01411872 | 6.233749402 | 3.320776433 | 10.01411872 |
| theta_r_p95_15_30 | 0.106000005 | 0.093999997 | 0.106000006 | 0.106000006 | 0.098000005 |
| theta_s_p95_15_30 | 0.467924555 | 0.558490634 | 0.460377365 | 0.475471735 | 0.558490634 |
| wrb | Lixisols | Lixisols | Lixisols | Lixisols | Lixisols |
| cec_0_5 cm_Q0.05 | 77 | 76 | 76 | 76 | 76 |
| cec_5_15 cm_Q0.05 | 61 | 63 | 63 | 63 | 63 |
| cec_15_30 cm_Q0.05 | 61 | 61 | 61 | 61 | 61 |
| cec_30_60 cm_Q0.05 | 61 | 61 | 61 | 61 | 61 |
| cec_60_100 cm_Q0.05 | 61 | 52 | 52 | 52 | 52 |
| cec_100_200 cm_Q0.05 | 61 | 56 | 56 | 56 | 56 |
| clay_0_5 cm_Q0.05 | 53 | 57 | 57 | 57 | 57 |
| clay_5_15 cm_Q0.05 | 52 | 57 | 57 | 57 | 57 |
| clay_15_30 cm_Q0.05 | 58 | 57 | 57 | 57 | 57 |
| clay_30_60 cm_Q0.05 | 58 | 63 | 63 | 63 | 63 |
| clay_60_100 cm_Q0.05 | 29 | 44 | 44 | 44 | 44 |
| clay_100_200 cm_Q0.05 | 30 | 34 | 34 | 34 | 34 |
| phh2o_0_5 cm_Q0.05 | 45 | 45 | 45 | 45 | 45 |
| phh2o_5_15 cm_Q0.05 | 45 | 45 | 45 | 45 | 45 |
| phh2o_15_30 cm_Q0.05 | 50 | 51 | 51 | 51 | 51 |
| phh2o_30_60 cm_Q0.05 | 50 | 52 | 52 | 52 | 52 |
| phh2o_60_100 cm_Q0.05 | 53 | 53 | 53 | 53 | 53 |
| phh2o_100_200 cm_Q0.05 | 54 | 54 | 54 | 54 | 54 |
| sand_0_5 cm_Q0.05 | 180 | 223 | 223 | 223 | 223 |
| sand_5_15 cm_Q0.05 | 225 | 232 | 232 | 232 | 232 |
| sand_15_30 cm_Q0.05 | 195 | 216 | 216 | 216 | 216 |
| sand_30_60 cm_Q0.05 | 202 | 214 | 214 | 214 | 214 |
| sand_60_100 cm_Q0.05 | 214 | 232 | 232 | 232 | 232 |
| sand_100_200 cm_Q0.05 | 238 | 253 | 253 | 253 | 253 |
| silt_0_5 cm_Q0.05 | 121 | 138 | 138 | 138 | 138 |
| silt_5_15 cm_Q0.05 | 148 | 152 | 152 | 152 | 152 |
| silt_15_30 cm_Q0.05 | 120 | 128 | 128 | 128 | 128 |
| silt_30_60 cm_Q0.05 | 111 | 111 | 111 | 111 | 111 |
| silt_60_100 cm_Q0.05 | 105 | 102 | 102 | 102 | 102 |
| silt_100_200 cm_Q0.05 | 95 | 83 | 83 | 83 | 83 |
| cec_0_5 cm_Q0.5 | 180 | 183 | 183 | 183 | 183 |
| cec_5_15 cm_Q0.5 | 152 | 156 | 156 | 156 | 156 |
| cec_15_30 cm_Q0.5 | 156 | 150 | 150 | 150 | 150 |
| cec_30_60 cm_Q0.5 | 203 | 175 | 175 | 175 | 175 |
| cec_60_100 cm_Q0.5 | 222 | 193 | 193 | 193 | 193 |
| cec_100_200 cm_Q0.5 | 222 | 193 | 193 | 193 | 193 |
| cfvo_0_5 cm_Q0.5 | 20 | 20 | 20 | 20 | 20 |
| cfvo_5_15 cm_Q0.5 | 20 | 20 | 20 | 20 | 20 |
| cfvo_15_30 cm_Q0.5 | 10 | 20 | 20 | 20 | 20 |
| cfvo_30_60 cm_Q0.5 | 15 | 20 | 20 | 20 | 20 |
| cfvo_60_100 cm_Q0.5 | 10 | 20 | 20 | 20 | 20 |
| cfvo_100_200 cm_Q0.5 | 15 | 10 | 10 | 10 | 10 |
| clay_0_5 cm_Q0.5 | 180 | 183 | 183 | 183 | 183 |
| clay_5_15 cm_Q0.5 | 189 | 197 | 197 | 197 | 197 |
| clay_15_30 cm_Q0.5 | 187 | 198 | 198 | 198 | 198 |
| clay_30_60 cm_Q0.5 | 214 | 216 | 216 | 216 | 216 |
| clay_60_100 cm_Q0.5 | 207 | 214 | 214 | 214 | 214 |
| clay_100_200 cm_Q0.5 | 160 | 160 | 160 | 160 | 160 |
| phh2o_0_5 cm_Q0.5 | 63 | 62 | 62 | 62 | 62 |
| phh2o_5_15 cm_Q0.5 | 63 | 63 | 63 | 63 | 63 |
| phh2o_15_30 cm_Q0.5 | 63 | 62 | 62 | 62 | 62 |
| phh2o_30_60 cm_Q0.5 | 65 | 64 | 64 | 64 | 64 |
| phh2o_60_100 cm_Q0.5 | 71 | 71 | 71 | 71 | 71 |
| phh2o_100_200 cm_Q0.5 | 74 | 74 | 74 | 74 | 74 |
| sand_0_5 cm_Q0.5 | 405 | 416 | 416 | 416 | 416 |
| sand_5_15 cm_Q0.5 | 399 | 398 | 398 | 398 | 398 |
| sand_15_30 cm_Q0.5 | 400 | 401 | 401 | 401 | 401 |
| sand_30_60 cm_Q0.5 | 389 | 389 | 389 | 389 | 389 |
| sand_60_100 cm_Q0.5 | 402 | 403 | 403 | 403 | 403 |
| sand_100_200 cm_Q0.5 | 458 | 462 | 462 | 462 | 462 |
| silt_0_5 cm_Q0.5 | 390 | 376 | 376 | 376 | 376 |
| silt_5_15 cm_Q0.5 | 405 | 400 | 400 | 400 | 400 |
| silt_15_30 cm_Q0.5 | 397 | 384 | 384 | 384 | 384 |
| silt_30_60 cm_Q0.5 | 383 | 372 | 372 | 372 | 372 |
| silt_60_100 cm_Q0.5 | 370 | 352 | 352 | 352 | 352 |
| silt_100_200 cm_Q0.5 | 348 | 344 | 344 | 344 | 344 |
| cec_0_5 cm_mean | 230 | 232 | 232 | 232 | 232 |
| cec_5_15 cm_mean | 216 | 210 | 210 | 210 | 210 |
| cec_15_30 cm_mean | 208 | 201 | 201 | 201 | 201 |
| cec_30_60 cm_mean | 227 | 217 | 217 | 217 | 217 |
| cec_60_100 cm_mean | 255 | 235 | 235 | 235 | 235 |
| cec_100_200 cm_mean | 275 | 258 | 258 | 258 | 258 |
| cfvo_0_5 cm_mean | 79 | 71 | 71 | 71 | 71 |
| cfvo_5_15 cm_mean | 76 | 70 | 70 | 70 | 70 |
| cfvo_15_30 cm_mean | 87 | 79 | 79 | 79 | 79 |
| cfvo_30_60 cm_mean | 95 | 91 | 91 | 91 | 91 |
| cfvo_60_100 cm_mean | 103 | 101 | 101 | 101 | 101 |
| cfvo_100_200 cm_mean | 125 | 118 | 118 | 118 | 118 |
| clay_0_5 cm_mean | 211 | 214 | 214 | 214 | 214 |
| clay_5_15 cm_mean | 200 | 204 | 204 | 204 | 204 |
| clay_15_30 cm_mean | 214 | 214 | 214 | 214 | 214 |
| clay_30_60 cm_mean | 243 | 243 | 243 | 243 | 243 |
| clay_60_100 cm_mean | 235 | 240 | 240 | 240 | 240 |
| clay_100_200 cm_mean | 204 | 206 | 206 | 206 | 206 |
| phh2o_0_5 cm_mean | 62 | 62 | 62 | 62 | 62 |
| phh2o_5_15 cm_mean | 62 | 62 | 62 | 62 | 62 |
| phh2o_15_30 cm_mean | 63 | 63 | 63 | 63 | 63 |
| phh2o_30_60 cm_mean | 66 | 66 | 66 | 66 | 66 |
| phh2o_60_100 cm_mean | 70 | 70 | 70 | 70 | 70 |
| phh2o_100_200 cm_mean | 73 | 72 | 72 | 72 | 72 |
| sand_0_5 cm_mean | 412 | 423 | 423 | 423 | 423 |
| sand_5_15 cm_mean | 403 | 409 | 409 | 409 | 409 |
| sand_15_30 cm_mean | 401 | 410 | 410 | 410 | 410 |
| sand_30_60 cm_mean | 385 | 394 | 394 | 394 | 394 |
| sand_60_100 cm_mean | 407 | 415 | 415 | 415 | 415 |
| sand_100_200 cm_mean | 457 | 460 | 460 | 460 | 460 |
| silt_0_5 cm_mean | 376 | 364 | 364 | 364 | 364 |
| silt_5_15 cm_mean | 397 | 387 | 387 | 387 | 387 |
| silt_15_30 cm_mean | 385 | 377 | 377 | 377 | 377 |
| silt_30_60 cm_mean | 372 | 364 | 364 | 364 | 364 |
| silt_60_100 cm_mean | 368 | 345 | 345 | 345 | 345 |
| silt_100_200 cm_mean | 339 | 334 | 334 | 334 | 334 |
| cec_0_5 cm_Q0.95 | 487 | 481 | 481 | 481 | 481 |
| cec_5_15 cm_Q0.95 | 487 | 485 | 485 | 485 | 485 |
| cec_15_30 cm_Q0.95 | 451 | 452 | 452 | 452 | 452 |
| cec_30_60 cm_Q0.95 | 459 | 486 | 486 | 486 | 486 |
| cec_60_100 cm_Q0.95 | 645 | 645 | 645 | 645 | 645 |
| cec_100_200 cm_Q0.95 | 647 | 649 | 649 | 649 | 649 |
| cfvo_0_5 cm_Q0.95 | 361 | 335 | 335 | 335 | 335 |
| cfvo_5_15 cm_Q0.95 | 361 | 335 | 335 | 335 | 335 |
| cfvo_15_30 cm_Q0.95 | 400 | 400 | 400 | 400 | 400 |
| cfvo_30_60 cm_Q0.95 | 450 | 450 | 450 | 450 | 450 |
| cfvo_60_100 cm_Q0.95 | 450 | 451 | 451 | 451 | 451 |
| cfvo_100_200 cm_Q0.95 | 451 | 481 | 481 | 481 | 481 |
| clay_0_5 cm_Q0.95 | 543 | 509 | 509 | 509 | 509 |
| clay_5_15 cm_Q0.95 | 378 | 378 | 378 | 378 | 378 |
| clay_15_30 cm_Q0.95 | 509 | 490 | 490 | 490 | 490 |
| clay_30_60 cm_Q0.95 | 549 | 534 | 534 | 534 | 534 |
| clay_60_100 cm_Q0.95 | 528 | 517 | 517 | 517 | 517 |
| clay_100_200 cm_Q0.95 | 528 | 528 | 528 | 528 | 528 |
| phh2o_0_5 cm_Q0.95 | 75 | 77 | 77 | 77 | 77 |
| phh2o_5_15 cm_Q0.95 | 75 | 76 | 76 | 76 | 76 |
| phh2o_15_30 cm_Q0.95 | 76 | 78 | 78 | 78 | 78 |
| phh2o_30_60 cm_Q0.95 | 85 | 85 | 85 | 85 | 85 |
| phh2o_60_100 cm_Q0.95 | 87 | 86 | 86 | 86 | 86 |
| phh2o_100_200 cm_Q0.95 | 86 | 85 | 85 | 85 | 85 |
| sand_0_5 cm_Q0.95 | 645 | 657 | 657 | 657 | 657 |
| sand_5_15 cm_Q0.95 | 603 | 622 | 622 | 622 | 622 |
| sand_15_30 cm_Q0.95 | 598 | 601 | 601 | 601 | 601 |
| sand_30_60 cm_Q0.95 | 617 | 617 | 617 | 617 | 617 |
| sand_60_100 cm_Q0.95 | 648 | 659 | 659 | 659 | 659 |
| sand_100_200 cm_Q0.95 | 704 | 705 | 705 | 705 | 705 |
| silt_0_5 cm_Q0.95 | 645 | 598 | 598 | 598 | 598 |
| silt_5_15 cm_Q0.95 | 615 | 598 | 598 | 598 | 598 |
| silt_15_30 cm_Q0.95 | 611 | 609 | 609 | 609 | 609 |
| silt_30_60 cm_Q0.95 | 630 | 623 | 623 | 623 | 623 |
| silt_60_100 cm_Q0.95 | 593 | 579 | 579 | 579 | 579 |
| silt_100_200 cm_Q0.95 | 647 | 622 | 622 | 622 | 622 |

Processing circuitry being supplied with this multitude of predictors and the analysis points given can utilize a threshold for predictors that are informative in determining or have a sufficient impact on determination and the predictors that are not utilized. This generates a subset of candidate predictor variables. A selection of points throughout the parcels are associated with this subset and shown in Table 6 and modeled data provided in Table 8. Table 6 represents exemplary 100 points distributed within the parcels. As many points as practical can utilizing informative predictor values. After determining the subset, data as shown in Table 6 can be provided for parcels or portions of parcels as shown in Step 2. For example, the V4's represent selected predictor values within parcel 200 and the X2's indicate selected predictor values within parcel 190. Additionally, the predictor values as shown in location are shown for V3 are provided for parcel 300 and these are the predictor values that can be used to determine what the soil organic carbon is for a plot or parcel that has not been sampled.

TABLE 6
Selected Predictive Parcel Data

| Parcel | Sample Location | prcp_mean | prcp_max | prcp_sd | srad_max | srad_sd | tmax_mean | tmax_sd |
|---|---|---|---|---|---|---|---|---|
| V4 | V4_868_2022-03-02 | 1.93 | 105.89 | 9.09 | 442.02 | 85.98 | 19.89 | 6.69 |
| V4 | V4_6867_2022-03-02 | 1.93 | 105.89 | 9.09 | 442.02 | 85.98 | 19.89 | 6.69 |
| V4 | V4_3471_2022-03-02 | 1.93 | 105.89 | 9.09 | 442.02 | 85.98 | 19.89 | 6.69 |
| V4 | V4_6747_2022-03-02 | 1.93 | 105.89 | 9.09 | 442.02 | 85.98 | 19.89 | 6.69 |
| V4 | V4_4791_2022-03-02 | 1.93 | 105.89 | 9.09 | 442.02 | 85.98 | 19.89 | 6.69 |
| V4 | V4_347_2022-03-02 | 1.93 | 105.89 | 9.09 | 442.02 | 85.98 | 19.89 | 6.69 |
| V4 | V4_2596_2022-03-02 | 1.93 | 105.89 | 9.09 | 442.02 | 85.98 | 19.89 | 6.69 |
| V4 | V4_6941_2022-03-02 | 1.93 | 105.89 | 9.09 | 442.02 | 85.98 | 19.89 | 6.69 |
| V4 | V4_2045_2022-03-02 | 1.93 | 105.89 | 9.09 | 442.02 | 85.98 | 19.89 | 6.69 |
| V4 | V4_364_2022-03-02 | 1.93 | 105.89 | 9.09 | 442.02 | 85.98 | 19.89 | 6.69 |
| V4 | V4_1912_2022-03-02 | 1.93 | 105.89 | 9.09 | 442.02 | 85.98 | 19.89 | 6.69 |
| V4 | V4_671_2022-03-02 | 1.93 | 105.89 | 9.09 | 442.02 | 85.98 | 19.89 | 6.69 |
| V4 | V4_7799_2022-03-02 | 1.93 | 105.89 | 9.09 | 442.02 | 85.98 | 19.89 | 6.69 |
| V4 | V4_4102_2022-03-02 | 1.93 | 105.89 | 9.09 | 442.02 | 85.98 | 19.89 | 6.69 |
| V4 | V4_7724_2022-03-02 | 1.93 | 105.89 | 9.09 | 442.02 | 85.98 | 19.89 | 6.69 |
| V4 | V4_2192_2022-03-02 | 1.93 | 105.89 | 9.09 | 442.02 | 85.98 | 19.89 | 6.69 |
| V4 | V4_6771_2022-03-02 | 1.93 | 105.89 | 9.09 | 442.02 | 85.98 | 19.89 | 6.69 |
| V4 | V4_6189_2022-03-02 | 1.93 | 105.89 | 9.09 | 442.02 | 85.98 | 19.89 | 6.69 |
| V4 | V4_5022_2022-03-02 | 1.93 | 105.89 | 9.09 | 442.02 | 85.98 | 19.89 | 6.69 |
| V4 | V4_8097_2022-03-02 | 1.93 | 105.89 | 9.09 | 442.02 | 85.98 | 19.89 | 6.69 |
| V4 | V4_1667_2022-03-02 | 1.93 | 105.89 | 9.09 | 442.02 | 85.98 | 19.89 | 6.69 |
| V4 | V4_9462_2022-03-02 | 1.93 | 105.89 | 9.09 | 442.02 | 85.98 | 19.89 | 6.69 |
| V4 | V4_7611_2022-03-02 | 1.93 | 105.89 | 9.09 | 442.02 | 85.98 | 19.89 | 6.69 |
| V4 | V4_3027_2022-03-02 | 1.93 | 105.89 | 9.09 | 442.02 | 85.98 | 19.89 | 6.69 |
| V4 | V4_6852_2022-03-02 | 1.93 | 105.89 | 9.09 | 442.02 | 85.98 | 19.89 | 6.69 |
| V4 | V4_6831_2022-03-02 | 1.93 | 105.89 | 9.09 | 442.02 | 85.98 | 19.89 | 6.69 |
| V4 | V4_870_2022-03-02 | 1.93 | 105.89 | 9.09 | 442.02 | 85.98 | 19.89 | 6.69 |
| V4 | V4_6523_2022-03-02 | 1.93 | 105.89 | 9.09 | 442.02 | 85.98 | 19.89 | 6.69 |
| V4 | V4_3805_2022-03-02 | 1.93 | 105.89 | 9.09 | 442.02 | 85.98 | 19.89 | 6.69 |
| V4 | V4_4525_2022-03-02 | 1.93 | 105.89 | 9.09 | 442.02 | 85.98 | 19.89 | 6.69 |
| V4 | V4_6377_2022-03-02 | 1.93 | 105.89 | 9.09 | 442.02 | 85.98 | 19.89 | 6.69 |
| V4 | V4_436_2022-03-02 | 1.93 | 105.89 | 9.09 | 442.02 | 85.98 | 19.89 | 6.69 |
| V4 | V4_2891_2022-03-02 | 1.93 | 105.89 | 9.09 | 442.02 | 85.98 | 19.89 | 6.69 |
| V4 | V4_1184_2022-03-02 | 1.93 | 105.89 | 9.09 | 442.02 | 85.98 | 19.89 | 6.69 |
| V4 | V4_4085_2022-03-02 | 1.93 | 105.89 | 9.09 | 442.02 | 85.98 | 19.89 | 6.69 |
| V4 | V4_9182_2022-03-02 | 1.93 | 105.89 | 9.09 | 442.02 | 85.98 | 19.89 | 6.69 |
| V4 | V4_1435_2022-03-02 | 1.93 | 105.89 | 9.09 | 442.02 | 85.98 | 19.89 | 6.69 |
| V4 | V4_6125_2022-03-02 | 1.93 | 105.89 | 9.09 | 442.02 | 85.98 | 19.89 | 6.69 |
| V4 | V4_2617_2022-03-02 | 1.93 | 105.89 | 9.09 | 442.02 | 85.98 | 19.89 | 6.69 |
| V4 | V4_7028_2022-03-02 | 1.93 | 105.89 | 9.09 | 442.02 | 85.98 | 19.89 | 6.69 |
| V4 | V4_6527_2022-03-02 | 1.93 | 105.89 | 9.09 | 442.02 | 85.98 | 19.89 | 6.69 |
| V4 | V4_803_2022-03-02 | 1.93 | 105.89 | 9.09 | 442.02 | 85.98 | 19.89 | 6.69 |
| V4 | V4_1599_2022-03-02 | 1.93 | 105.89 | 9.09 | 442.02 | 85.98 | 19.89 | 6.69 |
| V4 | V4_4514_2022-03-02 | 1.93 | 105.89 | 9.09 | 442.02 | 85.98 | 19.89 | 6.69 |
| V4 | V4_5473_2022-03-02 | 1.93 | 105.89 | 9.09 | 442.02 | 85.98 | 19.89 | 6.69 |
| V4 | V4_6350_2022-03-02 | 1.93 | 105.89 | 9.09 | 442.02 | 85.98 | 19.89 | 6.69 |
| V4 | V4_1573_2022-03-02 | 1.93 | 105.89 | 9.09 | 442.02 | 85.98 | 19.89 | 6.69 |
| V4 | V4_7026_2022-03-02 | 1.93 | 105.89 | 9.09 | 442.02 | 85.98 | 19.89 | 6.69 |
| V4 | V4_7022_2022-03-02 | 1.93 | 105.89 | 9.09 | 442.02 | 85.98 | 19.89 | 6.69 |
| V4 | V4_2115_2022-03-02 | 1.93 | 105.89 | 9.09 | 442.02 | 85.98 | 19.89 | 6.69 |
| V4 | V4_7182_2022-03-02 | 1.93 | 105.89 | 9.09 | 442.02 | 85.98 | 19.89 | 6.69 |
| V4 | V4_5933_2022-03-02 | 1.93 | 105.89 | 9.09 | 442.02 | 85.98 | 19.89 | 6.69 |
| V4 | V4_5966_2022-03-02 | 1.93 | 105.89 | 9.09 | 442.02 | 85.98 | 19.89 | 6.69 |
| V4 | V4_5997_2022-03-02 | 1.93 | 105.89 | 9.09 | 442.02 | 85.98 | 19.89 | 6.69 |
| V4 | V4_5452_2022-03-02 | 1.93 | 105.89 | 9.09 | 442.02 | 85.98 | 19.89 | 6.69 |
| V4 | V4_2451_2022-03-02 | 1.93 | 105.89 | 9.09 | 442.02 | 85.98 | 19.89 | 6.69 |
| V4 | V4_7220_2022-03-02 | 1.93 | 105.89 | 9.09 | 442.02 | 85.98 | 19.89 | 6.69 |
| V4 | V4_3784_2022-03-02 | 1.93 | 105.89 | 9.09 | 442.02 | 85.98 | 19.89 | 6.69 |
| V4 | V4_2823_2022-03-02 | 1.93 | 105.89 | 9.09 | 442.02 | 85.98 | 19.89 | 6.69 |
| V4 | V4_6931_2022-03-02 | 1.93 | 105.89 | 9.09 | 442.02 | 85.98 | 19.89 | 6.69 |
| V4 | V4_3790_2022-03-02 | 1.93 | 105.89 | 9.09 | 442.02 | 85.98 | 19.89 | 6.69 |
| V4 | V4_3583_2022-03-02 | 1.93 | 105.89 | 9.09 | 442.02 | 85.98 | 19.89 | 6.69 |
| V4 | V4_7031_2022-03-02 | 1.93 | 105.89 | 9.09 | 442.02 | 85.98 | 19.89 | 6.69 |
| V4 | V4_683_2022-03-02 | 1.93 | 105.89 | 9.09 | 442.02 | 85.98 | 19.89 | 6.69 |
| V4 | V4_1915_2022-03-02 | 1.93 | 105.89 | 9.09 | 442.02 | 85.98 | 19.89 | 6.69 |
| V4 | V4_486_2022-03-02 | 1.93 | 105.89 | 9.09 | 442.02 | 85.98 | 19.89 | 6.69 |
| V4 | V4_186_2022-03-02 | 1.93 | 105.89 | 9.09 | 442.02 | 85.98 | 19.89 | 6.69 |
| V4 | V4_7797_2022-03-02 | 1.93 | 105.89 | 9.09 | 442.02 | 85.98 | 19.89 | 6.69 |
| V4 | V4_409_2022-03-02 | 1.93 | 105.89 | 9.09 | 442.02 | 85.98 | 19.89 | 6.69 |
| V4 | V4_5357_2022-03-02 | 1.93 | 105.89 | 9.09 | 442.02 | 85.98 | 19.89 | 6.69 |
| V4 | V4_1523_2022-03-02 | 1.93 | 105.89 | 9.09 | 442.02 | 85.98 | 19.89 | 6.69 |
| V4 | V4_4371_2022-03-02 | 1.93 | 105.89 | 9.09 | 442.02 | 85.98 | 19.89 | 6.69 |
| V4 | V4_8881_2022-03-02 | 1.93 | 105.89 | 9.09 | 442.02 | 85.98 | 19.89 | 6.69 |
| V4 | V4_8373_2022-03-02 | 1.93 | 105.89 | 9.09 | 442.02 | 85.98 | 19.89 | 6.69 |
| V4 | V4_1478_2022-03-02 | 1.93 | 105.89 | 9.09 | 442.02 | 85.98 | 19.89 | 6.69 |
| V4 | V4_4301_2022-03-02 | 1.93 | 105.89 | 9.09 | 442.02 | 85.98 | 19.89 | 6.69 |
| V4 | V4_323_2022-03-02 | 1.93 | 105.89 | 9.09 | 442.02 | 85.98 | 19.89 | 6.69 |
| V4 | V4_3431_2022-03-02 | 1.93 | 105.89 | 9.09 | 442.02 | 85.98 | 19.89 | 6.69 |
| V4 | V4_7492_2022-03-02 | 1.93 | 105.89 | 9.09 | 442.02 | 85.98 | 19.89 | 6.69 |
| V4 | V4_5402_2022-03-02 | 1.93 | 105.89 | 9.09 | 442.02 | 85.98 | 19.89 | 6.69 |
| V4 | V4_7880_2022-03-02 | 1.93 | 105.89 | 9.09 | 442.02 | 85.98 | 19.89 | 6.69 |
| V4 | V4_1649_2022-03-02 | 1.93 | 105.89 | 9.09 | 442.02 | 85.98 | 19.89 | 6.69 |
| V4 | V4_6283_2022-03-02 | 1.93 | 105.89 | 9.09 | 442.02 | 85.98 | 19.89 | 6.69 |
| V4 | V4_6773_2022-03-02 | 1.93 | 105.89 | 9.09 | 442.02 | 85.98 | 19.89 | 6.69 |
| V4 | V4_6698_2022-03-02 | 1.93 | 105.89 | 9.09 | 442.02 | 85.98 | 19.89 | 6.69 |
| V4 | V4_4345_2022-03-02 | 1.93 | 105.89 | 9.09 | 442.02 | 85.98 | 19.89 | 6.69 |
| V4 | V4_3444_2022-03-02 | 1.93 | 105.89 | 9.09 | 442.02 | 85.98 | 19.89 | 6.69 |
| V4 | V4_8828_2022-03-02 | 1.93 | 105.89 | 9.09 | 442.02 | 85.98 | 19.89 | 6.69 |
| V4 | V4_2342_2022-03-02 | 1.93 | 105.89 | 9.09 | 442.02 | 85.98 | 19.89 | 6.69 |
| V4 | V4_7869_2022-03-02 | 1.93 | 105.89 | 9.09 | 442.02 | 85.98 | 19.89 | 6.69 |
| V4 | V4_5671_2022-03-02 | 1.93 | 105.89 | 9.09 | 442.02 | 85.98 | 19.89 | 6.69 |
| V4 | V4_7159_2022-03-02 | 1.93 | 105.89 | 9.09 | 442.02 | 85.98 | 19.89 | 6.69 |
| V4 | V4_732_2022-03-02 | 1.93 | 105.89 | 9.09 | 442.02 | 85.98 | 19.89 | 6.69 |
| V4 | V4_1168_2022-03-02 | 1.93 | 105.89 | 9.09 | 442.02 | 85.98 | 19.89 | 6.69 |
| V4 | V4_770_2022-03-02 | 1.93 | 105.89 | 9.09 | 442.02 | 85.98 | 19.89 | 6.69 |
| V4 | V4_5732_2022-03-02 | 1.93 | 105.89 | 9.09 | 442.02 | 85.98 | 19.89 | 6.69 |
| V4 | V4_882_2022-03-02 | 1.93 | 105.89 | 9.09 | 442.02 | 85.98 | 19.89 | 6.69 |
| V4 | V4_2182_2022-03-02 | 1.93 | 105.89 | 9.09 | 442.02 | 85.98 | 19.89 | 6.69 |
| V4 | V4_3303_2022-03-02 | 1.93 | 105.89 | 9.09 | 442.02 | 85.98 | 19.89 | 6.69 |
| V4 | V4_460_2022-03-02 | 1.93 | 105.89 | 9.09 | 442.02 | 85.98 | 19.89 | 6.69 |
| X2 | X2_4320_2022-02-10 | 3.58 | 138.74 | 13.78 | 449.17 | 93.72 | 18.83 | 5.82 |
| X2 | X2_612_2022-02-10 | 3.58 | 138.74 | 13.78 | 449.17 | 93.72 | 18.83 | 5.82 |
| X2 | X2_1296_2022-02-10 | 3.58 | 138.74 | 13.78 | 449.17 | 93.72 | 18.83 | 5.82 |
| X2 | X2_2990_2022-02-10 | 3.58 | 138.74 | 13.78 | 449.17 | 93.72 | 18.83 | 5.82 |
| X2 | X2_2873_2022-02-10 | 3.58 | 138.74 | 13.78 | 449.17 | 93.72 | 18.83 | 5.82 |
| X2 | X2_3173_2022-02-10 | 3.58 | 138.74 | 13.78 | 449.17 | 93.72 | 18.83 | 5.82 |
| X2 | X2_1092_2022-02-10 | 3.58 | 138.74 | 13.78 | 449.17 | 93.72 | 18.83 | 5.82 |
| X2 | X2_824_2022-02-10 | 3.58 | 138.74 | 13.78 | 449.17 | 93.72 | 18.83 | 5.82 |
| X2 | X2_3490_2022-02-10 | 3.58 | 138.74 | 13.78 | 449.17 | 93.72 | 18.83 | 5.82 |
| X2 | X2_1898_2022-02-10 | 3.58 | 138.74 | 13.78 | 449.17 | 93.72 | 18.83 | 5.82 |
| X2 | X2_2911_2022-02-10 | 3.58 | 138.74 | 13.78 | 449.17 | 93.72 | 18.83 | 5.82 |
| X2 | X2_4214_2022-02-10 | 3.58 | 138.74 | 13.78 | 449.17 | 93.72 | 18.83 | 5.82 |
| X2 | X2_2468_2022-02-10 | 3.58 | 138.74 | 13.78 | 449.17 | 93.72 | 18.83 | 5.82 |
| X2 | X2_579_2022-02-10 | 3.58 | 138.74 | 13.78 | 449.17 | 93.72 | 18.83 | 5.82 |
| X2 | X2_3900_2022-02-10 | 3.58 | 138.74 | 13.78 | 449.17 | 93.72 | 18.83 | 5.82 |
| X2 | X2_1614_2022-02-10 | 3.58 | 138.74 | 13.78 | 449.17 | 93.72 | 18.83 | 5.82 |
| X2 | X2_1583_2022-02-10 | 3.58 | 138.74 | 13.78 | 449.17 | 93.72 | 18.83 | 5.82 |
| X2 | X2_3108_2022-02-10 | 3.58 | 138.74 | 13.78 | 449.17 | 93.72 | 18.83 | 5.82 |
| X2 | X2_3357_2022-02-10 | 3.58 | 138.74 | 13.78 | 449.17 | 93.72 | 18.83 | 5.82 |
| X2 | X2_4246_2022-02-10 | 3.58 | 138.74 | 13.78 | 449.17 | 93.72 | 18.83 | 5.82 |
| X2 | X2_166_2022-02-10 | 3.58 | 138.74 | 13.78 | 449.17 | 93.72 | 18.83 | 5.82 |
| X2 | X2_470_2022-02-10 | 3.58 | 138.74 | 13.78 | 449.17 | 93.72 | 18.83 | 5.82 |
| X2 | X2_187_2022-02-10 | 3.58 | 138.74 | 13.78 | 449.17 | 93.72 | 18.83 | 5.82 |
| X2 | X2_1055_2022-02-10 | 3.58 | 138.74 | 13.78 | 449.17 | 93.72 | 18.83 | 5.82 |
| X2 | X2_1454_2022-02-10 | 3.58 | 138.74 | 13.78 | 449.17 | 93.72 | 18.83 | 5.82 |
| X2 | X2_4093_2022-02-10 | 3.58 | 138.74 | 13.78 | 449.17 | 93.72 | 18.83 | 5.82 |
| X2 | X2_3319_2022-02-10 | 3.58 | 138.74 | 13.78 | 449.17 | 93.72 | 18.83 | 5.82 |
| X2 | X2_2763_2022-02-10 | 3.58 | 138.74 | 13.78 | 449.17 | 93.72 | 18.83 | 5.82 |
| X2 | X2_1935_2022-02-10 | 3.58 | 138.74 | 13.78 | 449.17 | 93.72 | 18.83 | 5.82 |
| X2 | X2_4772_2022-02-10 | 3.58 | 138.74 | 13.78 | 449.17 | 93.72 | 18.83 | 5.82 |
| X2 | X2_401_2022-02-10 | 3.58 | 138.74 | 13.78 | 449.17 | 93.72 | 18.83 | 5.82 |
| X2 | X2_1589_2022-02-10 | 3.58 | 138.74 | 13.78 | 449.17 | 93.72 | 18.83 | 5.82 |
| X2 | X2_4620_2022-02-10 | 3.58 | 138.74 | 13.78 | 449.17 | 93.72 | 18.83 | 5.82 |
| X2 | X2_2168_2022-02-10 | 3.58 | 138.74 | 13.78 | 449.17 | 93.72 | 18.83 | 5.82 |
| X2 | X2_4229_2022-02-10 | 3.58 | 138.74 | 13.78 | 449.17 | 93.72 | 18.83 | 5.82 |
| X2 | X2_4757_2022-02-10 | 3.58 | 138.74 | 13.78 | 449.17 | 93.72 | 18.83 | 5.82 |
| X2 | X2_1793_2022-02-10 | 3.58 | 138.74 | 13.78 | 449.17 | 93.72 | 18.83 | 5.82 |
| X2 | X2_2846_2022-02-10 | 3.58 | 138.74 | 13.78 | 449.17 | 93.72 | 18.83 | 5.82 |
| X2 | X2_3003_2022-02-10 | 3.58 | 138.74 | 13.78 | 449.17 | 93.72 | 18.83 | 5.82 |
| X2 | X2_831_2022-02-10 | 3.58 | 138.74 | 13.78 | 449.17 | 93.72 | 18.83 | 5.82 |
| X2 | X2_2608_2022-02-10 | 3.58 | 138.74 | 13.78 | 449.17 | 93.72 | 18.83 | 5.82 |
| X2 | X2_2125_2022-02-10 | 3.58 | 138.74 | 13.78 | 449.17 | 93.72 | 18.83 | 5.82 |
| X2 | X2_3773_2022-02-10 | 3.58 | 138.74 | 13.78 | 449.17 | 93.72 | 18.83 | 5.82 |
| X2 | X2_3525_2022-02-10 | 3.58 | 138.74 | 13.78 | 449.17 | 93.72 | 18.83 | 5.82 |
| X2 | X2_4127_2022-02-10 | 3.58 | 138.74 | 13.78 | 449.17 | 93.72 | 18.83 | 5.82 |
| X2 | X2_1406_2022-02-10 | 3.58 | 138.74 | 13.78 | 449.17 | 93.72 | 18.83 | 5.82 |
| X2 | X2_3023_2022-02-10 | 3.58 | 138.74 | 13.78 | 449.17 | 93.72 | 18.83 | 5.82 |
| X2 | X2_2454_2022-02-10 | 3.58 | 138.74 | 13.78 | 449.17 | 93.72 | 18.83 | 5.82 |
| X2 | X2_4852_2022-02-10 | 3.58 | 138.74 | 13.78 | 449.17 | 93.72 | 18.83 | 5.82 |
| X2 | X2_4037_2022-02-10 | 3.58 | 138.74 | 13.78 | 449.17 | 93.72 | 18.83 | 5.82 |
| X2 | X2_2451_2022-02-10 | 3.58 | 138.74 | 13.78 | 449.17 | 93.72 | 18.83 | 5.82 |
| X2 | X2_4742_2022-02-10 | 3.58 | 138.74 | 13.78 | 449.17 | 93.72 | 18.83 | 5.82 |
| X2 | X2_3517_2022-02-10 | 3.58 | 138.74 | 13.78 | 449.17 | 93.72 | 18.83 | 5.82 |
| X2 | X2_1957_2022-02-10 | 3.58 | 138.74 | 13.78 | 449.17 | 93.72 | 18.83 | 5.82 |
| X2 | X2_1824_2022-02-10 | 3.58 | 138.74 | 13.78 | 449.17 | 93.72 | 18.83 | 5.82 |
| X2 | X2_1738_2022-02-10 | 3.58 | 138.74 | 13.78 | 449.17 | 93.72 | 18.83 | 5.82 |
| X2 | X2_1845_2022-02-10 | 3.58 | 138.74 | 13.78 | 449.17 | 93.72 | 18.83 | 5.82 |
| X2 | X2_260_2022-02-10 | 3.58 | 138.74 | 13.78 | 449.17 | 93.72 | 18.83 | 5.82 |
| X2 | X2_2894_2022-02-10 | 3.58 | 138.74 | 13.78 | 449.17 | 93.72 | 18.83 | 5.82 |
| X2 | X2_1785_2022-02-10 | 3.58 | 138.74 | 13.78 | 449.17 | 93.72 | 18.83 | 5.82 |
| X2 | X2_847_2022-02-10 | 3.58 | 138.74 | 13.78 | 449.17 | 93.72 | 18.83 | 5.82 |
| X2 | X2_2981_2022-02-10 | 3.58 | 138.74 | 13.78 | 449.17 | 93.72 | 18.83 | 5.82 |
| X2 | X2_3846_2022-02-10 | 3.58 | 138.74 | 13.78 | 449.17 | 93.72 | 18.83 | 5.82 |
| X2 | X2_521_2022-02-10 | 3.58 | 138.74 | 13.78 | 449.17 | 93.72 | 18.83 | 5.82 |
| X2 | X2_4855_2022-02-10 | 3.58 | 138.74 | 13.78 | 449.17 | 93.72 | 18.83 | 5.82 |
| X2 | X2_2346_2022-02-10 | 3.58 | 138.74 | 13.78 | 449.17 | 93.72 | 18.83 | 5.82 |
| X2 | X2_3167_2022-02-10 | 3.58 | 138.74 | 13.78 | 449.17 | 93.72 | 18.83 | 5.82 |
| X2 | X2_4024_2022-02-10 | 3.58 | 138.74 | 13.78 | 449.17 | 93.72 | 18.83 | 5.82 |
| X2 | X2_195_2022-02-10 | 3.58 | 138.74 | 13.78 | 449.17 | 93.72 | 18.83 | 5.82 |
| X2 | X2_2500_2022-02-10 | 3.58 | 138.74 | 13.78 | 449.17 | 93.72 | 18.83 | 5.82 |
| X2 | X2_1170_2022-02-10 | 3.58 | 138.74 | 13.78 | 449.17 | 93.72 | 18.83 | 5.82 |
| X2 | X2_4653_2022-02-10 | 3.58 | 138.74 | 13.78 | 449.17 | 93.72 | 18.83 | 5.82 |
| X2 | X2_2132_2022-02-10 | 3.58 | 138.74 | 13.78 | 449.17 | 93.72 | 18.83 | 5.82 |
| X2 | X2_4926_2022-02-10 | 3.58 | 138.74 | 13.78 | 449.17 | 93.72 | 18.83 | 5.82 |
| X2 | X2_2832_2022-02-10 | 3.58 | 138.74 | 13.78 | 449.17 | 93.72 | 18.83 | 5.82 |
| X2 | X2_391_2022-02-10 | 3.58 | 138.74 | 13.78 | 449.17 | 93.72 | 18.83 | 5.82 |
| X2 | X2_365_2022-02-10 | 3.58 | 138.74 | 13.78 | 449.17 | 93.72 | 18.83 | 5.82 |
| X2 | X2_3691_2022-02-10 | 3.58 | 138.74 | 13.78 | 449.17 | 93.72 | 18.83 | 5.82 |
| X2 | X2_3695_2022-02-10 | 3.58 | 138.74 | 13.78 | 449.17 | 93.72 | 18.83 | 5.82 |
| X2 | X2_2241_2022-02-10 | 3.58 | 138.74 | 13.78 | 449.17 | 93.72 | 18.83 | 5.82 |
| X2 | X2_2562_2022-02-10 | 3.58 | 138.74 | 13.78 | 449.17 | 93.72 | 18.83 | 5.82 |
| X2 | X2_2663_2022-02-10 | 3.58 | 138.74 | 13.78 | 449.17 | 93.72 | 18.83 | 5.82 |
| X2 | X2_1001_2022-02-10 | 3.58 | 138.74 | 13.78 | 449.17 | 93.72 | 18.83 | 5.82 |
| X2 | X2_972_2022-02-10 | 3.58 | 138.74 | 13.78 | 449.17 | 93.72 | 18.83 | 5.82 |
| X2 | X2_81_2022-02-10 | 3.58 | 138.74 | 13.78 | 449.17 | 93.72 | 18.83 | 5.82 |
| X2 | X2_3910_2022-02-10 | 3.58 | 138.74 | 13.78 | 449.17 | 93.72 | 18.83 | 5.82 |
| X2 | X2_2262_2022-02-10 | 3.58 | 138.74 | 13.78 | 449.17 | 93.72 | 18.83 | 5.82 |
| X2 | X2_1558_2022-02-10 | 3.58 | 138.74 | 13.78 | 449.17 | 93.72 | 18.83 | 5.82 |
| X2 | X2_287_2022-02-10 | 3.58 | 138.74 | 13.78 | 449.17 | 93.72 | 18.83 | 5.82 |
| X2 | X2_1669_2022-02-10 | 3.58 | 138.74 | 13.78 | 449.17 | 93.72 | 18.83 | 5.82 |
| X2 | X2_4636_2022-02-10 | 3.58 | 138.74 | 13.78 | 449.17 | 93.72 | 18.83 | 5.82 |
| X2 | X2_4237_2022-02-10 | 3.58 | 138.74 | 13.78 | 449.17 | 93.72 | 18.83 | 5.82 |
| X2 | X2_3540_2022-02-10 | 3.58 | 138.74 | 13.78 | 449.17 | 93.72 | 18.83 | 5.82 |
| X2 | X2_1343_2022-02-10 | 3.58 | 138.74 | 13.78 | 449.17 | 93.72 | 18.83 | 5.82 |
| X2 | X2_1879_2022-02-10 | 3.58 | 138.74 | 13.78 | 449.17 | 93.72 | 18.83 | 5.82 |
| X2 | X2_1926_2022-02-10 | 3.58 | 138.74 | 13.78 | 449.17 | 93.72 | 18.83 | 5.82 |
| X2 | X2_117_2022-02-10 | 3.58 | 138.74 | 13.78 | 449.17 | 93.72 | 18.83 | 5.82 |
| X2 | X2_759_2022-02-10 | 3.58 | 138.74 | 13.78 | 449.17 | 93.72 | 18.83 | 5.82 |
| X2 | X2_1309_2022-02-10 | 3.58 | 138.74 | 13.78 | 449.17 | 93.72 | 18.83 | 5.82 |
| X2 | X2_3449_2022-02-10 | 3.58 | 138.74 | 13.78 | 449.17 | 93.72 | 18.83 | 5.82 |
| | Predicted Target Agricultural Data for Unsample Parcel | | | | | | | |
| V3 | V3_1750_2021-03-11 | 3.36 | 42.43 | 6.79 | 383.85 | 81.13 | 15.73 | 3.26 |
| V3 | V3_8649_2021-03-11 | 3.36 | 42.43 | 6.79 | 383.85 | 81.13 | 15.73 | 3.26 |
| V3 | V3_7102_2021-03-11 | 3.36 | 42.43 | 6.79 | 383.85 | 81.13 | 15.73 | 3.26 |
| V3 | V3_346_2021-03-11 | 3.36 | 42.43 | 6.79 | 383.85 | 81.13 | 15.73 | 3.26 |
| V3 | V3_6860_2021-03-11 | 3.36 | 42.43 | 6.79 | 383.85 | 81.13 | 15.73 | 3.26 |
| V3 | V3_2237_2021-03-11 | 3.36 | 42.43 | 6.79 | 383.85 | 81.13 | 15.73 | 3.26 |
| V3 | V3_3438_2021-03-11 | 3.36 | 42.43 | 6.79 | 383.85 | 81.13 | 15.73 | 3.26 |
| V3 | V3_8072_2021-03-11 | 3.36 | 42.43 | 6.79 | 383.85 | 81.13 | 15.73 | 3.26 |
| V3 | V3_7211_2021-03-11 | 3.36 | 42.43 | 6.79 | 383.85 | 81.13 | 15.73 | 3.26 |
| V3 | V3_6348_2021-03-11 | 3.36 | 42.43 | 6.79 | 383.85 | 81.13 | 15.73 | 3.26 |
| V3 | V3_3738_2021-03-11 | 3.36 | 42.43 | 6.79 | 383.85 | 81.13 | 15.73 | 3.26 |
| V3 | V3_8222_2021-03-11 | 3.36 | 42.43 | 6.79 | 383.85 | 81.13 | 15.73 | 3.26 |
| V3 | V3_5956_2021-03-11 | 3.36 | 42.43 | 6.79 | 383.85 | 81.13 | 15.73 | 3.26 |
| V3 | V3_5561_2021-03-11 | 3.36 | 42.43 | 6.79 | 383.85 | 81.13 | 15.73 | 3.26 |
| V3 | V3_1310_2021-03-11 | 3.36 | 42.43 | 6.79 | 383.85 | 81.13 | 15.73 | 3.26 |
| V3 | V3_6546_2021-03-11 | 3.36 | 42.43 | 6.79 | 383.85 | 81.13 | 15.73 | 3.26 |
| V3 | V3_4477_2021-03-11 | 3.36 | 42.43 | 6.79 | 383.85 | 81.13 | 15.73 | 3.26 |
| V3 | V3_5826_2021-03-11 | 3.36 | 42.43 | 6.79 | 383.85 | 81.13 | 15.73 | 3.26 |
| V3 | V3_6381_2021-03-11 | 3.36 | 42.43 | 6.79 | 383.85 | 81.13 | 15.73 | 3.26 |
| V3 | V3_5162_2021-03-11 | 3.36 | 42.43 | 6.79 | 383.85 | 81.13 | 15.73 | 3.26 |
| V3 | V3_3496_2021-03-11 | 3.36 | 42.43 | 6.79 | 383.85 | 81.13 | 15.73 | 3.26 |
| V3 | V3_2804_2021-03-11 | 3.36 | 42.43 | 6.79 | 383.85 | 81.13 | 15.73 | 3.26 |
| V3 | V3_5646_2021-03-11 | 3.36 | 42.43 | 6.79 | 383.85 | 81.13 | 15.73 | 3.26 |
| V3 | V3_5153_2021-03-11 | 3.36 | 42.43 | 6.79 | 383.85 | 81.13 | 15.73 | 3.26 |
| V3 | V3_8418_2021-03-11 | 3.36 | 42.43 | 6.79 | 383.85 | 81.13 | 15.73 | 3.26 |
| V3 | V3_1611_2021-03-11 | 3.36 | 42.43 | 6.79 | 383.85 | 81.13 | 15.73 | 3.26 |
| V3 | V3_1438_2021-03-11 | 3.36 | 42.43 | 6.79 | 383.85 | 81.13 | 15.73 | 3.26 |
| V3 | V3_5778_2021-03-11 | 3.36 | 42.43 | 6.79 | 383.85 | 81.13 | 15.73 | 3.26 |
| V3 | V3_2725_2021-03-11 | 3.36 | 42.43 | 6.79 | 383.85 | 81.13 | 15.73 | 3.26 |
| V3 | V3_1433_2021-03-11 | 3.36 | 42.43 | 6.79 | 383.85 | 81.13 | 15.73 | 3.26 |
| V3 | V3_7492_2021-03-11 | 3.36 | 42.43 | 6.79 | 383.85 | 81.13 | 15.73 | 3.26 |
| V3 | V3_903_2021-03-11 | 3.36 | 42.43 | 6.79 | 383.85 | 81.13 | 15.73 | 3.26 |
| V3 | V3_6302_2021-03-11 | 3.36 | 42.43 | 6.79 | 383.85 | 81.13 | 15.73 | 3.26 |
| V3 | V3_8516_2021-03-11 | 3.36 | 42.43 | 6.79 | 383.85 | 81.13 | 15.73 | 3.26 |
| V3 | V3_2323_2021-03-11 | 3.36 | 42.43 | 6.79 | 383.85 | 81.13 | 15.73 | 3.26 |
| V3 | V3_4456_2021-03-11 | 3.36 | 42.43 | 6.79 | 383.85 | 81.13 | 15.73 | 3.26 |
| V3 | V3_8054_2021-03-11 | 3.36 | 42.43 | 6.79 | 383.85 | 81.13 | 15.73 | 3.26 |
| V3 | V3_7720_2021-03-11 | 3.36 | 42.43 | 6.79 | 383.85 | 81.13 | 15.73 | 3.26 |
| V3 | V3_1709_2021-03-11 | 3.36 | 42.43 | 6.79 | 383.85 | 81.13 | 15.73 | 3.26 |
| V3 | V3_5518_2021-03-11 | 3.36 | 42.43 | 6.79 | 383.85 | 81.13 | 15.73 | 3.26 |
| V3 | V3_2863_2021-03-11 | 3.36 | 42.43 | 6.79 | 383.85 | 81.13 | 15.73 | 3.26 |
| V3 | V3_4106_2021-03-11 | 3.36 | 42.43 | 6.79 | 383.85 | 81.13 | 15.73 | 3.26 |
| V3 | V3_7152_2021-03-11 | 3.36 | 42.43 | 6.79 | 383.85 | 81.13 | 15.73 | 3.26 |
| V3 | V3_3695_2021-03-11 | 3.36 | 42.43 | 6.79 | 383.85 | 81.13 | 15.73 | 3.26 |
| V3 | V3_2059_2021-03-11 | 3.36 | 42.43 | 6.79 | 383.85 | 81.13 | 15.73 | 3.26 |
| V3 | V3_4148_2021-03-11 | 3.36 | 42.43 | 6.79 | 383.85 | 81.13 | 15.73 | 3.26 |
| V3 | V3_8330_2021-03-11 | 3.36 | 42.43 | 6.79 | 383.85 | 81.13 | 15.73 | 3.26 |
| V3 | V3_5822_2021-03-11 | 3.36 | 42.43 | 6.79 | 383.85 | 81.13 | 15.73 | 3.26 |
| V3 | V3_3093_2021-03-11 | 3.36 | 42.43 | 6.79 | 383.85 | 81.13 | 15.73 | 3.26 |
| V3 | V3_6933_2021-03-11 | 3.36 | 42.43 | 6.79 | 383.85 | 81.13 | 15.73 | 3.26 |
| V3 | V3_3377_2021-03-11 | 3.36 | 42.43 | 6.79 | 383.85 | 81.13 | 15.73 | 3.26 |
| V3 | V3_3190_2021-03-11 | 3.36 | 42.43 | 6.79 | 383.85 | 81.13 | 15.73 | 3.26 |
| V3 | V3_3256_2021-03-11 | 3.36 | 42.43 | 6.79 | 383.85 | 81.13 | 15.73 | 3.26 |
| V3 | V3_1607_2021-03-11 | 3.36 | 42.43 | 6.79 | 383.85 | 81.13 | 15.73 | 3.26 |
| V3 | V3_2648_2021-03-11 | 3.36 | 42.43 | 6.79 | 383.85 | 81.13 | 15.73 | 3.26 |
| V3 | V3_3197_2021-03-11 | 3.36 | 42.43 | 6.79 | 383.85 | 81.13 | 15.73 | 3.26 |
| V3 | V3_672_2021-03-11 | 3.36 | 42.43 | 6.79 | 383.85 | 81.13 | 15.73 | 3.26 |
| V3 | V3_1414_2021-03-11 | 3.36 | 42.43 | 6.79 | 383.85 | 81.13 | 15.73 | 3.26 |
| V3 | V3_5191_2021-03-11 | 3.36 | 42.43 | 6.79 | 383.85 | 81.13 | 15.73 | 3.26 |
| V3 | V3_1107_2021-03-11 | 3.36 | 42.43 | 6.79 | 383.85 | 81.13 | 15.73 | 3.26 |
| V3 | V3_5231_2021-03-11 | 3.36 | 42.43 | 6.79 | 383.85 | 81.13 | 15.73 | 3.26 |
| V3 | V3_7188_2021-03-11 | 3.36 | 42.43 | 6.79 | 383.85 | 81.13 | 15.73 | 3.26 |
| V3 | V3_5554_2021-03-11 | 3.36 | 42.43 | 6.79 | 383.85 | 81.13 | 15.73 | 3.26 |
| V3 | V3_2955_2021-03-11 | 3.36 | 42.43 | 6.79 | 383.85 | 81.13 | 15.73 | 3.26 |
| V3 | V3_5400_2021-03-11 | 3.36 | 42.43 | 6.79 | 383.85 | 81.13 | 15.73 | 3.26 |
| V3 | V3_5687_2021-03-11 | 3.36 | 42.43 | 6.79 | 383.85 | 81.13 | 15.73 | 3.26 |
| V3 | V3_7468_2021-03-11 | 3.36 | 42.43 | 6.79 | 383.85 | 81.13 | 15.73 | 3.26 |
| V3 | V3_6839_2021-03-11 | 3.36 | 42.43 | 6.79 | 383.85 | 81.13 | 15.73 | 3.26 |
| V3 | V3_8247_2021-03-11 | 3.36 | 42.43 | 6.79 | 383.85 | 81.13 | 15.73 | 3.26 |
| V3 | V3_1229_2021-03-11 | 3.36 | 42.43 | 6.79 | 383.85 | 81.13 | 15.73 | 3.26 |
| V3 | V3_2118_2021-03-11 | 3.36 | 42.43 | 6.79 | 383.85 | 81.13 | 15.73 | 3.26 |
| V3 | V3_5223_2021-03-11 | 3.36 | 42.43 | 6.79 | 383.85 | 81.13 | 15.73 | 3.26 |
| V3 | V3_6481_2021-03-11 | 3.36 | 42.43 | 6.79 | 383.85 | 81.13 | 15.73 | 3.26 |
| V3 | V3_7836_2021-03-11 | 3.36 | 42.43 | 6.79 | 383.85 | 81.13 | 15.73 | 3.26 |
| V3 | V3_5316_2021-03-11 | 3.36 | 42.43 | 6.79 | 383.85 | 81.13 | 15.73 | 3.26 |
| V3 | V3_5631_2021-03-11 | 3.36 | 42.43 | 6.79 | 383.85 | 81.13 | 15.73 | 3.26 |
| V3 | V3_546_2021-03-11 | 3.36 | 42.43 | 6.79 | 383.85 | 81.13 | 15.73 | 3.26 |
| V3 | V3_2121_2021-03-11 | 3.36 | 42.43 | 6.79 | 383.85 | 81.13 | 15.73 | 3.26 |
| V3 | V3_2773_2021-03-11 | 3.36 | 42.43 | 6.79 | 383.85 | 81.13 | 15.73 | 3.26 |
| V3 | V3_8369_2021-03-11 | 3.36 | 42.43 | 6.79 | 383.85 | 81.13 | 15.73 | 3.26 |
| V3 | V3_4232_2021-03-11 | 3.36 | 42.43 | 6.79 | 383.85 | 81.13 | 15.73 | 3.26 |
| V3 | V3_7537_2021-03-11 | 3.36 | 42.43 | 6.79 | 383.85 | 81.13 | 15.73 | 3.26 |
| V3 | V3_4727_2021-03-11 | 3.36 | 42.43 | 6.79 | 383.85 | 81.13 | 15.73 | 3.26 |
| V3 | V3_2851_2021-03-11 | 3.36 | 42.43 | 6.79 | 383.85 | 81.13 | 15.73 | 3.26 |
| V3 | V3_97_2021-03-11 | 3.36 | 42.43 | 6.79 | 383.85 | 81.13 | 15.73 | 3.26 |
| V3 | V3_3891_2021-03-11 | 3.36 | 42.43 | 6.79 | 383.85 | 81.13 | 15.73 | 3.26 |
| V3 | V3_7718_2021-03-11 | 3.36 | 42.43 | 6.79 | 383.85 | 81.13 | 15.73 | 3.26 |
| V3 | V3_4976_2021-03-11 | 3.36 | 42.43 | 6.79 | 383.85 | 81.13 | 15.73 | 3.26 |
| V3 | V3_2468_2021-03-11 | 3.36 | 42.43 | 6.79 | 383.85 | 81.13 | 15.73 | 3.26 |
| V3 | V3_151_2021-03-11 | 3.36 | 42.43 | 6.79 | 383.85 | 81.13 | 15.73 | 3.26 |
| V3 | V3_7333_2021-03-11 | 3.36 | 42.43 | 6.79 | 383.85 | 81.13 | 15.73 | 3.26 |
| V3 | V3_3638_2021-03-11 | 3.36 | 42.43 | 6.79 | 383.85 | 81.13 | 15.73 | 3.26 |
| V3 | V3_3784_2021-03-11 | 3.36 | 42.43 | 6.79 | 383.85 | 81.13 | 15.73 | 3.26 |
| V3 | V3_3176_2021-03-11 | 3.36 | 42.43 | 6.79 | 383.85 | 81.13 | 15.73 | 3.26 |
| V3 | V3_1891_2021-03-11 | 3.36 | 42.43 | 6.79 | 383.85 | 81.13 | 15.73 | 3.26 |
| V3 | V3_122_2021-03-11 | 3.36 | 42.43 | 6.79 | 383.85 | 81.13 | 15.73 | 3.26 |
| V3 | V3_1066_2021-03-11 | 3.36 | 42.43 | 6.79 | 383.85 | 81.13 | 15.73 | 3.26 |
| V3 | V3_5233_2021-03-11 | 3.36 | 42.43 | 6.79 | 383.85 | 81.13 | 15.73 | 3.26 |
| V3 | V3_3682_2021-03-11 | 3.36 | 42.43 | 6.79 | 383.85 | 81.13 | 15.73 | 3.26 |
| V3 | V3_2718_2021-03-11 | 3.36 | 42.43 | 6.79 | 383.85 | 81.13 | 15.73 | 3.26 |

| Parcel | vp_min | vp_mean | vp_sd | kNDVI_S2_min | NDWI_S2_mean | NIRv_S2_sd | NDVI_S2_min |
|---|---|---|---|---|---|---|---|
| V4 | 306.22 | 820.44 | 238.88 | 0.04 | −0.50 | 710.20 | 0.19 |
| V4 | 306.22 | 820.44 | 238.88 | 0.08 | −0.55 | 652.03 | 0.29 |
| V4 | 306.22 | 820.44 | 238.88 | 0.05 | −0.54 | 687.50 | 0.24 |
| V4 | 306.22 | 820.44 | 238.88 | 0.06 | −0.55 | 676.94 | 0.24 |
| V4 | 306.22 | 820.44 | 238.88 | 0.07 | −0.54 | 716.85 | 0.25 |
| V4 | 306.22 | 820.44 | 238.88 | 0.06 | −0.51 | 697.04 | 0.24 |
| V4 | 306.22 | 820.44 | 238.88 | 0.07 | −0.54 | 707.38 | 0.25 |
| V4 | 306.22 | 820.44 | 238.88 | 0.06 | −0.54 | 673.34 | 0.24 |
| V4 | 306.22 | 820.44 | 238.88 | 0.06 | −0.54 | 657.22 | 0.24 |
| V4 | 306.22 | 820.44 | 238.88 | 0.05 | −0.52 | 683.35 | 0.24 |
| V4 | 306.22 | 820.44 | 238.88 | 0.06 | −0.54 | 718.92 | 0.24 |
| V4 | 306.22 | 820.44 | 238.88 | 0.06 | −0.53 | 731.07 | 0.24 |
| V4 | 306.22 | 820.44 | 238.88 | 0.06 | −0.54 | 706.71 | 0.25 |
| V4 | 306.22 | 820.44 | 238.88 | 0.07 | −0.54 | 701.32 | 0.26 |
| V4 | 306.22 | 820.44 | 238.88 | 0.07 | −0.55 | 639.30 | 0.26 |
| V4 | 306.22 | 820.44 | 238.88 | 0.07 | −0.54 | 710.09 | 0.26 |
| V4 | 306.22 | 820.44 | 238.88 | 0.06 | −0.54 | 707.24 | 0.25 |
| V4 | 306.22 | 820.44 | 238.88 | 0.06 | −0.55 | 673.41 | 0.24 |
| V4 | 306.22 | 820.44 | 238.88 | 0.07 | −0.54 | 712.88 | 0.26 |
| V4 | 306.22 | 820.44 | 238.88 | 0.07 | −0.55 | 615.69 | 0.26 |
| V4 | 306.22 | 820.44 | 238.88 | 0.07 | −0.53 | 660.84 | 0.25 |
| V4 | 306.22 | 820.44 | 238.88 | 0.09 | −0.55 | 674.48 | 0.30 |
| V4 | 306.22 | 820.44 | 238.88 | 0.07 | −0.55 | 639.30 | 0.25 |
| V4 | 306.22 | 820.44 | 238.88 | 0.07 | −0.55 | 703.07 | 0.26 |
| V4 | 306.22 | 820.44 | 238.88 | 0.06 | −0.54 | 679.33 | 0.25 |
| V4 | 306.22 | 820.44 | 238.88 | 0.05 | −0.54 | 673.34 | 0.24 |
| V4 | 306.22 | 820.44 | 238.88 | 0.09 | −0.50 | 654.67 | 0.31 |
| V4 | 306.22 | 820.44 | 238.88 | 0.06 | −0.55 | 676.94 | 0.24 |
| V4 | 306.22 | 820.44 | 238.88 | 0.06 | −0.54 | 703.35 | 0.24 |
| V4 | 306.22 | 820.44 | 238.88 | 0.06 | −0.55 | 699.19 | 0.25 |
| V4 | 306.22 | 820.44 | 238.88 | 0.06 | −0.54 | 629.33 | 0.24 |
| V4 | 306.22 | 820.44 | 238.88 | 0.06 | −0.51 | 697.04 | 0.24 |
| V4 | 306.22 | 820.44 | 238.88 | 0.07 | −0.54 | 682.71 | 0.27 |
| V4 | 306.22 | 820.44 | 238.88 | 0.07 | −0.54 | 663.96 | 0.26 |
| V4 | 306.22 | 820.44 | 238.88 | 0.07 | −0.54 | 704.78 | 0.25 |
| V4 | 306.22 | 820.44 | 238.88 | 0.08 | −0.54 | 656.21 | 0.28 |
| V4 | 306.22 | 820.44 | 238.88 | 0.05 | −0.53 | 722.14 | 0.23 |
| V4 | 306.22 | 820.44 | 238.88 | 0.06 | −0.54 | 691.16 | 0.25 |
| V4 | 306.22 | 820.44 | 238.88 | 0.05 | −0.54 | 704.52 | 0.23 |
| V4 | 306.22 | 820.44 | 238.88 | 0.06 | −0.54 | 713.88 | 0.24 |
| V4 | 306.22 | 820.44 | 238.88 | 0.06 | −0.55 | 675.94 | 0.24 |
| V4 | 306.22 | 820.44 | 238.88 | 0.06 | −0.53 | 660.03 | 0.24 |
| V4 | 306.22 | 820.44 | 238.88 | 0.06 | −0.54 | 684.33 | 0.25 |
| V4 | 306.22 | 820.44 | 238.88 | 0.07 | −0.54 | 682.54 | 0.26 |
| V4 | 306.22 | 820.44 | 238.88 | 0.06 | −0.54 | 697.56 | 0.24 |
| V4 | 306.22 | 820.44 | 238.88 | 0.07 | −0.54 | 695.79 | 0.26 |
| V4 | 306.22 | 820.44 | 238.88 | 0.07 | −0.54 | 663.96 | 0.25 |
| V4 | 306.22 | 820.44 | 238.88 | 0.06 | −0.54 | 705.23 | 0.25 |
| V4 | 306.22 | 820.44 | 238.88 | 0.06 | −0.54 | 705.23 | 0.25 |
| V4 | 306.22 | 820.44 | 238.88 | 0.06 | −0.54 | 716.92 | 0.24 |
| V4 | 306.22 | 820.44 | 238.88 | 0.07 | −0.55 | 682.92 | 0.26 |
| V4 | 306.22 | 820.44 | 238.88 | 0.06 | −0.54 | 629.33 | 0.24 |
| V4 | 306.22 | 820.44 | 238.88 | 0.06 | −0.54 | 679.33 | 0.25 |
| V4 | 306.22 | 820.44 | 238.88 | 0.06 | −0.54 | 723.58 | 0.25 |
| V4 | 306.22 | 820.44 | 238.88 | 0.06 | −0.54 | 705.81 | 0.25 |
| V4 | 306.22 | 820.44 | 238.88 | 0.06 | −0.53 | 654.76 | 0.24 |
| V4 | 306.22 | 820.44 | 238.88 | 0.06 | −0.54 | 706.09 | 0.24 |
| V4 | 306.22 | 820.44 | 238.88 | 0.07 | −0.54 | 695.13 | 0.26 |
| V4 | 306.22 | 820.44 | 238.88 | 0.06 | −0.54 | 698.72 | 0.25 |
| V4 | 306.22 | 820.44 | 238.88 | 0.06 | −0.54 | 634.92 | 0.25 |
| V4 | 306.22 | 820.44 | 238.88 | 0.07 | −0.54 | 693.13 | 0.26 |
| V4 | 306.22 | 820.44 | 238.88 | 0.06 | −0.54 | 677.89 | 0.25 |
| V4 | 306.22 | 820.44 | 238.88 | 0.05 | −0.54 | 713.86 | 0.24 |
| V4 | 306.22 | 820.44 | 238.88 | 0.04 | −0.50 | 710.20 | 0.19 |
| V4 | 306.22 | 820.44 | 238.88 | 0.06 | −0.54 | 716.92 | 0.24 |
| V4 | 306.22 | 820.44 | 238.88 | 0.06 | −0.51 | 729.85 | 0.25 |
| V4 | 306.22 | 820.44 | 238.88 | 0.06 | −0.52 | 683.35 | 0.24 |
| V4 | 306.22 | 820.44 | 238.88 | 0.05 | −0.54 | 706.71 | 0.25 |
| V4 | 306.22 | 820.44 | 238.88 | 0.03 | −0.47 | 689.37 | 0.17 |
| V4 | 306.22 | 820.44 | 238.88 | 0.06 | −0.54 | 705.11 | 0.25 |
| V4 | 306.22 | 820.44 | 238.88 | 0.05 | −0.54 | 730.90 | 0.23 |
| V4 | 306.22 | 820.44 | 238.88 | 0.06 | −0.54 | 585.08 | 0.25 |
| V4 | 306.22 | 820.44 | 238.88 | 0.09 | −0.56 | 522.32 | 0.29 |
| V4 | 306.22 | 820.44 | 238.88 | 0.08 | −0.55 | 644.65 | 0.28 |
| V4 | 306.22 | 820.44 | 238.88 | 0.07 | −0.54 | 689.27 | 0.25 |
| V4 | 306.22 | 820.44 | 238.88 | 0.07 | −0.55 | 684.32 | 0.26 |
| V4 | 306.22 | 820.44 | 238.88 | 0.07 | −0.49 | 687.33 | 0.27 |
| V4 | 306.22 | 820.44 | 238.88 | 0.07 | −0.54 | 690.96 | 0.27 |
| V4 | 306.22 | 820.44 | 238.88 | 0.07 | −0.55 | 633.95 | 0.27 |
| V4 | 306.22 | 820.44 | 238.88 | 0.06 | −0.55 | 669.94 | 0.24 |
| V4 | 306.22 | 820.44 | 238.88 | 0.07 | −0.54 | 675.77 | 0.26 |
| V4 | 306.22 | 820.44 | 238.88 | 0.06 | −0.54 | 659.24 | 0.25 |
| V4 | 306.22 | 820.44 | 238.88 | 0.06 | −0.54 | 695.94 | 0.24 |
| V4 | 306.22 | 820.44 | 238.88 | 0.06 | −0.54 | 706.09 | 0.24 |
| V4 | 306.22 | 820.44 | 238.88 | 0.06 | −0.54 | 713.88 | 0.24 |
| V4 | 306.22 | 820.44 | 238.88 | 0.06 | −0.54 | 693.10 | 0.25 |
| V4 | 306.22 | 820.44 | 238.88 | 0.07 | −0.54 | 687.11 | 0.26 |
| V4 | 306.22 | 820.44 | 238.88 | 0.09 | −0.55 | 573.26 | 0.30 |
| V4 | 306.22 | 820.44 | 238.88 | 0.06 | −0.54 | 664.93 | 0.25 |
| V4 | 306.22 | 820.44 | 238.88 | 0.07 | −0.54 | 684.56 | 0.26 |
| V4 | 306.22 | 820.44 | 238.88 | 0.06 | −0.55 | 711.87 | 0.25 |
| V4 | 306.22 | 820.44 | 238.88 | 0.05 | −0.54 | 659.01 | 0.24 |
| V4 | 306.22 | 820.44 | 238.88 | 0.06 | −0.55 | 680.30 | 0.24 |
| V4 | 306.22 | 820.44 | 238.88 | 0.06 | −0.53 | 651.90 | 0.24 |
| V4 | 306.22 | 820.44 | 238.88 | 0.07 | −0.54 | 584.56 | 0.26 |
| V4 | 306.22 | 820.44 | 238.88 | 0.06 | −0.54 | 681.81 | 0.25 |
| V4 | 306.22 | 820.44 | 238.88 | 0.05 | −0.53 | 654.06 | 0.24 |
| V4 | 306.22 | 820.44 | 238.88 | 0.07 | −0.54 | 706.59 | 0.27 |
| V4 | 306.22 | 820.44 | 238.88 | 0.06 | −0.53 | 661.20 | 0.25 |
| V4 | 306.22 | 820.44 | 238.88 | 0.07 | −0.53 | 595.27 | 0.25 |
| X2 | 331.41 | 853.50 | 297.74 | 0.11 | −0.56 | 453.04 | 0.33 |
| X2 | 331.41 | 853.50 | 297.74 | 0.10 | −0.58 | 453.52 | 0.31 |
| X2 | 331.41 | 853.50 | 297.74 | 0.09 | −0.58 | 435.25 | 0.30 |
| X2 | 331.41 | 853.50 | 297.74 | 0.10 | −0.57 | 446.33 | 0.32 |
| X2 | 331.41 | 853.50 | 297.74 | 0.10 | −0.57 | 446.33 | 0.32 |
| X2 | 331.41 | 853.50 | 297.74 | 0.10 | −0.57 | 486.44 | 0.32 |
| X2 | 331.41 | 853.50 | 297.74 | 0.09 | −0.58 | 435.25 | 0.30 |
| X2 | 331.41 | 853.50 | 297.74 | 0.10 | −0.57 | 480.70 | 0.32 |
| X2 | 331.41 | 853.50 | 297.74 | 0.10 | −0.56 | 495.84 | 0.32 |
| X2 | 331.41 | 853.50 | 297.74 | 0.10 | −0.56 | 474.91 | 0.31 |
| X2 | 331.41 | 853.50 | 297.74 | 0.09 | −0.57 | 435.44 | 0.29 |
| X2 | 331.41 | 853.50 | 297.74 | 0.09 | −0.56 | 419.94 | 0.30 |
| X2 | 331.41 | 853.50 | 297.74 | 0.10 | −0.57 | 450.16 | 0.32 |
| X2 | 331.41 | 853.50 | 297.74 | 0.08 | −0.58 | 433.90 | 0.29 |
| X2 | 331.41 | 853.50 | 297.74 | 0.09 | −0.56 | 419.19 | 0.30 |
| X2 | 331.41 | 853.50 | 297.74 | 0.09 | −0.57 | 456.65 | 0.31 |
| X2 | 331.41 | 853.50 | 297.74 | 0.08 | −0.58 | 428.20 | 0.28 |
| X2 | 331.41 | 853.50 | 297.74 | 0.10 | −0.57 | 486.44 | 0.32 |
| X2 | 331.41 | 853.50 | 297.74 | 0.10 | −0.56 | 495.84 | 0.32 |
| X2 | 331.41 | 853.50 | 297.74 | 0.11 | −0.56 | 453.04 | 0.33 |
| X2 | 331.41 | 853.50 | 297.74 | 0.08 | −0.56 | 389.20 | 0.29 |
| X2 | 331.41 | 853.50 | 297.74 | 0.09 | −0.58 | 402.47 | 0.30 |
| X2 | 331.41 | 853.50 | 297.74 | 0.08 | −0.56 | 389.20 | 0.29 |
| X2 | 331.41 | 853.50 | 297.74 | 0.08 | −0.58 | 426.26 | 0.28 |
| X2 | 331.41 | 853.50 | 297.74 | 0.09 | −0.57 | 450.87 | 0.30 |
| X2 | 331.41 | 853.50 | 297.74 | 0.11 | −0.56 | 464.18 | 0.33 |
| X2 | 331.41 | 853.50 | 297.74 | 0.08 | −0.56 | 504.15 | 0.28 |
| X2 | 331.41 | 853.50 | 297.74 | 0.10 | −0.57 | 446.33 | 0.32 |
| X2 | 331.41 | 853.50 | 297.74 | 0.09 | −0.57 | 452.07 | 0.31 |
| X2 | 331.41 | 853.50 | 297.74 | 0.12 | −0.54 | 505.74 | 0.35 |
| X2 | 331.41 | 853.50 | 297.74 | 0.11 | −0.56 | 464.18 | 0.33 |
| X2 | 331.41 | 853.50 | 297.74 | 0.09 | −0.57 | 450.87 | 0.30 |
| X2 | 331.41 | 853.50 | 297.74 | 0.10 | −0.56 | 449.37 | 0.32 |
| X2 | 331.41 | 853.50 | 297.74 | 0.10 | −0.57 | 454.50 | 0.31 |
| X2 | 331.41 | 853.50 | 297.74 | 0.11 | −0.58 | 453.04 | 0.33 |
| X2 | 331.41 | 853.50 | 297.74 | 0.08 | −0.56 | 438.36 | 0.29 |
| X2 | 331.41 | 853.50 | 297.74 | 0.08 | −0.58 | 448.45 | 0.28 |
| X2 | 331.41 | 853.50 | 297.74 | 0.09 | −0.57 | 436.44 | 0.29 |
| X2 | 331.41 | 853.50 | 297.74 | 0.09 | −0.56 | 467.02 | 0.30 |
| X2 | 331.41 | 853.50 | 297.74 | 0.08 | −0.58 | 451.77 | 0.29 |
| X2 | 331.41 | 853.50 | 297.74 | 0.09 | −0.57 | 457.56 | 0.30 |
| X2 | 331.41 | 853.50 | 297.74 | 0.10 | −0.56 | 474.91 | 0.31 |
| X2 | 331.41 | 853.50 | 297.74 | 0.10 | −0.56 | 454.72 | 0.32 |
| X2 | 331.41 | 853.50 | 297.74 | 0.08 | −0.56 | 504.15 | 0.28 |
| X2 | 331.41 | 853.50 | 297.74 | 0.09 | −0.56 | 419.94 | 0.30 |
| X2 | 331.41 | 853.50 | 297.74 | 0.09 | −0.57 | 450.87 | 0.30 |
| X2 | 331.41 | 853.50 | 297.74 | 0.09 | −0.56 | 467.02 | 0.30 |
| X2 | 331.41 | 853.50 | 297.74 | 0.09 | −0.57 | 457.56 | 0.30 |
| X2 | 331.41 | 853.50 | 297.74 | 0.08 | −0.56 | 438.36 | 0.29 |
| X2 | 331.41 | 853.50 | 297.74 | 0.09 | −0.56 | 419.19 | 0.30 |
| X2 | 331.41 | 853.50 | 297.74 | 0.09 | −0.57 | 457.56 | 0.30 |
| X2 | 331.41 | 853.50 | 297.74 | 0.09 | −0.53 | 444.62 | 0.30 |
| X2 | 331.41 | 853.50 | 297.74 | 0.10 | −0.56 | 495.84 | 0.32 |
| X2 | 331.41 | 853.50 | 297.74 | 0.09 | −0.57 | 452.07 | 0.31 |
| X2 | 331.41 | 853.50 | 297.74 | 0.09 | −0.57 | 456.65 | 0.31 |
| X2 | 331.41 | 853.50 | 297.74 | 0.08 | −0.58 | 448.45 | 0.26 |
| X2 | 331.41 | 853.50 | 297.74 | 0.09 | −0.57 | 456.65 | 0.31 |
| X2 | 331.41 | 853.50 | 297.74 | 0.08 | −0.58 | 390.91 | 0.28 |
| X2 | 331.41 | 853.50 | 297.74 | 0.10 | −0.57 | 446.33 | 0.32 |
| X2 | 331.41 | 853.50 | 297.74 | 0.08 | −0.58 | 448.45 | 0.28 |
| X2 | 331.41 | 853.50 | 297.74 | 0.10 | −0.57 | 480.70 | 0.32 |
| X2 | 331.41 | 853.50 | 297.74 | 0.09 | −0.57 | 436.44 | 0.29 |
| X2 | 331.41 | 853.50 | 297.74 | 0.09 | −0.56 | 419.19 | 0.30 |
| X2 | 331.41 | 853.50 | 297.74 | 0.10 | −0.58 | 453.52 | 0.31 |
| X2 | 331.41 | 853.50 | 297.74 | 0.09 | −0.53 | 444.52 | 0.30 |
| X2 | 331.41 | 853.50 | 297.74 | 0.10 | −0.57 | 454.50 | 0.31 |
| X2 | 331.41 | 853.50 | 297.74 | 0.09 | −0.56 | 457.02 | 0.30 |
| X2 | 331.41 | 853.50 | 297.74 | 0.11 | −0.56 | 454.18 | 0.33 |
| X2 | 331.41 | 853.50 | 297.74 | 0.09 | −0.56 | 395.11 | 0.31 |
| X2 | 331.41 | 853.50 | 297.74 | 0.09 | −0.57 | 457.56 | 0.30 |
| X2 | 331.41 | 853.50 | 297.74 | 0.08 | −0.58 | 426.26 | 0.26 |
| X2 | 331.41 | 853.50 | 297.74 | 0.09 | −0.53 | 444.62 | 0.30 |
| X2 | 331.41 | 853.50 | 297.74 | 0.08 | −0.58 | 454.37 | 0.28 |
| X2 | 331.41 | 853.50 | 297.74 | 0.09 | −0.54 | 505.12 | 0.29 |
| X2 | 331.41 | 853.50 | 297.74 | 0.10 | −0.57 | 446.33 | 0.32 |
| X2 | 331.41 | 853.50 | 297.74 | 0.10 | −0.56 | 424.26 | 0.32 |
| X2 | 331.41 | 853.50 | 297.74 | 0.10 | −0.58 | 424.26 | 0.32 |
| X2 | 331.41 | 853.50 | 297.74 | 0.08 | −0.55 | 465.56 | 0.28 |
| X2 | 331.41 | 853.50 | 297.74 | 0.10 | −0.56 | 464.72 | 0.32 |
| X2 | 331.41 | 853.50 | 297.74 | 0.09 | −0.56 | 471.44 | 0.30 |
| X2 | 331.41 | 853.50 | 297.74 | 0.09 | −0.57 | 457.56 | 0.30 |
| X2 | 331.41 | 853.50 | 297.74 | 0.09 | −0.57 | 457.56 | 0.30 |
| X2 | 331.41 | 853.50 | 297.74 | 0.09 | −0.58 | 448.25 | 0.31 |
| X2 | 331.41 | 853.50 | 297.74 | 0.09 | −0.58 | 448.25 | 0.31 |
| X2 | 331.41 | 853.50 | 297.74 | 0.09 | −0.56 | 395.11 | 0.31 |
| X2 | 331.41 | 853.50 | 297.74 | 0.11 | −0.56 | 464.18 | 0.33 |
| X2 | 331.41 | 853.50 | 297.74 | 0.09 | −0.56 | 471.44 | 0.30 |
| X2 | 331.41 | 853.50 | 297.74 | 0.08 | −0.58 | 428.20 | 0.28 |
| X2 | 331.41 | 853.50 | 297.74 | 0.09 | −0.58 | 402.47 | 0.30 |
| X2 | 331.41 | 853.50 | 297.74 | 0.10 | −0.56 | 493.37 | 0.32 |
| X2 | 331.41 | 853.50 | 297.74 | 0.09 | −0.56 | 431.04 | 0.30 |
| X2 | 331.41 | 853.50 | 297.74 | 0.09 | −0.56 | 419.94 | 0.30 |
| X2 | 331.41 | 853.50 | 297.74 | 0.10 | −0.56 | 495.84 | 0.32 |
| X2 | 331.41 | 853.50 | 297.74 | 0.09 | −0.57 | 450.87 | 0.30 |
| X2 | 331.41 | 853.50 | 297.74 | 0.08 | −0.58 | 454.37 | 0.28 |
| X2 | 331.41 | 853.50 | 297.74 | 0.08 | −0.58 | 454.37 | 0.28 |
| X2 | 331.41 | 853.50 | 297.74 | 0.10 | −0.55 | 453.95 | 0.32 |
| X2 | 331.41 | 853.50 | 297.74 | 0.08 | −0.58 | 451.77 | 0.29 |
| X2 | 331.41 | 853.50 | 297.74 | 0.08 | −0.58 | 426.26 | 0.28 |
| X2 | 331.41 | 853.50 | 297.74 | 0.10 | −0.56 | 495.84 | 0.32 |
| | Predicted Target Agricultural Data for Unsample Parcel | | | | | | |
| V3 | 550.16 | 843.22 | 130.07 | 0.40 | −0.64 | 395.10 | 0.66 |
| V3 | 550.16 | 843.22 | 130.07 | 0.30 | −0.61 | 322.12 | 0.56 |
| V3 | 550.16 | 843.22 | 130.07 | 0.42 | −0.64 | 411.25 | 0.67 |
| V3 | 550.16 | 843.22 | 130.07 | 0.43 | −0.64 | 315.17 | 0.68 |
| V3 | 550.16 | 843.22 | 130.07 | 0.46 | −0.67 | 436.56 | 0.71 |
| V3 | 550.16 | 843.22 | 130.07 | 0.44 | −0.65 | 350.38 | 0.69 |
| V3 | 550.16 | 843.22 | 130.07 | 0.47 | −0.67 | 428.22 | 0.71 |
| V3 | 550.16 | 843.22 | 130.07 | 0.41 | −0.65 | 371.39 | 0.66 |
| V3 | 550.16 | 843.22 | 130.07 | 0.41 | −0.64 | 367.26 | 0.66 |
| V3 | 550.16 | 843.22 | 130.07 | 0.38 | −0.63 | 247.40 | 0.63 |
| V3 | 550.16 | 843.22 | 130.07 | 0.49 | −0.67 | 414.95 | 0.73 |
| V3 | 550.16 | 843.22 | 130.07 | 0.40 | −0.65 | 524.24 | 0.65 |
| V3 | 550.16 | 843.22 | 130.07 | 0.43 | −0.64 | 393.34 | 0.68 |
| V3 | 550.16 | 843.22 | 130.07 | 0.39 | −0.67 | 452.46 | 0.64 |
| V3 | 550.16 | 843.22 | 130.07 | 0.42 | −0.63 | 391.85 | 0.67 |
| V3 | 550.16 | 843.22 | 130.07 | 0.44 | −0.65 | 441.04 | 0.68 |
| V3 | 550.16 | 843.22 | 130.07 | 0.43 | −0.67 | 514.14 | 0.68 |
| V3 | 550.16 | 843.22 | 130.07 | 0.42 | −0.65 | 314.15 | 0.67 |
| V3 | 550.16 | 843.22 | 130.07 | 0.39 | −0.64 | 518.50 | 0.64 |
| V3 | 550.16 | 843.22 | 130.07 | 0.41 | −0.66 | 444.86 | 0.66 |
| V3 | 550.16 | 843.22 | 130.07 | 0.40 | −0.63 | 288.92 | 0.65 |
| V3 | 550.16 | 843.22 | 130.07 | 0.40 | −0.63 | 396.20 | 0.65 |
| V3 | 550.16 | 843.22 | 130.07 | 0.41 | −0.66 | 444.86 | 0.66 |
| V3 | 550.16 | 843.22 | 130.07 | 0.39 | −0.65 | 402.05 | 0.64 |
| V3 | 550.16 | 843.22 | 130.07 | 0.23 | −0.56 | 211.59 | 0.48 |
| V3 | 550.16 | 843.22 | 130.07 | 0.45 | −0.65 | 434.00 | 0.70 |
| V3 | 550.16 | 843.22 | 130.07 | 0.46 | −0.65 | 417.24 | 0.71 |
| V3 | 550.16 | 843.22 | 130.07 | 0.43 | −0.64 | 393.34 | 0.68 |
| V3 | 550.16 | 843.22 | 130.07 | 0.42 | −0.64 | 424.31 | 0.67 |
| V3 | 550.16 | 843.22 | 130.07 | 0.49 | −0.66 | 388.87 | 0.73 |
| V3 | 550.16 | 843.22 | 130.07 | 0.26 | −0.56 | 265.90 | 0.51 |
| V3 | 550.16 | 843.22 | 130.07 | 0.49 | −0.56 | 386.01 | 0.73 |
| V3 | 550.16 | 843.22 | 130.07 | 0.39 | −0.64 | 518.50 | 0.65 |
| V3 | 550.16 | 843.22 | 130.07 | 0.29 | −0.57 | 318.02 | 0.54 |
| V3 | 550.16 | 843.22 | 130.07 | 0.42 | −0.64 | 376.67 | 0.67 |
| V3 | 550.16 | 843.22 | 130.07 | 0.48 | −0.66 | 529.38 | 0.72 |
| V3 | 550.16 | 843.22 | 130.07 | 0.23 | −0.55 | 321.77 | 0.48 |
| V3 | 550.16 | 843.22 | 130.07 | 0.34 | −0.60 | 323.79 | 0.59 |
| V3 | 550.16 | 843.22 | 130.07 | 0.44 | −0.65 | 350.38 | 0.69 |
| V3 | 550.16 | 843.22 | 130.07 | 0.47 | −0.56 | 287.23 | 0.71 |
| V3 | 550.16 | 843.22 | 130.07 | 0.42 | −0.64 | 361.42 | 0.67 |
| V3 | 550.16 | 843.22 | 130.07 | 0.43 | −0.65 | 367.49 | 0.68 |
| V3 | 550.16 | 843.22 | 130.07 | 0.41 | −0.64 | 367.26 | 0.66 |
| V3 | 550.16 | 843.22 | 130.07 | 0.43 | −0.65 | 413.55 | 0.68 |
| V3 | 550.16 | 843.22 | 130.07 | 0.43 | −0.55 | 349.28 | 0.58 |
| V3 | 550.16 | 843.22 | 130.07 | 0.43 | −0.65 | 413.55 | 0.68 |
| V3 | 550.16 | 843.22 | 130.07 | 0.29 | −0.58 | 323.40 | 0.54 |
| V3 | 550.16 | 843.22 | 130.07 | 0.41 | −0.66 | 364.12 | 0.66 |
| V3 | 550.16 | 843.22 | 130.07 | 0.42 | −0.64 | 497.12 | 0.67 |
| V3 | 550.16 | 843.22 | 130.07 | 0.40 | −0.65 | 265.64 | 0.55 |
| V3 | 550.16 | 843.22 | 130.07 | 0.41 | −0.63 | 465.00 | 0.66 |
| V3 | 550.16 | 843.22 | 130.07 | 0.49 | −0.67 | 418.49 | 0.73 |
| V3 | 550.16 | 843.22 | 130.07 | 0.42 | −0.64 | 497.12 | 0.67 |
| V3 | 550.16 | 843.22 | 130.07 | 0.49 | −0.66 | 388.87 | 0.73 |
| V3 | 550.16 | 843.22 | 130.07 | 0.51 | −0.67 | 283.25 | 0.75 |
| V3 | 550.16 | 843.22 | 130.07 | 0.50 | −0.67 | 625.69 | 0.74 |
| V3 | 550.16 | 843.22 | 130.07 | 0.37 | −0.62 | 374.77 | 0.52 |
| V3 | 550.16 | 843.22 | 130.07 | 0.46 | −0.65 | 469.67 | 0.71 |
| V3 | 550.16 | 843.22 | 130.07 | 0.43 | −0.66 | 535.58 | 0.68 |
| V3 | 550.16 | 843.22 | 130.07 | 0.42 | −0.65 | 336.94 | 0.57 |
| V3 | 550.16 | 843.22 | 130.07 | 0.39 | −0.65 | 402.05 | 0.64 |
| V3 | 550.16 | 843.22 | 130.07 | 0.25 | −0.53 | 203.99 | 0.50 |
| V3 | 550.16 | 843.22 | 130.07 | 0.39 | −0.65 | 402.05 | 0.54 |
| V3 | 550.16 | 843.22 | 130.07 | 0.42 | −0.64 | 361.42 | 0.67 |
| V3 | 550.16 | 843.22 | 130.07 | 0.39 | −0.67 | 452.46 | 0.54 |
| V3 | 550.16 | 843.22 | 130.07 | 0.50 | −0.69 | 394.12 | 0.74 |
| V3 | 550.16 | 843.22 | 130.07 | 0.41 | −0.63 | 531.81 | 0.66 |
| V3 | 550.16 | 843.22 | 130.07 | 0.44 | −0.65 | 441.04 | 0.68 |
| V3 | 550.16 | 843.22 | 130.07 | 0.40 | −0.65 | 524.24 | 0.65 |
| V3 | 550.16 | 843.22 | 130.07 | 0.42 | −0.63 | 391.85 | 0.67 |
| V3 | 550.16 | 843.22 | 130.07 | 0.50 | −0.67 | 460.83 | 0.74 |
| V3 | 550.16 | 843.22 | 130.07 | 0.38 | −0.64 | 346.96 | 0.63 |
| V3 | 550.16 | 843.22 | 130.07 | 0.29 | −0.57 | 318.02 | 0.54 |
| V3 | 550.16 | 843.22 | 130.07 | 0.42 | −0.64 | 430.51 | 0.67 |
| V3 | 550.16 | 843.22 | 130.07 | 0.39 | −0.67 | 452.46 | 0.54 |
| V3 | 550.16 | 843.22 | 130.07 | 0.38 | −0.64 | 346.96 | 0.63 |
| V3 | 550.16 | 843.22 | 130.07 | 0.40 | −0.62 | 349.01 | 0.66 |
| V3 | 550.16 | 843.22 | 130.07 | 0.50 | −0.67 | 460.83 | 0.74 |
| V3 | 550.16 | 843.22 | 130.07 | 0.42 | −0.64 | 361.42 | 0.67 |
| V3 | 550.16 | 843.22 | 130.07 | 0.40 | −0.65 | 524.24 | 0.66 |
| V3 | 550.16 | 843.22 | 130.07 | 0.46 | −0.67 | 399.19 | 0.71 |
| V3 | 550.16 | 843.22 | 130.07 | 0.36 | −0.66 | 251.85 | 0.62 |
| V3 | 550.16 | 843.22 | 130.07 | 0.44 | −0.66 | 477.77 | 0.69 |
| V3 | 550.16 | 843.22 | 130.07 | 0.50 | −0.56 | 448.26 | 0.74 |
| V3 | 550.16 | 843.22 | 130.07 | 0.41 | −0.64 | 325.87 | 0.66 |
| V3 | 550.16 | 843.22 | 130.07 | 0.49 | −0.67 | 414.95 | 0.73 |
| V3 | 550.16 | 843.22 | 130.07 | 0.23 | −0.54 | 226.55 | 0.48 |
| V3 | 550.16 | 843.22 | 130.07 | 0.45 | −0.68 | 420.87 | 0.70 |
| V3 | 550.16 | 843.22 | 130.07 | 0.45 | −0.64 | 414.54 | 0.69 |
| V3 | 550.16 | 843.22 | 130.07 | 0.42 | −0.64 | 283.34 | 0.67 |
| V3 | 550.16 | 843.22 | 130.07 | 0.41 | −0.64 | 367.26 | 0.66 |
| V3 | 550.16 | 843.22 | 130.07 | 0.50 | −0.67 | 625.69 | 0.74 |
| V3 | 550.16 | 843.22 | 130.07 | 0.47 | −0.68 | 568.04 | 0.71 |
| V3 | 550.16 | 843.22 | 130.07 | 0.42 | −0.63 | 422.13 | 0.67 |
| V3 | 550.16 | 843.22 | 130.07 | 0.46 | −0.66 | 367.45 | 0.70 |
| V3 | 550.16 | 843.22 | 130.07 | 0.36 | −0.62 | 311.97 | 0.61 |
| V3 | 550.16 | 843.22 | 130.07 | 0.46 | −0.65 | 469.67 | 0.74 |
| V3 | 550.16 | 843.22 | 130.07 | 0.39 | −0.67 | 452.46 | 0.65 |
| V3 | 550.16 | 843.22 | 130.07 | 0.41 | −0.64 | 397.63 | 0.66 |
| V3 | 550.16 | 843.22 | 130.07 | 0.40 | −0.63 | 440.23 | 0.65 |

As shown in Table 7, the testing of the two machine learning programs (catboost and a featureless, mean, baseline model) are shown. This testing can include but is not limited to the use of the following equations.

Mean Squared Error (MSE)

The Mean Squared Error is defined as

$$\frac{1}{n} {\sum }_{i = 1}^{n} {{w}_{i} ( {t}_{i} - {r}_{i} )}^{2} \qquad Equation 1$$

Mean Absolute Error (MAE)

The Mean Absolute Error is defined as

$$\frac{1}{n} {\sum }_{i = 1}^{n} {w}_{i} \vert {t}_{i} - {r}_{i} \vert \qquad Equation 2$$

Mean Absolute Percent Error (MAPE)

The Mean Absolute Percent Error is defined as

$$\frac{1}{n} {\sum }_{i = 1}^{n} {w}_{i} \vert \frac{{t}_{i} - {r}_{i}}{{t}_{i}} \vert \qquad Equation 3$$

Bias

The Bias is defined as

$$\frac{1}{n} {\sum }_{i = 1}^{n} {w}_{i} ( {t}_{i} - {r}_{i} ) \qquad Equation 4$$

Relative Squared Error (RSE)

The Relative Squared Error is defined as

$$\frac{{\sum }_{i = 1}^{n} {( {t}_{i} - {r}_{i} )}^{2}}{{\sum }_{i = 1}^{n} {( {t}_{i} - \underline{t} )}^{2}} \qquad Equation 5$$

The performance of the trained CatBoost model demonstrates learning from data in comparison with the performance of the featureless, mean, baseline model.

TABLE 7
Process and Model Performance Between Programs

| | | | | | relative | adjusted |
|---|---|---|---|---|---|---|
| | | | | | difference | p-value of |
| | | | | | with | Dunn's |
| program | mse | mape | mae | rmse | featureless | test |
| featureless | 116.67 | 71.47% | 8.35 | 9.58 | n/a | n/a |
| catboost | 84.53 | 37.77% | 6.22 | 7.41 | −27.55% | 0.03 |

Referring next to Table 8, as shown the additional mean of the analysis points are the data for 280 is shown as the observed standard deviation and model mean and the model standard deviation. The same thing is shown for plot 283 as X2 and plot 282 as V3. As there is no observed mean at V3, the modeled mean is 16.06 and the modeled standard deviation is 0.07.

TABLE 8
Modeled Data v. Sampled Data

| | observed | observed | modeled | modeled |
|---|---|---|---|---|
| code | mean | sd | mean | sd |
| V4 | 11.06 | 1.34 | 12.31 | 0.61 |
| X2 | 29.34 | 1.12 | 27.64 | 0.47 |
| V3 | n/a | n/a | 16.06 | 0.07 |

Referring next to FIGS. 14-16, Bulbosa 7PB55 cultivar seeds (7PB55) are planted between the months of September-December in Northern and Central California. Seeds are planted in the alleyways between specialty crop rows using conventional site preparation methods and equipment and/or planted underneath the wine grape crop using specialized seeding equipment. 7PB55 emerges as grass upon receipt of sufficient moisture from rain, fog, and/or a combination of both after seeding and enters an annual cycle in which it emerges on average from October through November, grows from December through March, and goes dormant from April through September. During the periods of emergence, growth, and senescence, 7PB55's water consumption requirements are satisfied by average Northern and Central California climate rainfall conditions without irrigation. It grows to less than 6 inches in height on average, warranting 0-1 mows per year in specialty crop systems. During its dormancy period it consumes no water and displays no living ground cover, while biomass remains intact in living root systems that knit together over consecutive years.

TABLE 9
Poa Bulbosa Alleyway Cover Crop

| Site | V4 | X2 |
|---|---|---|
| Installation date | Dec. 4, 2020 | Oct. 23, 2019 |
| Farm acres | 4.77 | 1.5 |
| Seeded acres | 1.735 | 1 |
| Total seed applied (lbs) | 700 | |
| Seed rate (lbs/acre) | 403.564 | |
| Seed rate goal (lbs/acre) | 434 | 550 |
| Total seed goal (lbs) | 752.7927272 | 550.0000001 |
| PLS goal (PLS/acre) | 90000000 | 114000000 |
| Observed biomass (g/0.1 m2) | 0.536 | 6.89 |
| in year 1 | | |
| Sampling date in year 1 | 2021 Apr. 6 | 2021 Mar. 20 |
| Observed biomass (g/0.1 m2) | 6.65 | 4.25 |
| in year 2 | | |
| Sampling date in year 2 | 2022 Mar. 2 | 2021 Mar. 20 |

In accordance with example implementations, this cultivar can be planted in alleyways between commodity crops. In some parcels in some portions of alleyways, target agricultural data such as carbon content can be sampled and determined. Without actually sampling other portions of parcels or other portions of alleyways, the systems and methods of the present disclosure can be used to provide modeled data with the sample or different alleyways of the same or different parcels. This modeled data can be used to determine the amount of carbon being sequestered by the cover crop.

Accordingly, methods for sequestering carbon are provided. The methods can include: identifying a parcel having commodity crops planted in rows, the commodity crops having a dormant season; defining the alleyways between the rows of commodity crops; planting a cover crop within the alleyways, the cover crops having growing season within the dormant season of the commodity crop, and a dormant season within the growing season of the commodity crop; and increasing the carbon content of the parcel during the dormant season of the commodity crop with the cover crop. The commodity crop can be a vineyard or orchard. The cover crop can be Poa bulbosa or hybrid of same. The cover crop can be retained between commodity crop growing seasons.

Systems for agricultural carbon sequestration are also provided. They system processing circuitry can be configured to: identify one or more land parcels for agricultural parameter optimization, the land parcels having commodity crops in rows with alleyways therebetween; and determine carbon per acre of parcel of at least one land parcel during a first time period without sampling the one land parcel, the determining can include: collecting target agricultural data for at least one other land parcel, the target agricultural data including total carbon and the collecting comprising determining sampling sites and compiling target agricultural data associated with the sampled sites; collecting predictive parcel data associated with the target agricultural data; and processing both the compiled target agricultural data and the predictive parcel data to generate target agricultural data for unsampled parcel portions, the processing can include: selecting a predictive parcel data subset from the predictive parcel data, the selecting comprising identifying impactful predictive parcel data for selection; determining sample sites for the one land parcel and additional sample sites for the other land parcel; associating the predictive parcel data subset with both the sample sites for the one land parcel and the additional sample sites for the other land parcel to form a target agricultural data model; and applying the model to the carbon data associated with the sampled sites to determine the total carbon of the at least one land parcel.

### Glossary

TABLE 10

| | Description | Unit | Source |
|---|---|---|---|
| depth (cm) | depth where soil sample is | cm | field |
| | taken from | | |
| fresh weight (g) | fresh weight of soil sample | g | field |
| dry weight (g) | dry weight of soil sample | g | lab |
| toc % | total organic carbon | % of mass | lab |
| bd (g/cm3) | bulk density | g of soil per | lab |
| | | cubic | |
| | | cm of soil | |
| bd_p50_15_30 | bulk density | g of soil per | Polaris |
| | | cubic | |
| | | cm of soil | |
| Amount (mg) | amount of soil for elemental | mg | lab |
| | analysis | | |
| (mg) N | mass of nitrogen | mg | lab |
| % N | nitrogen | % of mass | lab |
| (mg) C | mass of carbon | mg | lab |
| % C | carbon | % of mass | lab |
| C:N Ratio | carbon-to-nitrogen ratio | — | lab |

TABLE 11

| | Description | Unit | Equation | Source |
|---|---|---|---|---|
| prcp_mean | mean precipitation | mm | | DayMet |
| prcp_max | maximum | mm | | DayMet |
| | precipitation | | | |
| prcp_sd | standard deviation | mm | | DayMet |
| | pf precipitation | | | |
| srad_max | maximum shortwave | W/m2 | | DayMet |
| | radiation | | | |
| srad_sd | standard deviation | W/m2 | | DayMet |
| | shortwave radiation | | | |
| tmax_mean | mean maximum | degrees | | DayMet |
| | temperature | C. | | |
| tmax_sd | standard deviation | degrees | | DayMet |
| | of maximum | C. | | |
| | temperature | | | |
| vp_min | minimum water | Pa | | DayMet |
| | vapor pressure | | | |
| vp_mean | mean water vapor | Pa | | DayMet |
| | pressure | | | |
| vp_sd | standard deviation | Pa | | DayMet |
| | vapor pressure | | | |
| kNDVI_S2_min | minimum kernalized | | kNDVI = tanh | Sentinel-2 |
| | Normalized | | (NDVI\hat{ }2) | |
| | Difference | | | |
| | Vegetation Index | | | |
| NDWI_S2_mean | mean Normalized | | NDWI = (green − | Sentinel-2 |
| | Difference Water | | near infrared)/ | |
| | Index | | (green + near | |
| | | | infrared) | |
| NIRv_S2_sd | standard deviation | | | Sentinel-2 |
| | Near Infrared value | | | |
| NDVI_S2_min | minimum Normalized | | NDVI = (near | Sentinel-2 |
| | Difference | | infrared − red)/ | |
| | Vegetation Index | | (near infrared + | |
| | | | red) | |

TABLE 12

| | Description | Unit | Equation |
|---|---|---|---|
| mse | mean squared error; the lower the better | | $\frac{1}{n} {\sum }_{i = 1}^{n} {{w}_{i} ( {t}_{i} - {r}_{i} )}^{2}$ |
| mape | mean absolute percent error; the lower the better | | $\frac{1}{n} {\sum }_{i = 1}^{n} {w}_{i} \vert \frac{{t}_{i} - {r}_{i}}{{t}_{i}} \vert$ |
| mae | mean absolute error; the lower the better | | $\frac{1}{n} {\sum }_{i = 1}^{n} {w}_{i} \vert {t}_{i} - {r}_{i} \vert$ |
| rmse | root-mean-square error; the lower the better | | $\frac{{\sum }_{i = 1}^{n} {( {t}_{i} - {r}_{i} )}^{2}}{{\sum }_{i = 1}^{n} {( {t}_{i} - {t}_{-} )}^{2}}$ |
| relative | Measures the relative difference | % | (MSE_non- |
| distance | in average square errors between | | baseline- |
| with | baseline and non-baseline models; | | MSE_baseline)/ |
| featureless | the lower the better | | MSE_baseline |
| adjusted p- | The distribution of errors of | — | |
| value of | baseline and non-baseline models | | |
| Dunn’s | were compared with a Kruskal- | | |
| test | Wallis test followed by a post- | | |
| | hoc Dunn’s test of which the p- | | |
| | value was adjusted for multiple | | |
| | comparison through the | | |
| | Bonferroni′s correction; | | |
| | the lower the better | | |

TABLE 13

| | Description | Unit |
|---|---|---|
| Code | code for area of interest | |
| observed mean | mean of values from field samples | tons total carbon |
| | | per acre |
| observed sd | standard deviation of values from | tons total carbon |
| | field samples | per acre |
| modeled mean | mean of modeled values | tons total carbon |
| | | per acre |
| modeled sd | standard deviation of modeled | tons total carbon |
| | values | per acre |

TABLE 14
Candidate Predictor Variables

| column name | description |
|---|---|
| Code | code |
| sample_description | sample description |
| CI_min | minimum of the Coloration Index |
| CI_mean | mean of the Coloration Index |
| CI_max | maximum of the Coloration Index |
| CI_sd | standard deviation of the |
| | Coloration Index |
| MCARI_min | minimum of the Modified |
| | Chlorophyll Absorption in |
| | Reflectance Index |
| MCARI_mean | mean of the Modified |
| | Chlorophyll Absorption in |
| | Reflectance Index |
| MCARI_max | maximum of the Modified |
| | Chlorophyll Absorption in |
| | Reflectance Index |
| MCARI_sd | standard deviation of the |
| | Modified Chlorophyll Absorption in |
| | Reflectance Index |
| NDWI_min | minimum of the Normalized |
| | Difference Water Index |
| NDWI_mean | mean of the Normalized |
| | Difference Water Index |
| NDWI_max | maximum of the Normalized |
| | Difference Water Index |
| NDWI_sd | standard deviation of the |
| | Normalized Difference Water Index |
| VARI_min | minimum of the Visible |
| | Atmospherically Resistant Index |
| VARI_mean | mean of the Visible |
| | Atmospherically Resistant Index |
| VARI_max | maximum of the Visible |
| | Atmospherically Resistant Index |
| VARI_sd | standard deviation of the |
| | Visible Atmospherically Resistant |
| | Index |
| kNDVI_min | minimum of the kernelized |
| | Normalized Difference Vegetation |
| | Index |
| kNDVI_mean | mean of the kernelized |
| | Normalized Difference Vegetation |
| | Index |
| kNDVI_max | maximum of the kernelized |
| | Normalized Difference Vegetation |
| | Index |
| kNDVI_sd | standard deviation of the |
| | kernelized Normalized Difference |
| | Vegetation Index |
| NDVI_min | minimum of the Normalized |
| | Difference Vegetation Index |
| NDVI_mean | mean of the Normalized |
| | Difference Vegetation Index |
| NDVI_max | maximum of the Normalized |
| | Difference Vegetation Index |
| NDVI_sd | standard deviation of the |
| | Normalized Difference Vegetation |
| | Index |
| SAVI_min | minimum of the soil Adjusted |
| | Vegetation Index |
| SAVI_mean | mean of the soil Adjusted |
| | Vegetation Index |
| SAVI_max | maximum of the soil Adjusted |
| | Vegetation Index |
| SAVI_sd | standard deviation of the soil |
| | Adjusted Vegetation Index |
| GNDVI_min | minimum of the Green |
| | Normalized Difference Vegetation |
| | Index |
| GNDVI_mean | mean of the Green |
| | Normalized Difference Vegetation |
| | Index |
| GNDVI_max | maximum of the Green |
| | Normalized Difference Vegetation |
| | Index |
| GNDVI_sd | standard deviation of the |
| | Green Normalized Difference |
| | Vegetation Index |
| ENDVI_min | minimum of the Enhanced |
| | Normalized Difference Vegetation |
| | Index |
| ENDVI_mean | mean of the Enhanced |
| | Normalized Difference Vegetation |
| | Index |
| ENDVI_max | maximum of the Enhanced |
| | Normalized Difference Vegetation |
| | Index |
| ENDVI_sd | standard deviation of the |
| | Enhanced Normalized Difference |
| | Vegetation Index |
| LCI_min | minimum of the Leaf |
| | Chlorophyl Index |
| LCI_mean | mean of the Leaf |
| | Chlorophyl Index |
| LCI_max | maximum of the Leaf |
| | Chlorophyl Index |
| LCI_sd | standard deviation of the Leaf |
| | Chlorophyl Index |
| EVI_min | minimum of the Enhanced |
| | Vegetation Index |
| EVI_mean | mean of the Enhanced |
| | Vegetation Index |
| EVI_max | maximum of the Enhanced |
| | Vegetation Index |
| EVI_sd | standard deviation of the |
| | Enhanced Vegetation Index |
| NIRv_min | minimum of the Near Infrared |
| | value |
| NIRv_mean | mean of the Near Infrared |
| | value |
| NIRv_max | maximum of the Near Infrared |
| | value |
| NIRv_sd | standard deviation of the Near |
| | Infrared value |
| GLI_min | minimum of the Green Leaf Index |
| GLI_mean | mean of the Green Leaf Index |
| GLI_max | maximum of the Green Leaf Index |
| GLI_sd | standard deviation of the |
| | Green Leaf Index |
| CVI_min | minimum of the Chlorophyll |
| | vegetation index |
| CVI_mean | mean of the Chlorophyll |
| | vegetation index |
| CVI_max | maximum of the Chlorophyll |
| | vegetation index |
| CVI_sd | standard deviation of the |
| | Chlorophyll vegetation index |
| CI_Rededge_min | minimum of the Coloration |
| | Index_Rededge |
| CI_Rededge_mean | mean of the Coloration |
| | Index_Rededge |
| CI_Rededge_max | maximum of the Coloration |
| | Index_Rededge |
| CI_Rededge_sd | standard deviation of the |
| | Coloration Index_Rededge |
| NDRE_min | minimum of the Normalized |
| | Difference RedEdge |
| NDRE_mean | mean of the Normalized |
| | Difference RedEdge |
| NDRE_max | maximum of the Normalized |
| | Difference RedEdge |
| NDRE_sd | standard deviation of the |
| | Normalized Difference RedEdge |
| System | system type |
| Crop | crop type |
| Age | years since initial planting |
| prcp_mean | mean of the precipitation |
| prcp_max | maximum of the precipitation |
| prcp_sd | standard deviation of the |
| | precipitation |
| srad_min | minimum of the shortwave |
| | radiation |
| srad_mean | mean of the shortwave |
| | radiation |
| srad_max | maximum of the shortwave |
| | radiation |
| srad_sd | standard deviation of the |
| | shortwave radiation |
| tmax_min | minimum of the maximum of |
| | the temperature |
| tmax_mean | mean of the maximum of |
| | the temperature |
| tmax_max | maximum of the maximum of |
| | the temperature |
| tmax_sd | standard deviation of the |
| | maximum of the temperature |
| tmin_min | minimum of the minimum of |
| | the temperature |
| tmin_mean | mean of the minimum of |
| | the temperature |
| tmin_max | maximum of the minimum of |
| | the temperature |
| tmin_sd | standard deviation of the |
| | minimum of the temperature |
| vp_min | minimum of the vapor pressure |
| vp_mean | mean of the vapor pressure |
| vp_max | maximum of the vapor pressure |
| vp_sd | standard deviation of the |
| | vapor pressure |
| sunlight_hr_mean | mean of the hours of sunlight |
| sunlight_hr_sum | sum hours of sunlight |
| SCI_S2_min | minimum of the SCI from |
| | Sentinel-2 |
| SCI_S2_mean | mean of the SCI from |
| | Sentinel-2 |
| SCI_S2_max | maximum of the SCI from |
| | Sentinel-2 |
| SCI_S2_sd | standard deviation of the SCI |
| | from Sentinel-2 |
| CI_S2_min | minimum of the Coloration |
| | Index from Sentinel-2 |
| CI_S2_mean | mean of the Coloration |
| | Index from Sentinel-2 |
| CI_S2_max | maximum of the Coloration |
| | Index from Sentinel-2 |
| CI_S2_sd | standard deviation of the |
| | Coloration Index from Sentinel-2 |
| NDWI_S2_min | minimum of the Normalized |
| | Difference Water Index from |
| | Sentinel-2 |
| NDWI_S2_mean | mean of the Normalized |
| | Difference Water Index from |
| | Sentinel-2 |
| NDWI_S2_max | maximum of the Normalized |
| | Difference Water Index from |
| | Sentinel-2 |
| NDWI_S2_sd | standard deviation of the |
| | Normalized Difference Water Index |
| | from Sentinel-2 |
| VARI_S2_min | minimum of the Visible |
| | Atmospherically Resistant Index |
| | from Sentinel-2 |
| VARI_S2_mean | mean of the Visible |
| | Atmospherically Resistant Index |
| | from Sentinel-2 |
| VARI_S2_max | maximum of the Visible |
| | Atmospherically Resistant Index |
| | from Sentinel-2 |
| VARI_S2_sd | standard deviation of the |
| | Visible Atmospherically Resistant |
| | Index from Sentinel-2 |
| kNDVI_S2_min | minimum of the kernelized |
| | Normalized Difference Vegetation |
| | Index from Sentinel-2 |
| kNDVI_S2_mean | mean of the kernelized |
| | Normalized Difference Vegetation |
| | Index from Sentinel-2 |
| kNDVI_S2_max | maximum of the kernelized |
| | Normalized Difference Vegetation |
| | Index from Sentinel-2 |
| kNDVI_S2_sd | standard deviation of the |
| | kernelized Normalized Difference |
| | Vegetation Index from Sentinel-2 |
| SAVI_S2_min | minimum of the soil Adjusted |
| | Vegetation Index from Sentinel-2 |
| SAVI_S2_mean | mean of the soil Adjusted |
| | Vegetation Index from Sentinel-2 |
| SAVI_S2_max | maximum of the soil Adjusted |
| | Vegetation Index from Sentinel-2 |
| SAVI_S2_sd | standard deviation of the soil |
| | Adjusted Vegetation Index from |
| | Sentinel-2 |
| ENDVI_S2_min | minimum of the Enhanced |
| | Normalized Difference Vegetation |
| | Index from Sentinel-2 |
| ENDVI_S2_mean | mean of the Enhanced |
| | Normalized Difference Vegetation |
| | Index from Sentinel-2 |
| ENDVI_S2_max | maximum of the Enhanced |
| | Normalized Difference Vegetation |
| | Index from Sentinel-2 |
| ENDVI_S2_sd | standard deviation of the |
| | Enhanced Normalized Difference |
| | Vegetation Index from Sentinel-2 |
| LCI_S2_B5_min | minimum of the Leaf |
| | Chlorophyl Index from Sentinel-2 |
| | (using band 5) |
| LCI_S2_B5_mean | mean of the Leaf |
| | Chlorophyl Index from Sentinel-2 |
| | (using band 5) |
| LCI_S2_B5_max | maximum of the Leaf |
| | Chlorophyl Index from Sentinel-2 |
| | (using band 5) |
| LCI_S2_B5_sd | standard deviation of the Leaf |
| | Chlorophyl Index from Sentinel-2 |
| | (using band 5) |
| LCI_S2_B6_min | minimum of the Leaf |
| | Chlorophyl Index from Sentinel-2 |
| | (using band 6) |
| LCI_S2_B6_mean | mean of the Leaf |
| | Chlorophyl Index from Sentinel-2 |
| | (using band 6) |
| LCI_S2_B6_max | maximum of the Leaf |
| | Chlorophyl Index from Sentinel-2 |
| | (using band 6) |
| LCI_S2_B6_sd | standard deviation of the Leaf |
| | Chlorophyl Index from Sentinel-2 |
| | (using band 6) |
| LCI_S2_B7_min | minimum of the Leaf |
| | Chlorophyl Index from Sentinel-2 |
| | (using band 7) |
| LCI_S2_B7_mean | mean of the Leaf |
| | Chlorophyl Index from Sentinel-2 |
| | (using band 7) |
| LCI_S2_B7_max | maximum of the Leaf |
| | Chlorophyl Index from Sentinel-2 |
| | (using band 7) |
| LCI_S2_B7_sd | standard deviation of the Leaf |
| | Chlorophyl Index from Sentinel-2 |
| | (using band 7) |
| NIRv_S2_min | minimum of the Near Infrared |
| | value from Sentinel-2 |
| NIRv_S2_mean | mean of the Near Infrared |
| | value from Sentinel-2 |
| NIRv_S2_max | maximum of the Near Infrared |
| | value from Sentinel-2 |
| NIRv_S2_sd | standard deviation of the Near |
| | Infrared value from Sentinel-2 |
| GLI_S2_min | minimum of the Green Leaf |
| | Index from Sentinel-2 |
| GLI_S2_mean | mean of the Green Leaf |
| | Index from Sentinel-2 |
| GLI_S2_max | maximum of the Green Leaf |
| | Index from Sentinel-2 |
| GLI_S2_sd | standard deviation of the |
| | Green Leaf Index from Sentinel-2 |
| CVI_S2_min | minimum of the Chlorophyll |
| | vegetation index from Sentinel-2 |
| CVI_S2_mean | mean of the Chlorophyll |
| | vegetation index from Sentinel-2 |
| CVI_S2_max | maximum of the Chlorophyll |
| | vegetation index from Sentinel-2 |
| CVI_S2_sd | standard deviation of the |
| | Chlorophyll vegetation index from |
| | Sentinel-2 |
| CI_Rededge_S2_B5_min | minimum of the Coloration |
| | Index_Rededge from Sentinel-2 |
| | (using band 5) |
| CI_Rededge_S2_B5_mean | mean of the Coloration |
| | Index_Rededge from Sentinel-2 |
| | (using band 5) |
| CI_Rededge_S2_B5_max | maximum of the Coloration |
| | Index_Rededge from Sentinel-2 |
| | (using band 5) |
| CI_Rededge_S2_B5_sd | standard deviation of the |
| | Coloration Index_Rededge from |
| | Sentinel-2 (using band 5) |
| CI_Rededge_S2_B6_min | minimum of the Coloration |
| | Index_Rededge from Sentinel-2 |
| | (using band 6) |
| CI_Rededge_S2_B6_mean | mean of the Coloration |
| | Index_Rededge from Sentinel-2 |
| | (using band 6) |
| CI_Rededge_S2_B6_max | maximum of the Coloration |
| | Index_Rededge from Sentinel-2 |
| | (using band 6) |
| CI_Rededge_S2_B6_sd | standard deviation of the |
| | Coloration Index_Rededge from |
| | Sentinel-2 (using band 6) |
| CI_Rededge_S2_B7_min | minimum of the Coloration |
| | Index_Rededge from Sentinel-2 |
| | (using band 7) |
| CI_Rededge_S2_B7_mean | mean of the Coloration |
| | Index_Rededge from Sentinel-2 |
| | (using band 7) |
| CI_Rededge_S2_B7_max | maximum of the Coloration |
| | Index_Rededge from Sentinel-2 |
| | (using band 7) |
| CI_Rededge_S2_B7_sd | standard deviation of the |
| | Coloration Index_Rededge from |
| | Sentinel-2 (using band 7) |
| NDRE_S2_B5_min | minimum of the Normalized |
| | Difference RedEdge from Sentinel-2 |
| | (using band 5) |
| NDRE_S2_B5_mean | mean of the Normalized |
| | Difference RedEdge from Sentinel-2 |
| | (using band 5) |
| NDRE_S2_B5_max | maximum of the Normalized |
| | Difference RedEdge from Sentinel-2 |
| | (using band 5) |
| NDRE_S2_B5_sd | standard deviation of the |
| | Normalized Difference RedEdge |
| | from Sentinel-2 (using band 5) |
| NDRE_S2_B6_min | minimum of the Normalized |
| | Difference RedEdge from Sentinel-2 |
| | (using band 6) |
| NDRE_S2_B6_mean | mean of the Normalized |
| | Difference RedEdge from Sentinel-2 |
| | (using band 6) |
| NDRE_S2_B6_max | maximum of the Normalized |
| | Difference RedEdge from Sentinel-2 |
| | (using band 6) |
| NDRE_S2_B6_sd | standard deviation of the |
| | Normalized Difference RedEdge |
| | from Sentinel-2 (using band 6) |
| NDRE_S2_B7_min | minimum of the Normalized |
| | Difference RedEdge from Sentinel-2 |
| | (using band 7) |
| NDRE_S2_B7_mean | mean of the Normalized |
| | Difference RedEdge from Sentinel-2 |
| | (using band 7) |
| NDRE_S2_B7_max | maximum of the Normalized |
| | Difference RedEdge from Sentinel-2 |
| | (using band 7) |
| NDRE_S2_B7_sd | standard deviation of the |
| | Normalized Difference RedEdge |
| | from Sentinel-2 (using band 7) |
| Three_BSI_Tian_S2_min | minimum of the Three-using |
| | Band Spectral Index from Sentinel-2 |
| Three_BSI_Tian_S2_mean | mean of the Three-using |
| | Band Spectral Index from Sentinel-2 |
| Three_BSI_Tian_S2_max | maximum of the Three-using |
| | Band Spectral Index from Sentinel-2 |
| Three_BSI_Tian_S2_sd | standard deviation of the |
| | Three-using Band Spectral Index |
| | from Sentinel-2 |
| mND_Verrelst_S2_max | maximum of the modified |
| | Normalized Difference from |
| | Sentinel-2 |
| MCARI_S2_min | minimum of the Modified |
| | Chlorophyll Absorption in |
| | Reflectance Index from Sentinel-2 |
| MCARI_S2_mean | mean of the Modified |
| | Chlorophyll Absorption in |
| | Reflectance Index from Sentinel-2 |
| MCARI_S2_max | maximum of the Modified |
| | Chlorophyll Absorption in |
| | Reflectance Index from Sentinel-2 |
| MCARI_S2_sd | standard deviation of the |
| | Modified Chlorophyll Absorption in |
| | Reflectance Index from Sentinel-2 |
| IRECI_S2_min | minimum of the Inverted Red- |
| | Edge Chlorophyll Index from |
| | Sentinel-2 |
| IRECI_S2_mean | mean of the Inverted Red- |
| | Edge Chlorophyll Index from |
| | Sentinel-2 |
| IRECI_S2_max | maximum of the Inverted Red- |
| | Edge Chlorophyll Index from |
| | Sentinel-2 |
| IRECI_S2_sd | standard deviation of the |
| | Inverted Red-Edge Chlorophyll |
| | Index from Sentinel-2 |
| NDMI_S2_min | minimum of the Normalized |
| | Difference Moisture Index from |
| | Sentinel-2 |
| NDMI_S2_mean | mean of the Normalized |
| | Difference Moisture Index from |
| | Sentinel-2 |
| NDMI_S2_max | maximum of the Normalized |
| | Difference Moisture Index from |
| | Sentinel-2 |
| NDMI_S2_sd | standard deviation of the |
| | Normalized Difference Moisture |
| | Index from Sentinel-2 |
| S2REP_min | minimum of the Sentinel-2 |
| | Red-Edge Position |
| S2REP_mean | mean of the Sentinel-2 |
| | Red-Edge Position |
| S2REP_max | maximum of the Sentinel-2 |
| | Red-Edge Position |
| S2REP_sd | standard deviation of the |
| | Sentinel-2 Red-Edge Position |
| SR_S2_min | minimum of the Simple Ratio |
| | from Sentinel-2 |
| SR_S2_mean | mean of the Simple Ratio |
| | from Sentinel-2 |
| SR_S2_max | maximum of the Simple Ratio |
| | from Sentinel-2 |
| SR_S2_sd | standard deviation of the |
| | Simple Ratio from Sentinel-2 |
| GNDVI_S2_min | minimum of the Green |
| | Normalized Difference Vegetation |
| | Index from Sentinel-2 |
| GNDVI_S2_mean | mean of the Green |
| | Normalized Difference Vegetation |
| | Index from Sentinel-2 |
| GNDVI_S2_max | maximum of the Green |
| | Normalized Difference Vegetation |
| | Index from Sentinel-2 |
| GNDVI_S2_sd | standard deviation of the |
| | Green Normalized Difference |
| | Vegetation Index from Sentinel-2 |
| NDVI_S2_min | minimum of the Normalized |
| | Difference Vegetation Index from |
| | Sentinel-2 |
| NDVI_S2_mean | mean of the Normalized |
| | Difference Vegetation Index from |
| | Sentinel-2 |
| NDVI_S2_max | maximum of the Normalized |
| | Difference Vegetation Index from |
| | Sentinel-2 |
| NDVI_S2_sd | standard deviation of the |
| | Normalized Difference Vegetation |
| | Index from Sentinel-2 |
| MSI_S2_min | minimum of the Moisture |
| | Stress Index from Sentinel-2 |
| MSI_S2_mean | mean of the Moisture |
| | Stress Index from Sentinel-2 |
| MSI_S2_max | maximum of the Moisture |
| | Stress Index from Sentinel-2 |
| MSI_S2_sd | standard deviation of the |
| | Moisture Stress Index from Sentinel-2 |
| EVI_S2_min | minimum of the Enhanced |
| | Vegetation Index from Sentinel-2 |
| EVI_S2_mean | mean of the Enhanced |
| | Vegetation Index from Sentinel-2 |
| EVI_S2_max | maximum of the Enhanced |
| | Vegetation Index from Sentinel-2 |
| EVI_S2_sd | standard deviation of the |
| | Enhanced Vegetation Index from |
| | Sentinel-2 |
| Taxorder | taxonomic order |
| taxsuborder | taxonomic suborder |
| Taxgrtgroup | taxonomic group |
| Taxsubgrp | taxonomic subgroup |
| Taxpartsize | taxonomic particle size |
| ksat_r | saturated hydraulic conductivity |
| awc_r | available water capacity |
| wthirdbar_r | volumetric content of soil |
| | water retained at a tension of ⅓ |
| | bar |
| wfifteenbar_r | volumetric content of soil |
| | water retained at a tension of 15 |
| | bars |
| kwfact | erodibility factor which |
| | quantifies the susceptibility of soil |
| | particles to detachment and |
| | movement by water |
| Kffact | erodibility factor which |
| | quantifies the susceptibility of soil |
| | particles to detachment by water |
| claytotal_r | proportion of clay particles |
| | (<0.002 mm) in the fine earth |
| | fraction |
| Musym | map unit symbol |
| ph_mean_0_5 | mean of the soil pH in H20 |
| | between 0 and 5 cm |
| clay_mean_0_5 | mean of the proportion of clay |
| | particles (<0.002 mm) in the fine |
| | earth fraction between 0 and 5 cm |
| sand_mean_0_5 | mean of the proportion of sand |
| | particles (>0.05 mm) in the fine |
| | earth fraction between 0 and 5 cm |
| silt_mean_0_5 | mean of the proportion of silt |
| | particles (≥0.002 mm and ≤0.05 |
| | mm) in the fine earth fraction |
| | between 0 and 5 cm |
| hb_mean_0_5 | mean of the bubbling pressure |
| | (Brooks-Corey) between 0 and 5 cm |
| n_mean_0_5 | mean of the measure of the |
| | pore size distribution (Van |
| | Genuchten) between 0 and 5 cm |
| alpha_mean_0_5 | mean of the scale parameter |
| | inversely proportional to mean of the |
| | pore diameter (Van Genuchten) |
| | between 0 and 5 cm |
| ksat_mean_0_5 | mean of the saturated |
| | hydraulic conductivity between 0 |
| | and 5 cm |
| theta_r_mean_0_5 | mean of the residual soil |
| | water content between 0 and 5 cm |
| theta_s_mean_0_5 | mean of the saturated soil |
| | water content between 0 and 5 cm |
| ph_mean_5_15 | mean of the soil pH in H20 |
| | between 5 and 15 cm |
| clay_mean_5_15 | mean of the proportion of clay |
| | particles (<0.002 mm) in the fine |
| | earth fraction between 5 and 15 cm |
| sand_mean_5_15 | mean of the proportion of sand |
| | particles (>0.05 mm) in the fine |
| | earth fraction between 5 and 15 cm |
| silt_mean_5_15 | mean of the proportion of silt |
| | particles (≥0.002 mm and ≤0.05 |
| | mm) in the fine earth fraction |
| | between 5 and 15 cm |
| hb_mean_5_15 | mean of the bubbling pressure |
| | (Brooks-Corey) between 5 and 15 cm |
| n_mean_5_15 | mean of the measure of the |
| | pore size distribution (Van |
| | Genuchten) between 5 and 15 cm |
| alpha_mean_5_15 | mean of the scale parameter |
| | inversely proportional to mean of the |
| | pore diameter (Van Genuchten) |
| | between 5 and 15 cm |
| ksat_mean_5_15 | mean of the saturated |
| | hydraulic conductivity between 5 |
| | and 15 cm |
| theta_r_mean_5_15 | mean of the residual soil |
| | water content between 5 and 15 cm |
| theta_s_mean_5_15 | mean of the saturated soil |
| | water content between 5 and 15 cm |
| ph_mean_15_30 | mean of the soil pH in H20 |
| | between 15 and 30 cm |
| clay_mean_15_30 | mean of the proportion of clay |
| | particles (<0.002 mm) in the fine |
| | earth fraction between 15 and 30 cm |
| sand_mean_15_30 | mean of the proportion of sand |
| | particles (>0.05 mm) in the fine |
| | earth fraction between 15 and 30 cm |
| silt_mean_15_30 | mean of the proportion of silt |
| | particles (≥0.002 mm and ≤0.05 |
| | mm) in the fine earth fraction |
| | between 15 and 30 cm |
| hb_mean_15_30 | mean of the bubbling pressure |
| | (Brooks-Corey) between 15 and 30 cm |
| n_mean_15_30 | mean of the measure of the |
| | pore size distribution (Van |
| | Genuchten) between 15 and 30 cm |
| alpha_mean_15_30 | mean of the scale parameter |
| | inversely proportional to mean of the |
| | pore diameter (Van Genuchten) |
| | between 15 and 30 cm |
| ksat_mean_15_30 | mean of the saturated |
| | hydraulic conductivity between 15 |
| | and 30 cm |
| theta_r_mean_15_30 | mean of the residual soil |
| | water content between 15 and 30 cm |
| theta_s_mean_15_30 | mean of the saturated soil |
| | water content between 15 and 30 cm |
| ph_mode_0_5 | mode of the soil pH in H20 |
| | between 0 and 5 cm |
| clay_mode_0_5 | mode of the proportion of clay |
| | particles (<0.002 mm) in the fine |
| | earth fraction between 0 and 5 cm |
| sand_mode_0_5 | mode of the proportion of sand |
| | particles (>0.05 mm) in the fine |
| | earth fraction between 0 and 5 cm |
| silt_mode_0_5 | mode of the proportion of silt |
| | particles (≥0.002 mm and ≤0.05 |
| | mm) in the fine earth fraction |
| | between 0 and 5 cm |
| hb_mode_0_5 | mode of the bubbling pressure |
| | (Brooks-Corey) between 0 and 5 cm |
| n_mode_0_5 | mode of the measure of the |
| | pore size distribution (Van |
| | Genuchten) between 0 and 5 cm |
| alpha_mode_0_5 | mode of the scale parameter |
| | inversely proportional to mean of the |
| | pore diameter (Van Genuchten) |
| | between 0 and 5 cm |
| ksat_mode_0_5 | mode of the saturated |
| | hydraulic conductivity between 0 |
| | and 5 cm |
| theta_r_mode_0_5 | mode of the residual soil |
| | water content between 0 and 5 cm |
| theta_s_mode_0_5 | mode of the saturated soil |
| | water content between 0 and 5 cm |
| ph_mode_5_15 | mode of the soil pH in H20 |
| | between 5 and 15 cm |
| clay_mode_5_15 | mode of the proportion of clay |
| | particles (<0.002 mm) in the fine |
| | earth fraction between 5 and 15 cm |
| sand_mode_5_15 | mode of the proportion of sand |
| | particles (>0.05 mm) in the fine |
| | earth fraction between 5 and 15 cm |
| silt_mode_5_15 | mode of the proportion of silt |
| | particles (≥0.002 mm and ≤0.05 |
| | mm) in the fine earth fraction |
| | between 5 and 15 cm |
| hb_mode_5_15 | mode of the bubbling pressure |
| | (Brooks-Corey) between 5 and 15 cm |
| n_mode_5_15 | mode of the measure of the |
| | pore size distribution (Van |
| | Genuchten) between 5 and 15 cm |
| alpha_mode_5_15 | mode of the scale parameter |
| | inversely proportional to mean of the |
| | pore diameter (Van Genuchten) |
| | between 5 and 15 cm |
| ksat_mode_5_15 | mode of the saturated |
| | hydraulic conductivity between 5 |
| | and 15 cm |
| theta_r_mode_5_15 | mode of the residual soil |
| | water content between 5 and 15 cm |
| theta_s_mode_5_15 | mode of the saturated soil |
| | water content between 5 and 15 cm |
| ph_mode_15_30 | mode of the soil pH in H20 |
| | between 15 and 30 cm |
| clay_mode_15_30 | mode of the proportion of clay |
| | particles (<0.002 mm) in the fine |
| | earth fraction between 15 and 30 cm |
| sand_mode_15_30 | mode of the proportion of sand |
| | particles (>0.05 mm) in the fine |
| | earth fraction between 15 and 30 cm |
| silt_mode_15_30 | mode of the proportion of silt |
| | particles (≥0.002 mm and ≤0.05 |
| | mm) in the fine earth fraction |
| | between 15 and 30 cm |
| hb_mode_15_30 | mode of the bubbling pressure |
| | (Brooks-Corey) between 15 and 30 cm |
| n_mode_15_30 | mode of the measure of the |
| | pore size distribution (Van |
| | Genuchten) between 15 and 30 cm |
| alpha_mode_15_30 | mode of the scale parameter |
| | inversely proportional to mean of the |
| | pore diameter (Van Genuchten) |
| | between 15 and 30 cm |
| ksat_mode_15_30 | mode of the saturated |
| | hydraulic conductivity between 15 |
| | and 30 cm |
| theta_r_mode_15_30 | mode of the residual soil |
| | water content between 15 and 30 cm |
| theta_s_mode_15_30 | mode of the saturated soil |
| | water content between 15 and 30 cm |
| ph_p50_0_5 | median of the soil pH in H20 |
| | between 0 and 5 cm |
| clay_p50_0_5 | median of the proportion of clay |
| | particles (<0.002 mm) in the fine |
| | earth fraction between 0 and 5 cm |
| sand_p50_0_5 | median of the proportion of sand |
| | particles (>0.05 mm) in the fine |
| | earth fraction between 0 and 5 cm |
| silt_p50_0_5 | median of the proportion of silt |
| | particles (≥0.002 mm and ≤0.05 |
| | mm) in the fine earth fraction |
| | between 0 and 5 cm |
| hb_p50_0_5 | median of the bubbling pressure |
| | (Brooks-Corey) between 0 and 5 cm |
| n_p50_0_5 | median of the measure of the |
| | pore size distribution (Van |
| | Genuchten) between 0 and 5 cm |
| alpha_p50_0_5 | median of the scale parameter |
| | inversely proportional to mean of the |
| | pore diameter (Van Genuchten) |
| | between 0 and 5 cm |
| ksat_p50_0_5 | median of the saturated |
| | hydraulic conductivity between 0 |
| | and 5 cm |
| theta_r_p50_0_5 | median of the residual soil |
| | water content between 0 and 5 cm |
| theta_s_p50_0_5 | median of the saturated soil |
| | water content between 0 and 5 cm |
| ph_p50_5_15 | median of the soil pH in H20 |
| | between 5 and 15 cm |
| clay_p50_5_15 | median of the proportion of clay |
| | particles (<0.002 mm) in the fine |
| | earth fraction between 5 and 15 cm |
| sand_p50_5_15 | median of the proportion of sand |
| | particles (>0.05 mm) in the fine |
| | earth fraction between 5 and 15 cm |
| silt_p50_5_15 | median of the proportion of silt |
| | particles (≥0.002 mm and ≤0.05 |
| | mm) in the fine earth fraction |
| | between 5 and 15 cm |
| hb_p50_5_15 | median of the bubbling pressure |
| | (Brooks-Corey) between 5 and 15 cm |
| n_p50_5_15 | median of the measure of the |
| | pore size distribution (Van |
| | Genuchten) between 5 and 15 cm |
| alpha_p50_5_15 | median of the scale parameter |
| | inversely proportional to mean of the |
| | pore diameter (Van Genuchten) |
| | between 5 and 15 cm |
| ksat_p50_5_15 | median of the saturated |
| | hydraulic conductivity between 5 |
| | and 15 cm |
| theta_r_p50_5_15 | median of the residual soil |
| | water content between 5 and 15 cm |
| theta_s_p50_5_15 | median of the saturated soil |
| | water content between 5 and 15 cm |
| ph_p50_15_30 | median of the soil pH in H20 |
| | between 15 and 30 cm |
| clay_p50_15_30 | median of the proportion of clay |
| | particles (<0.002 mm) in the fine |
| | earth fraction between 15 and 30 cm |
| sand_p50_15_30 | median of the proportion of sand |
| | particles (>0.05 mm) in the fine |
| | earth fraction between 15 and 30 cm |
| silt_p50_15_30 | median of the proportion of silt |
| | particles (≥0.002 mm and ≤0.05 |
| | mm) in the fine earth fraction |
| | between 15 and 30 cm |
| hb_p50_15_30 | median of the bubbling pressure |
| | (Brooks-Corey) between 15 and 30 cm |
| n_p50_15_30 | median of the measure of the |
| | pore size distribution (Van |
| | Genuchten) between 15 and 30 cm |
| alpha_p50_15_30 | median of the scale parameter |
| | inversely proportional to mean of the |
| | pore diameter (Van Genuchten) |
| | between 15 and 30 cm |
| ksat_p50_15_30 | median of the saturated |
| | hydraulic conductivity between 15 |
| | and 30 cm |
| theta_r_p50_15_30 | median of the residual soil |
| | water content between 15 and 30 cm |
| theta_s_p50_15_30 | median of the saturated soil |
| | water content between 15 and 30 cm |
| ph_p5_0_5 | 5th percentile of the soil pH in |
| | H20 between 0 and 5 cm |
| clay_p5_0_5 | 5th percentile of the |
| | proportion of clay particles (<0.002 |
| | mm) in the fine earth fraction |
| | between 0 and 5 cm |
| sand_p5_0_5 | 5th percentile of the |
| | proportion of sand particles (>0.05 |
| | mm) in the fine earth fraction |
| | between 0 and 5 cm |
| silt_p5_0_5 | 5th percentile of the |
| | proportion of silt particles (≥0.002 |
| | mm and ≤0.05 mm) in the fine earth |
| | fraction between 0 and 5 cm |
| hb_p5_0_5 | 5th percentile of the bubbling |
| | pressure (Brooks-Corey) between 0 |
| | and 5 cm |
| n_p5_0_5 | 5th percentile of the measure |
| | of the pore size distribution (Van |
| | Genuchten) between 0 and 5 cm |
| alpha_p5_0_5 | 5th percentile of the scale |
| | parameter inversely proportional to |
| | mean of the pore diameter (Van |
| | Genuchten) between 0 and 5 cm |
| ksat_p5_0_5 | 5th percentile of the saturated |
| | hydraulic conductivity between 0 |
| | and 5 cm |
| theta_r_p5_0_5 | 5th percentile of the residual |
| | soil water content between 0 and 5 |
| | cm |
| theta_s_p5_0_5 | 5th percentile of the saturated |
| | soil water content between 0 and 5 |
| | cm |
| ph_p5_5_15 | 5th percentile of the soil pH in |
| | H20 between 5 and 15 cm |
| clay_p5_5_15 | 5th percentile of the |
| | proportion of clay particles (<0.002 |
| | mm) in the fine earth fraction |
| | between 5 and 15 cm |
| sand_p5_5_15 | 5th percentile of the |
| | proportion of sand particles (>0.05 |
| | mm) in the fine earth fraction |
| | between 5 and 15 cm |
| silt_p5_5_15 | 5th percentile of the |
| | proportion of silt particles (≥0.002 |
| | mm and ≤0.05 mm) in the fine earth |
| | fraction between 5 and 15 cm |
| hb_p5_5_15 | 5th percentile of the bubbling |
| | pressure (Brooks-Corey) between 5 |
| | and 15 cm |
| n_p5_5_15 | 5th percentile of the measure |
| | of the pore size distribution (Van |
| | Genuchten) between 5 and 15 cm |
| alpha_p5_5_15 | 5th percentile of the scale |
| | parameter inversely proportional to |
| | mean of the pore diameter (Van |
| | Genuchten) between 5 and 15 cm |
| ksat_p5_5_15 | 5th percentile of the saturated |
| | hydraulic conductivity between 5 |
| | and 15 cm |
| theta_r_p5_5_15 | 5th percentile of the residual |
| | soil water content between 5 and 15 |
| | cm |
| theta_s_p5_5_15 | 5th percentile of the saturated |
| | soil water content between 5 and 15 |
| | cm |
| ph_p5_15_30 | 5th percentile of the soil pH in |
| | H20 between 15 and 30 cm |
| clay_p5_15_30 | 5th percentile of the |
| | proportion of clay particles (<0.002 |
| | mm) in the fine earth fraction |
| | between 15 and 30 cm |
| sand_p5_15_30 | 5th percentile of the |
| | proportion of sand particles (>0.05 |
| | mm) in the fine earth fraction |
| | between 15 and 30 cm |
| silt_p5_15_30 | 5th percentile of the |
| | proportion of silt particles (≥0.002 |
| | mm and ≤0.05 mm) in the fine earth |
| | fraction between 15 and 30 cm |
| hb_p5_15_30 | 5th percentile of the bubbling |
| | pressure (Brooks-Corey) between 15 |
| | and 30 cm |
| n_p5_15_30 | 5th percentile of the measure |
| | of the pore size distribution (Van |
| | Genuchten) between 15 and 30 cm |
| alpha_p5_15_30 | 5th percentile of the scale |
| | parameter inversely proportional to |
| | mean of the pore diameter (Van |
| | Genuchten) between 15 and 30 cm |
| ksat_p5_15_30 | 5th percentile of the saturated |
| | hydraulic conductivity between 15 |
| | and 30 cm |
| theta_r_p5_15_30 | 5th percentile of the residual |
| | soil water content between 15 and |
| | 30 cm |
| theta_s_p5_15_30 | 5th percentile of the saturated |
| | soil water content between 15 and |
| | 30 cm |
| ph_p95_0_5 | 95th percentile of the soil pH |
| | in H20 between 0 and 5 cm |
| clay_p95_0_5 | 95th percentile of the |
| | proportion of clay particles (<0.002 |
| | mm) in the fine earth fraction |
| | between 0 and 5 cm |
| sand_p95_0_5 | 95th percentile of the |
| | proportion of sand particles (>0.05 |
| | mm) in the fine earth fraction |
| | between 0 and 5 cm |
| silt_p95_0_5 | 95th percentile of the |
| | proportion of silt particles (≥0.002 |
| | mm and ≤0.05 mm) in the fine earth |
| | fraction between 0 and 5 cm |
| hb_p95_0_5 | 95th percentile of the bubbling |
| | pressure (Brooks-Corey) between 0 |
| | and 5 cm |
| n_p95_0_5 | 95th percentile of the measure |
| | of the pore size distribution (Van |
| | Genuchten) between 0 and 5 cm |
| alpha_p95_0_5 | 95th percentile of the scale |
| | parameter inversely proportional to |
| | mean of the pore diameter (Van |
| | Genuchten) between 0 and 5 cm |
| ksat_p95_0_5 | 95th percentile of the saturated |
| | hydraulic conductivity between 0 |
| | and 5 cm |
| theta_r_p95_0_5 | 95th percentile of the residual |
| | soil water content between 0 and 5 |
| | cm |
| theta_s_p95_0_5 | 95th percentile of the saturated |
| | soil water content between 0 and 5 |
| | cm |
| ph_p95_5_15 | 95th percentile of the soil pH |
| | in H20 between 5 and 15 cm |
| clay_p95_5_15 | 95th percentile of the |
| | proportion of clay particles (<0.002 |
| | mm) in the fine earth fraction |
| | between 5 and 15 cm |
| sand_p95_5_15 | 95th percentile of the |
| | proportion of sand particles (>0.05 |
| | mm) in the fine earth fraction |
| | between 5 and 15 cm |
| silt_p95_5_15 | 95th percentile of the |
| | proportion of silt particles (≥0.002 |
| | mm and ≤0.05 mm) in the fine earth |
| | fraction between 5 and 15 cm |
| hb_p95_5_15 | 95th percentile of the bubbling |
| | pressure (Brooks-Corey) between 5 |
| | and 15 cm |
| n_p95_5_15 | 95th percentile of the measure |
| | of the pore size distribution (Van |
| | Genuchten) between 5 and 15 cm |
| alpha_p95_5_15 | 95th percentile of the scale |
| | parameter inversely proportional to |
| | mean of the pore diameter (Van |
| | Genuchten) between 5 and 15 cm |
| ksat_p95_5_15 | 95th percentile of the saturated |
| | hydraulic conductivity between 5 |
| | and 15 cm |
| theta_r_p95_5_15 | 95th percentile of the residual |
| | soil water content between 5 and 15 |
| | cm |
| theta_s_p95_5_15 | 95th percentile of the saturated |
| | soil water content between 5 and 15 |
| | cm |
| ph_p95_15_30 | 95th percentile of the soil pH |
| | in H20 between 15 and 30 cm |
| clay_p95_15_30 | 95th percentile of the |
| | proportion of clay particles (<0.002 |
| | mm) in the fine earth fraction |
| | between 15 and 30 cm |
| sand_p95_15_30 | 95th percentile of the |
| | proportion of sand particles (>0.05 |
| | mm) in the fine earth fraction |
| | between 15 and 30 cm |
| silt_p95_15_30 | 95th percentile of the |
| | proportion of silt particles (≥0.002 |
| | mm and ≤0.05 mm) in the fine earth |
| | fraction between 15 and 30 cm |
| hb_p95_15_30 | 95th percentile of the bubbling |
| | pressure (Brooks-Corey) between 15 |
| | and 30 cm |
| n_p95_15_30 | 95th percentile of the measure |
| | of the pore size distribution (Van |
| | Genuchten) between 15 and 30 cm |
| alpha_p95_15_30 | 95th percentile of the scale |
| | parameter inversely proportional to |
| | mean of the pore diameter (Van |
| | Genuchten) between 15 and 30 cm |
| ksat_p95_15_30 | 95th percentile of the saturated |
| | hydraulic conductivity between 15 |
| | and 30 cm |
| theta_r_p95_15_30 | 95th percentile of the residual |
| | soil water content between 15 and 30 |
| | cm |
| theta_s_p95_15_30 | 95th percentile of the saturated |
| | soil water content between 15 and 30 |
| | cm |
| Wrb | World Reference Base (WRB) |
| | soil class |
| cec_0_5 cm_Q0.05 | 5th percentile of the cation |
| | exchange capacity of the |
| | soil_between 0 and 5 cm |
| cec_5_15 cm_Q0.05 | 5th percentile of the cation |
| | exchange capacity of the |
| | soil between 5 and 15 cm |
| cec_15_30 cm_Q0.05 | 5th percentile of the cation |
| | exchange capacity of the |
| | soil between 15 and 30 cm |
| cec_30_60 cm_Q0.05 | 5th percentile of the cation |
| | exchange capacity of the |
| | soil between 30 and 60 cm |
| cec_60_100 cm_Q0.05 | 5th percentile of the cation |
| | exchange capacity of the |
| | soil between 60 and 100 cm |
| cec_100_200 cm_Q0.05 | 5th percentile of the cation |
| | exchange capacity of the |
| | soil between 100 and 200 cm |
| clay_0_5 cm_Q0.05 | 5th percentile of the |
| | proportion of clay particles (<0.002 |
| | mm) in the fine earth |
| | fraction_between 0 and 5 cm |
| clay_5_15 cm_Q0.05 | 5th percentile of the |
| | proportion of clay particles (<0.002 |
| | mm) in the fine earth |
| | fraction between 5 and 15 cm |
| clay_15_30 cm_Q0.05 | 5th percentile of the |
| | proportion of clay particles (<0.002 |
| | mm) in the fine earth |
| | fraction between 15 and 30 cm |
| clay_30_60 cm_Q0.05 | 5th percentile of the |
| | proportion of clay particles (<0.002 |
| | mm) in the fine earth |
| | fraction between 30 and 60 cm |
| clay_60_100 cm_Q0.05 | 5th percentile of the |
| | proportion of clay particles (<0.002 |
| | mm) in the fine earth |
| | fraction between 60 and 100 cm |
| clay_100_200 cm_Q0.05 | 5th percentile of the |
| | proportion of clay particles (<0.002 |
| | mm) in the fine earth |
| | fraction between 100 and 200 cm |
| phh2o_0_5 cm_Q0.05 | 5th percentile of the soil pH |
| | between 0 and 5 cm |
| phh2o_5_15 cm_Q0.05 | 5th percentile of the soil pH |
| | between 5 and 15 cm |
| phh2o_15_30 cm_Q0.05 | 5th percentile of the soil pH |
| | between 15 and 30 cm |
| phh2o_30_60 cm_Q0.05 | 5th percentile of the soil pH |
| | between 30 and 60 cm |
| phh2o_60_100 cm_Q0.05 | 5th percentile of the soil pH |
| | between 60 and 100 cm |
| phh2o_100_200 cm_Q0.05 | 5th percentile of the soil pH |
| | between 100 and 200 cm |
| sand_0_5 cm_Q0.05 | 5th percentile of the |
| | proportion of sand particles (>0.05 |
| | mm) in the fine earth |
| | fraction_between 0 and 5 cm |
| sand_5_15 cm_Q0.05 | 5th percentile of the |
| | proportion of sand particles (>0.05 |
| | mm) in the fine earth |
| | fraction between 5 and 15 cm |
| sand_15_30 cm_Q0.05 | 5th percentile of the |
| | proportion of sand particles (>0.05 |
| | mm) in the fine earth |
| | fraction between 15 and 30 cm |
| sand_30_60 cm_Q0.05 | 5th percentile of the |
| | proportion of sand particles (>0.05 |
| | mm) in the fine earth |
| | fraction between 30 and 60 cm |
| sand_60_100 cm_Q0.05 | 5th percentile of the |
| | proportion of sand particles (>0.05 |
| | mm) in the fine earth |
| | fraction between 60 and 100 cm |
| sand_100_200 cm_Q0.05 | 5th percentile of the |
| | proportion of sand particles (>0.05 |
| | mm) in the fine earth |
| | fraction between 100 and 200 cm |
| silt_0_5 cm_Q0.05 | 5th percentile of the |
| | proportion of silt particles (≥0.002 |
| | mm and ≤0.05 mm) in the fine earth |
| | fraction_between 0 and 5 cm |
| silt_5_15 cm_Q0.05 | 5th percentile of the |
| | proportion of silt particles (≥0.002 |
| | mm and ≤0.05 mm) in the fine earth |
| | fraction between 5 and 15 cm |
| silt_15_30 cm_Q0.05 | 5th percentile of the |
| | proportion of silt particles (≥0.002 |
| | mm and ≤0.05 mm) in the fine earth |
| | fraction between 15 and 30 cm |
| silt_30_60 cm_Q0.05 | 5th percentile of the |
| | proportion of silt particles (≥0.002 |
| | mm and ≤0.05 mm) in the fine earth |
| | fraction between 30 and 60 cm |
| silt_60_100 cm_Q0.05 | 5th percentile of the |
| | proportion of silt particles (≥0.002 |
| | mm and ≤0.05 mm) in the fine earth |
| | fraction between 60 and 100 cm |
| silt_100_200 cm_Q0.05 | 5th percentile of the |
| | proportion of silt particles (≥0.002 |
| | mm and ≤0.05 mm) in the fine earth |
| | fraction between 100 and 200 cm |
| cec_0_5 cm_Q0.5 | median of the cation |
| | exchange capacity of the |
| | soil_between 0 and 5 cm |
| cec_5_15 cm_Q0.5 | median of the cation |
| | exchange capacity of the |
| | soil between 5 and 15 cm |
| cec_15_30 cm_Q0.5 | median of the cation |
| | exchange capacity of the |
| | soil between 15 and 30 cm |
| cec_30_60 cm_Q0.5 | median of the cation |
| | exchange capacity of the |
| | soil between 30 and 60 cm |
| cec_60_100 cm_Q0.5 | median of the cation |
| | exchange capacity of the |
| | soil between 60 and 100 cm |
| cec_100_200 cm_Q0.5 | median of the cation |
| | exchange capacity of the |
| | soil between 100 and 200 cm |
| cfvo_0_5 cm_Q0.5 | median of the volumetric |
| | fraction of coarse |
| | fragments_between 0 and 5 cm |
| cfvo_5_15 cm_Q0.5 | median of the volumetric |
| | fraction of coarse |
| | fragments between 5 and 15 cm |
| cfvo_15_30 cm_Q0.5 | median of the volumetric |
| | fraction of coarse |
| | fragments between 15 and 30 cm |
| cfvo_30_60 cm_Q0.5 | median of the volumetric |
| | fraction of coarse |
| | fragments between 30 and 60 cm |
| cfvo_60_100 cm_Q0.5 | median of the volumetric |
| | fraction of coarse |
| | fragments between 60 and 100 cm |
| cfvo_100_200 cm_Q0.5 | median of the volumetric |
| | fraction of coarse |
| | fragments between 100 and 200 cm |
| clay_0_5 cm_Q0.5 | median of the proportion of |
| | clay particles (<0.002 mm) in the |
| | fine earth fraction_between 0 and 5 |
| | cm |
| clay_5_15 cm_Q0.5 | median of the proportion of |
| | clay particles (<0.002 mm) in the |
| | fine earth fraction between 5 and 15 |
| | cm |
| clay_15_30 cm_Q0.5 | median of the proportion of |
| | clay particles (<0.002 mm) in the |
| | fine earth fraction between 15 and |
| | 30 cm |
| clay_30_60 cm_Q0.5 | median of the proportion of |
| | clay particles (<0.002 mm) in the |
| | fine earth fraction between 30 and |
| | 60 cm |
| clay_60_100 cm_Q0.5 | median of the proportion of |
| | clay particles (<0.002 mm) in the |
| | fine earth fraction between 60 and |
| | 100 cm |
| clay_100_200 cm_Q0.5 | median of the proportion of |
| | clay particles (<0.002 mm) in the |
| | fine earth fraction between 100 and |
| | 200 cm |
| phh2o_0_5 cm_Q0.5 | median of the soil pH between |
| | 0 and 5 cm |
| phh2o_5_15 cm_Q0.5 | median of the soil pH between |
| | 5 and 15 cm |
| phh2o_15_30 cm_Q0.5 | median of the soil pH between |
| | 15 and 30 cm |
| phh2o_30_60 cm_Q0.5 | median of the soil pH between |
| | 30 and 60 cm |
| phh2o_60_100 cm_Q0.5 | median of the soil pH between |
| | 60 and 100 cm |
| phh2o_100_200 cm_Q0.5 | median of the soil pH between |
| | 100 and 200 cm |
| sand_0_5 cm_Q0.5 | median of the proportion of |
| | sand particles (>0.05 mm) in the |
| | fine earth fraction_between 0 and |
| | 5 cm |
| sand_5_15 cm_Q0.5 | median of the proportion of |
| | sand particles (>0.05 mm) in the |
| | fine earth fraction between 5 and |
| | 15 cm |
| sand_15_30 cm_Q0.5 | median of the proportion of |
| | sand particles (>0.05 mm) in the |
| | fine earth fraction between 15 and |
| | 30 cm |
| sand_30_60 cm_Q0.5 | median of the proportion of |
| | sand particles (>0.05 mm) in the |
| | fine earth fraction between 30 and |
| | 60 cm |
| sand_60_100 cm_Q0.5 | median of the proportion of |
| | sand particles (>0.05 mm) in the |
| | fine earth fraction between 60 and |
| | 100 cm |
| sand_100_200 cm_Q0.5 | median of the proportion of |
| | sand particles (>0.05 mm) in the |
| | fine earth fraction between 100 and |
| | 200 cm |
| silt_0_5 cm_Q0.5 | median of the proportion of |
| | silt particles (≥0.002 mm and ≤0.05 |
| | mm) in the fine earth fraction |
| | between 0 and 5 cm |
| silt_5_15 cm_Q0.5 | median of the proportion of |
| | silt particles (≥0.002 mm and ≤0.05 |
| | mm) in the fine earth fraction |
| | between 5 and 15 cm |
| silt_15_30 cm_Q0.5 | median of the proportion of |
| | silt particles (≥0.002 mm and ≤0.05 |
| | mm) in the fine earth fraction |
| | between 15 and 30 cm |
| silt_30_60 cm_Q0.5 | median of the proportion of |
| | silt particles (≥0.002 mm and ≤0.05 |
| | mm) in the fine earth fraction |
| | between 30 and 60 cm |
| silt_60_100 cm_Q0.5 | median of the proportion of |
| | silt particles (≥0.002 mm and ≤0.05 |
| | mm) in the fine earth fraction |
| | between 60 and 100 cm |
| silt_100_200 cm_Q0.5 | median of the proportion of |
| | silt particles (≥0.002 mm and ≤0.05 |
| | mm) in the fine earth fraction |
| | between 100 and 200 cm |
| cec_0_5 cm_mean | mean of the cation exchange |
| | capacity of the soil_between 0 and |
| | 5 cm |
| cec_5_15 cm_mean | mean of the cation exchange |
| | capacity of the soil between 5 and |
| | 15 cm |
| cec_15_30 cm_mean | mean of the cation exchange |
| | capacity of the soil between 15 and |
| | 30 cm |
| cec_30_60 cm_mean | mean of the cation exchange |
| | capacity of the soil between 30 and |
| | 60 cm |
| cec_60_100 cm_mean | mean of the cation exchange |
| | capacity of the soil between 60 and |
| | 100 cm |
| cec_100_200 cm_mean | mean of the cation exchange |
| | capacity of the soil between 100 and |
| | 200 cm |
| cfvo_0_5 cm_mean | mean of the volumetric |
| | fraction of coarse |
| | fragments_between 0 and 5 cm |
| cfvo_5_15 cm_mean | mean of the volumetric |
| | fraction of coarse |
| | fragments between 5 and 15 cm |
| cfvo_15_30 cm_mean | mean of the volumetric |
| | fraction of coarse |
| | fragments between 15 and 30 cm |
| cfvo_30_60 cm_mean | mean of the volumetric |
| | fraction of coarse |
| | fragments between 30 and 60 cm |
| cfvo_60_100 cm_mean | mean of the volumetric |
| | fraction of coarse |
| | fragments between 60 and 100 cm |
| cfvo_100_200 cm_mean | mean of the volumetric |
| | fraction of coarse |
| | fragments between 100 and 200 cm |
| clay_0_5 cm_mean | mean of the proportion of clay |
| | particles (<0.002 mm) in the fine |
| | earth fraction_between 0 and 5 cm |
| clay_5_15 cm_mean | mean of the proportion of clay |
| | particles (<0.002 mm) in the fine |
| | earth fraction between 5 and 15 cm |
| clay_15_30 cm_mean | mean of the proportion of clay |
| | particles (<0.002 mm) in the fine |
| | earth fraction between 15 and 30 cm |
| clay_30_60 cm_mean | mean of the proportion of clay |
| | particles (<0.002 mm) in the fine |
| | earth fraction between 30 and 60 cm |
| clay_60_100 cm_mean | mean of the proportion of clay |
| | particles (<0.002 mm) in the fine |
| | earth fraction between 60 and 100 cm |
| clay_100_200 cm_mean | mean of the proportion of clay |
| | particles (<0.002 mm) in the fine |
| | earth fraction between 100 and 200 cm |
| phh2o_0_5 cm_mean | mean of the soil pH between |
| | 0 and 5 cm |
| phh2o_5_15 cm_mean | mean of the soil pH between |
| | 5 and 15 cm |
| phh2o_15_30 cm_mean | mean of the soil pH between |
| | 15 and 30 cm |
| phh2o_30_60 cm_mean | mean of the soil pH between |
| | 30 and 60 cm |
| phh2o_60_100 cm_mean | mean of the soil pH between |
| | 60 and 100 cm |
| phh2o_100_200 cm_mean | mean of the soil pH between |
| | 100 and 200 cm |
| sand_0_5 cm_mean | mean of the proportion of |
| | sand particles (>0.05 mm) in the |
| | fine earth fraction_between 0 and |
| | 5 cm |
| sand_5_15 cm_mean | mean of the proportion of |
| | sand particles (>0.05 mm) in the |
| | fine earth fraction between 5 and |
| | 15 cm |
| sand_15_30 cm_mean | mean of the proportion of |
| | sand particles (>0.05 mm) in the |
| | fine earth fraction between 15 and |
| | 30 cm |
| sand_30_60 cm_mean | mean of the proportion of |
| | sand particles (>0.05 mm) in the |
| | fine earth fraction between 30 and |
| | 60 cm |
| sand_60_100 cm_mean | mean of the proportion of |
| | sand particles (>0.05 mm) in the |
| | fine earth fraction between 60 and |
| | 100 cm |
| sand_100_200 cm_mean | mean of the proportion of |
| | sand particles (>0.05 mm) in the |
| | fine earth fraction between 100 and |
| | 200 cm |
| silt_0_5 cm_mean | mean of the proportion of silt |
| | particles (≥0.002 mm and ≤0.05 |
| | mm) in the fine earth |
| | fraction_between 0 and 5 cm |
| silt_5_15 cm_mean | mean of the proportion of silt |
| | particles (≥0.002 mm and ≤0.05 |
| | mm) in the fine earth |
| | fraction between 5 and 15 cm |
| silt_15_30 cm_mean | mean of the proportion of silt |
| | particles (≥0.002 mm and ≤0.05 |
| | mm) in the fine earth |
| | fraction between 15 and 30 cm |
| silt_30_60 cm_mean | mean of the proportion of silt |
| | particles (≥0.002 mm and ≤0.05 |
| | mm) in the fine earth |
| | fraction between 30 and 60 cm |
| silt_60_100 cm_mean | mean of the proportion of silt |
| | particles (≥0.002 mm and ≤0.05 |
| | mm) in the fine earth |
| | fraction between 60 and 100 cm |
| silt_100_200 cm_mean | mean of the proportion of silt |
| | particles (≥0.002 mm and ≤0.05 |
| | mm) in the fine earth |
| | fraction between 100 and 200 cm |
| cec_0_5 cm_Q0.95 | 95th percentile of the cation |
| | exchange capacity of the |
| | soil_between 0 and 5 cm |
| cec_5_15 cm_Q0.95 | 95th percentile of the cation |
| | exchange capacity of the soil |
| | between 5 and 15 cm |
| cec_15_30 cm_Q0.95 | 95th percentile of the cation |
| | exchange capacity of the soil |
| | between 15 and 30 cm |
| cec_30_60 cm_Q0.95 | 95th percentile of the cation |
| | exchange capacity of the soil |
| | between 30 and 60 cm |
| cec_60_100 cm_Q0.95 | 95th percentile of the cation |
| | exchange capacity of the soil |
| | between 60 and 100 cm |
| cec_100_200 cm_Q0.95 | 95th percentile of the cation |
| | exchange capacity of the soil |
| | between 100 and 200 cm |
| cfvo_0_5 cm_Q0.95 | 95th percentile of the |
| | volumetric fraction of coarse |
| | fragments_between 0 and 5 cm |
| cfvo_5_15 cm_Q0.95 | 95th percentile of the |
| | volumetric fraction of coarse |
| | fragments between 5 and 15 cm |
| cfvo_15_30 cm_Q0.95 | 95th percentile of the |
| | volumetric fraction of coarse |
| | fragments between 15 and 30 cm |
| cfvo_30_60 cm_Q0.95 | 95th percentile of the |
| | volumetric fraction of coarse |
| | fragments between 30 and 60 cm |
| cfvo_60_100 cm_Q0.95 | 95th percentile of the |
| | volumetric fraction of coarse |
| | fragments between 60 and 100 cm |
| cfvo_100_200 cm_Q0.95 | 95th percentile of the |
| | volumetric fraction of coarse |
| | fragments between 100 and 200 cm |
| clay_0_5 cm_Q0.95 | 95th percentile of the |
| | proportion of clay particles (<0.002 |
| | mm) in the fine earth |
| | fraction_between 0 and 5 cm |
| clay_5_15 cm_Q0.95 | 95th percentile of the |
| | proportion of clay particles (<0.002 |
| | mm) in the fine earth |
| | fraction between 5 and 15 cm |
| clay_15_30 cm_Q0.95 | 95th percentile of the |
| | proportion of clay particles (<0.002 |
| | mm) in the fine earth |
| | fraction between 15 and 30 cm |
| clay_30_60 cm_Q0.95 | 95th percentile of the |
| | proportion of clay particles (<0.002 |
| | mm) in the fine earth |
| | fraction between 30 and 60 cm |
| clay_60_100 cm_Q0.95 | 95th percentile of the |
| | proportion of clay particles (<0.002 |
| | mm) in the fine earth |
| | fraction between 60 and 100 cm |
| clay_100_200 cm_Q0.95 | 95th percentile of the |
| | proportion of clay particles (<0.002 |
| | mm) in the fine earth |
| | fraction between 100 and 200 cm |
| phh2o_0_5 cm_Q0.95 | 95th percentile of the soil pH |
| | between 0 and 5 cm |
| phh2o_5_15 cm_Q0.95 | 95th percentile of the soil pH |
| | between 5 and 15 cm |
| phh2o_15_30 cm_Q0.95 | 95th percentile of the soil pH |
| | between 15 and 30 cm |
| phh2o_30_60 cm_Q0.95 | 95th percentile of the soil pH |
| | between 30 and 60 cm |
| phh2o_60_100 cm_Q0.95 | 95th percentile of the soil pH |
| | between 60 and 100 cm |
| phh2o_100_200 cm_Q0.95 | 95th percentile of the soil pH |
| | between 100 and 200 cm |
| sand_0_5 cm_Q0.95 | 95th percentile of the |
| | proportion of sand particles (>0.05 |
| | mm) in the fine earth |
| | fraction_between 0 and 5 cm |
| sand_5_15 cm_Q0.95 | 95th percentile of the |
| | proportion of sand particles (>0.05 |
| | mm) in the fine earth |
| | fraction between 5 and 15 cm |
| sand_15_30 cm_Q0.95 | 95th percentile of the |
| | proportion of sand particles (>0.05 |
| | mm) in the fine earth |
| | fraction between 15 and 30 cm |
| sand_30_60 cm_Q0.95 | 95th percentile of the |
| | proportion of sand particles (>0.05 |
| | mm) in the fine earth |
| | fraction between 30 and 60 cm |
| sand_60_100 cm_Q0.95 | 95th percentile of the |
| | proportion of sand particles (>0.05 |
| | mm) in the fine earth |
| | fraction between 60 and 100 cm |
| sand_100_200 cm_Q0.95 | 95th percentile of the |
| | proportion of sand particles (>0.05 |
| | mm) in the fine earth |
| | fraction between 100 and 200 cm |
| silt_0_5 cm_Q0.95 | 95th percentile of the |
| | proportion of silt particles (≥0.002 |
| | mm and ≤0.05 mm) in the fine earth |
| | fraction_between 0 and 5 cm |
| silt_5_15 cm_Q0.95 | 95th percentile of the |
| | proportion of silt particles (≥0.002 |
| | mm and ≤0.05 mm) in the fine earth |
| | fraction between 5 and 15 cm |
| silt_15_30 cm_Q0.95 | 95th percentile of the |
| | proportion of silt particles (≥0.002 |
| | mm and ≤0.05 mm) in the fine earth |
| | fraction between 15 and 30 cm |
| silt_30_60 cm_Q0.95 | 95th percentile of the |
| | proportion of silt particles (≥0.002 |
| | mm and ≤0.05 mm) in the fine earth |
| | fraction between 30 and 60 cm |
| silt_60_100 cm_Q0.95 | 95th percentile of the |
| | proportion of silt particles (≥0.002 |
| | mm and ≤0.05 mm) in the fine earth |
| | fraction between 60 and 100 cm |
| silt_100_200 cm_Q0.95 | 95th percentile of the |
| | proportion of silt particles (≥0.002 |
| | mm and ≤0.05 mm) in the fine earth |
| | fraction between 100 and 200 cm |

In compliance with the statute, embodiments of the invention have been described in language more or less specific as to structural and methodical features. It is to be understood, however, that the entire invention is not limited to the specific features and/or embodiments shown and/or described, since the disclosed embodiments comprise forms of putting the invention into effect.

1. A system for agricultural parameter determination, the system comprising processing circuitry configured to:
manage one or more land parcels for agricultural parameter optimization; and
determine one or more agricultural parameters of at least a portion of one land parcel during a first time period without sampling the portion of the one land parcel, the determining comprising:
collecting target agricultural data from at least one portion of another land parcel, the collecting comprising compiling target agricultural data and candidate predictor parcel data associated with collection sites;
associating a subset of the candidate predictor parcel data with points throughout the portions of the land parcels; and
processing both the compiled target agricultural data and the subset of predictive parcel data to generate target agricultural data for unsampled parcel portions, the processing comprising:
building a target agricultural data model from collected target agricultural data and the subsets of predictive data; and
applying the target agricultural data model to determine one or more agricultural parameters of the portion of the at least one land parcel.

2. The system of claim 1 wherein the processing circuitry is further configured to determine one or more agricultural parameters during a second time period wherein the processing both the compiled target agricultural data and the subset of predictive parcel data to generate target agricultural data for unsampled parcel portions includes target agricultural data from the second time period taken from the same and/or different locations as the first time period.

3. The system of claim 2 wherein the processing circuitry is further configured to determine one or more agricultural parameters of at least one land parcel without sampling the one land parcel by collecting target agricultural data for at least two other portions of two other land parcels.

4. The system of claim 1 wherein the system is further configured to determine annual predictions of agricultural parameters of the portion of the at least one land parcel, calculate the annual change, and/or quantify the agricultural and/or environmental benefit.

5. The system of claim 1 wherein the one or more land parcels are identified for agricultural optimization by associating the one or more land parcels by common commodity crop.

6. The system of claim 2 wherein the commodity crop is configured in rows having alleyways between the rows.

7. The system of claim 6 wherein the portions of the land parcels are alleyways between commodity crops.

8. The system of claim 7 wherein the specific portions of the parcels are the alleyways between rows of commodity crops.

9. The system of claim 8 wherein the alleyways between the rows of commodity crops have been planted with a cover crop.

10. The system of claim 9 wherein the cover crop is dormant during the growing season of the commodity crop and grows during the dormant season of the commodity crop.

11. The system of claim 10 wherein the commodity crop is a vineyard or orchard.

12. The system of claim 10 wherein the cover crop is hybridized bulbosa (7PB55).

13. The system of claim 10 wherein at least one target variable is total carbon.

14. The system of claim 13 wherein the total carbon comprises organic carbon.

15. The system of claim 14 wherein the system is further configured to determine carbon credits using predicted organic carbon.

16. A method for increasing soil organic carbon, the method comprising:
managing a parcel having commodity crops planted in rows, the commodity crops having a dormant season;
defining alleyways between the rows of commodity crops;
planting a cover crop within the alleyways, the cover crops having growing season within the dormant season of the commodity crop, and a dormant season within the growing season of the commodity crop; and
increasing the soil organic carbon content of the parcel during the dormant season of the commodity crop with the cover crop.

17. The method of claim 16 wherein the commodity crop is a vineyard or orchard.

18. The method of claim 16 wherein the cover crop is hybridized bulbosa (7PB55).

19. The method of claim 16 further comprising retaining the cover crop between commodity crop growing seasons.

20. A system for increasing soil organic carbon within land parcels having commodity crops separated by alleyways, the system comprising processing circuitry configured to:
manage one or more land parcels for agricultural parameter optimization, the land parcels having commodity crops in rows with alleyways therebetween; and
determine carbon per acre of at least one land parcel during a first time period without sampling the one land parcel, the determining comprising:
collecting soil organic carbon data for collection sites of alleyways of another land parcel, the collecting comprising determining collection sites and compiling soil organic carbon data associated with the collection sites;
associating a subset of the candidate predictor parcel data with points throughout the alleyways of the land parcels; and
processing both the compiled soil organic data and the subset of predictive parcel data to generate soil organic data for unsampled alleyways, the processing comprising:
building a soil organic carbon data model from collected soil organic data and the subsets of predictive data; and
applying the soil organic data model to determine soil organic carbon of the alleyway of the at least one land parcel.
